(19) United States
(12) Patent Application Publication
(10) Pub. No.: US 2015/0325079 A1
(43) Pub. Date: Nov. 12, 2015

(54) PLATFORMS AND SYSTEMS FOR PLAYING GAMES OF CHANCE

(71) Applicant: Bruce Alsip, Seattle, WA (US)

(72) Inventor: Bruce Alsip, Seattle, WA (US)

(21) Appl. No.: 14/704,622

(22) Filed: May 5, 2015

Related U.S. Application Data
(60) Provisional application No. 62/156,171, filed on May 1, 2015.
(60) Provisional application No. 61/992,018, filed on May 12, 2014.
(60) Provisional application No. 61/990,573, filed on May 8, 2014.
(60) Provisional application No. 61/990,563, filed on May 8, 2014.

(51) Int. Cl. G07F 17/32; G07F 17/34; G06F 3/048

(52) U.S. Cl. CPC G07F 17/329; G06F 3/048; G07F 17/34; G07F 17/3225; G07F 17/3213

(57) ABSTRACT

A gaming platform and system for operating a game of chance, more particularly a gaming machine having a player interface with interactive display, a processor with memory, instructions in memory, and a graphics modelling engine operative cooperatively with a kinematics engine and random number engine, such that the gaming machine is adapted to display randomized motions of a plurality of virtual gamepieces, wherein the final resting place, orientation and content of each gamepiece is indeterminate and unknowable until motion stops. The instructions, when executed by a processor, are configured to operate a game of chance. In preferred “conceal and reveal games”, a player selects gamepieces, termed here “selectable objects”, each selectable object having a concealed “embedded element” that is revealed during gameplay, and the game outcome is based on the number of random and non-random indicia matched by the player.

### CROSS REFERENCES TO RELATED APPLICATIONS

This application is related to and claims priority to U.S. Provisional Patent Application Ser. No. 62/156,171 titled, “Platform and System for Playing Games of Chance” filed 1 May 2015, U.S. Provisional Patent Application Ser. No. 61/990,563 titled, “Gaming Machine, Apparatus and Methods of Gaming” filed 8 May 2014, U.S. Provisional Pat. Appl. Ser. No. 61/990,573 titled “Gaming Machine, Apparatus and Methods of Electronic Gaming with Virtual Dice” filed 8 May 2014, and U.S. Provisional Pat. Appl. Ser. No. 61/992,018 titled “Electronic Gaming Machine for Dice Game of Elimination” filed 12 May 2014, which are all incorporated herein in full by reference for all purposes. This application is further related to U.S. patent application Ser. No. 14/703,865 titled “Gaming Machine, Apparatus and Methods” filed 4 May 2015, which is incorporated herein in full by reference for all purposes.

### FIELD OF THE INVENTION

The present invention relates generally to electronic gaming systems and machines, and more particularly to an apparatus for randomizing an outcome of a conceal-and-reveal game type.

### GOVERNMENT SUPPORT

The inventive matter disclosed herein was realized without government support.

### COPYRIGHT NOTICE

A portion of the disclosures of this patent document contains or may contain material that is subject to copyright protection. The copyright owner can have no objection to the photocopying or electronic reproduction by anyone of a patent document or a part of a patent disclosure in exactly the form it appears in the official records of the United States Patent and Trademark Office, but otherwise reserves all copyright rights whatsoever.

### BACKGROUND

As gaming advances to higher levels of virtual and augmented reality, game developers increasingly will be challenged to provide hyper-realistic game presentations. Mere mapping of winning indicia or gamepieces onto a featureless two-dimensional surface will no longer be fun or attractive to customers who have grown up with fast paced, life-like simulations in all aspects of their interactions with machines. Thus in games of the future, a virtual reel spin, dice throw, paint ball aim, or playing card deal will need to be executed in a deep virtual space with kinetic animation, realism and speed. The capacity to convincingly model three-dimensional action and reaction will be the challenge for next generation games. In future games, a display surface will become a display space, and players will increasingly turn to gestural interfaces and new peripheral devices by which gamepieces are acted on (or act back) without the constraints of an LED screen. This is already apparent for example in US Pat. Doc. No. 2015/0016777 published on 15 Jan. 2015.

Universal features of successful games include not only qualities of fun and velocity, but also qualities of familiarity and freshness. While at first paradoxical, familiar features help the player to grasp and appreciate a new game, and retention is maximized by combining familiarity with features of freshness that are either endlessly repeatable with no redundancy (a sort of calisthenics for the mind), or are configured to be revealed as players advance through ascending levels of discovery. Always a factor is the social aspect, which may be a deliberately solitary experience at one end, or a shared engagement, sometimes with competing teams who meet and play in tournaments at the other end of the spectrum.

The costs of game development is increasingly supported by games of chance, and economic models have shown that the mere 10% of players who gamble (often with virtual “chips”) are able to support a 90% cohort of players who play only for fun. This is because the costs of offering a virtual game are decreasing and players are increasingly able to connect and play anywhere (on the train, in a coffee shop, or at home) in their spare time, using mobile devices. In fact, retained earnings in the industry are increasingly in the form of trade secrets and intellectual property for creating new games and new content; less as brick and mortar assets or mailing lists.

This growth is not merely a matter of software development. Technical problems also remain related to the gaming apparatus and machines themselves. A fundamental sense of fairness is achieved only if the game is perceived not to be rigged, and a successful game operator must have strategies to ensure fairness and to prevent cheating. A technical feature of these strategies rests in the capacity to ensure that a random number generator (RNG) function call or invocation does not deliver predictable results, for example a lottery where the number “1” is a winning number exactly half the time . . . or as an actual instance, the Ontario tic-tac-toe game that was quickly cancelled due to a flaw in programming identified by a Toronto man—a repeating pattern in the numbers on scratchcards that signaled a winning ticket about 80% of the time.

Problematically, in most conventional electronic games of chance, the computer has determined the game outcome at the instant the player initiates the game. Players know this and are reluctant to play these games as a result. Non-deterministic means for generating random outcomes are needed to overcome this problem. In a preferred solution, it would be desirable that the player were able to discern the game outcome before (or at least at the same time) the computer is lead to the game's result. This gives the player a sense of control and trust to luck that is lacking in conventional electronic games of chance. In part, this is a problem in the way in which randomness is determined by conventional gaming platforms and systems.

It is generally agreed that true randomness is not possible with native computers and standard RNG function calls. Computers are by definition deterministic in their software code, so true randomness is believed in the art to arise by either 1) tapping into a chaotic physical process (such as noise from a diode, radioactive emissions, aperiodic signals in radio static) or 2) extracting signals from the uncertainty inherent in observation of quantum events. Non-deterministic processes for generating random numbers are known (a sample of the art is offered in US Pat. Docs Nos. 2008/0076525; 2008/0270503; 2009/0327381 and 2014/0287816, and in art that is offered for sale at www.random.org and at www.fourmilab.ch/hotbits/, for instance). These improvements, termed “true random number generators” (TRNGs), are contrasted with the teachings of the gaming patent literature of the 21^{st} Century generally—as represented in exemplary U.S. Pat. No. 7,004,834, which is incorporated herein by reference (the '834 patent), and in U.S. Pat. Nos. 5,935,002, 6,533,664; and 6,604,999, among others), and more generally throughout the published literature on computerized gaming. Recent filings such as US Pat. Publ. No. 2011/0003628 continue to fail to resolve the problem. U.S. Pat. No. 8,657,679, which is incorporated herein by reference (the '679 patent), posits the difference between TRNG and pRNG as a factor in regulatory requirements for gambling establishments but only hints at how valid RNGs may be physically implemented, not fully resolving the practical problem for game builders and operators of gaming systems.

TRNGs do not solve the problem of determinacy in computer programs, but at least are fair and unbiased. However, they generally require special hardware not available on current mobile devices such as cellphones and tablets. Thus for now, implementation of a TRNG system is not a practical solution in most gaming environments, particularly where another option presents itself that is more compatible and is synergic in achieving basic aspirations of players for both fun and fairness in gaming platforms and systems. Better player interfaces, through improved graphical, haptic, acoustic, and gestural interfaces are also compatible with (and needed for) all these aspirations. These and other goals are advanced by the technical contributions of the present invention to the art.

### SUMMARY

Compelling new game content is always needed. Slot machines alone reportedly generate more than ten billion dollars per year in revenue for US casinos, and social gaming “on line” is increasing rapidly. Thus fresh approaches and improvements in electronic gaming machines are urgently needed: approaches that result in new technical features or new combinations of technical features; including games adapted to improve and increase the quality of fun in the playing, the experience of winning, and to promote sustained interest from a broader gaming audience.

Examples for animated gaming are described here of innovative random number engines (RNEs) that more fully realize game outcomes based purely on chance and synergically, offer heightened realism, excitement and velocity in video gameplay. Randomization is based on computer modelling where it is an object of the invention to achieve randomness in game outcomes by modelling the kinematic motions of a plurality of gamepieces in a 3D virtual space according to iterative solutions to kinematic equations (with or without gravity, for example), the gamepieces containing embedded elements, including data or function calls relevant to the player's experience. These solutions are computationally inexpensive and fast. The preferred gaming systems and machines are operated to validly randomize an outcome of a game of chance, and include a graphics rendering engine and kinematic engine configured to output a display of virtual gamepieces, said gamepieces having randomized motion in three dimensions such that an outcome of a game of chance is indeterminate until said randomized motion is stopped. The games may be engineered to solve translational, rotational, and collisional kinematic equations of motion for a plurality of colliding or bouncing gamepieces, and will deliver an outcome that cannot be known by the player or the computer until the motion has stopped and the gamepieces have assumed their final resting positions and orientations. Added complexity may be added to the gaming systems by incorporating object attributes having hidden significance in the game. Also described here for illustration are representative games of the future: games embodying the universal principles of fun, freshness, familiarity and velocity of play and having technical features that characterize the inventive gaming machines, systems and platforms.

In one aspect, the invention is an apparatus for conducting an interactive game of chance, more particularly a gaming system having a player interface with display, a processor with memory, a random number generating capacity, with kinematic and graphical modelling capability, such that the gaming system is configured to display motions and trajectories of a plurality of virtual selectable objects in a three dimensional environment of a gaming system display. By “random number generating capacity” is included random number engines RNEs for pseudo-random number generators (pRNGs), true RNGs (TRNGs), and/or novel “kinematic RNEs” (kRNEs) in one or more combinations or individually. kRNEs are configured in gaming systems to achieve randomness in game outcomes by modelling the motions of a plurality of gamepieces in a three dimensional virtual space over time according to kinematic equations of motion of one or more virtual rigid bodies (with or without gravity, for example). Preferredly, any initial settings, velocities, vectors, spin, and/or collision parameters are randomized so as to reduce the playtime needed to achieve a fully disordered state. Thus simple pRNGs may initialize a game and are used in combination with kRNEs to accelerate and transform a game, achieving surprise in game outcomes such that even the computer cannot know the outcome in advance.

In a preferred embodiment, game setup includes initialization, transition and transformation as the gamepieces are randomly distributed in a game space. Subsequently, the player takes control of the game knowing that the game outcome is still unknown. The randomization of the gamepieces is statistically valid as tested by established standards and methods. Once randomized, gamepieces may be re-ordered as blinded virtual constructs without decrementing the randomness of their relative distribution.

Synergically, a kRNE supports both an animation function (emulating life-like motion) and kinetically randomizes the game positions of any embeddable elements associated with the gamepieces, thus putting the quality of luck (perceived as fairness) back into computerized games of chance and adding freshness. In some embodiments, the kRNE is combined with a “kinematic engine” having two outputs, a random number generator functionality and a kinematic motion functionality, where the two aspects are interlinked by a common core of kinematic equations, including translational, rotational and collisional equations of motion. The kinematic output is coupled to or part of a graphics rendering engine (GRE) that produces a virtual solid body in motion according to coordinates and vectors output from the kinematic engine. It is helpful to structure this functionality as an independent co-processor, a thread, a ASIC, or a daemon within a gaming platform architecture, such that the kRNE, kinematic engine, and related graphics rendering engines are operative independently of the processor at one or more stages of a game.

In other aspects the inventions include a gaming machine or system for randomizing an outcome of a game of chance, which comprises a processor with processing circuitry, a player interface with interactive display, a memory containing program instructions, such that the processing circuitry includes a graphics rendering engine and a kinematic engine operative to iteratively output a display of a plurality of virtual gamepieces, the gamepieces having randomized motion in three dimensions in real time such that an outcome of a game of chance played on the gaming machine or system is indeterminate until the randomized iterative motion of the gamepieces is stopped. The gamepieces may have concealed attributes or embedded content of significance in resolving the outcome of the game. Advantageously, in some implementations, the outcome of the game remains indeterminate until a player's selection of a subset of the gamepieces is received. More particularly, the game of chance may be a conceal-and-reveal game, such that the program instructions are configured to, when executed as an iteration by the processor and processing circuitry, enable the apparatus to model a plurality of virtual gamepieces of a game of chance, each gamepiece having a virtual motion in real time in a virtual space as defined by translational, rotational and collisional equations of motion applied thereto, such that the gamepieces are randomly assembled into a blinded virtual construct on the interactive display when the iteration is stopped. Each the virtual gamepiece may be modelled as a selectable object on the interactive player interface and each the gamepiece is associated with an embedded element concealedly associated therewith.

Games having these features may include combinations of lottery play with moving balls, slot play with spinning reels, roulette wheels, and scratchcard play, or combinations having dice play with bouncing dice such as craps, for example. In an instant lottery draw embodiment, the gaming system is configured to associate individual pads of a virtual scratchcard with embedded winning lottery numbers selected from an instant lottery draw routine. The lottery draw routine may include an animated simulation of percolating lottery balls that advances to an animated simulation in which the winning lottery numbers are concealedly embedded in the scratch card array. In one example of an animated simulation, a transformative slot reel spin is displayed to increase play excitement and randomization. The animation builds to the presentation of a scratchcard containing concealed winning lottery numbers and supplemental game indicia. To win, the player's blinded selections on the scratchcard must match the lottery numbers from the draw. In another variant, gameplay may include an animation of a dice throw, the object of which is to randomize and embedded winning game indicia in a blinded virtual construct of dice, from which the player must select the winning indicia.

In another aspect, the invention is an apparatus for randomizing an outcome of a conceal-and-reveal game, which comprises a processor with processing circuitry; an interactive player interface; and, a memory containing program instructions, such that the program instructions are configured to, when executed as an iteration by the processor and processing circuitry, adapt and enable the apparatus to model a plurality of virtual gamepieces of a game of chance, each gamepiece having a virtual motion in real time in a virtual space, motion defined and modelled by translational, rotational and collisional equations of motion applied thereto, such that the gamepieces are randomly assembled into a blinded virtual construct in the virtual space when the iteration is stopped. Using a graphics rendering engine, each gamepiece is modelled as a selectable object on the interactive player interface and each gamepiece is associated with an embedded element concealedly associated therewith. In a first instance, the virtual gamepieces are slot reels having a virtual motion in a virtual cylinder with a window, wherein the virtual motion is defined by a rotational equation of motion applied thereto and the program instructions are configured to represent the contents of the slot reel window as a scratch card on the interactive player interface when the iteration is stopped. Preferredly the embedded elements are instant win lottery numbers, non-random supplemental game indicia, and non-winning lottery numbers such that one and only one number or other indicia is associated with each the selectable object.

In other embodiments, the virtual space comprises at least one delimiting boundary, wherein the boundary is a gameboard, and the blinded virtual construct is randomly assembled on the gameboard on the interactive player interface. The virtual space may be a plane, a box, a tube, a dimple, and so forth. In a preferred embodiment, the virtual space is a gameboard, and the virtual gamepieces are dice having a virtual motion on the gameboard, such that the virtual motion is defined by translational, rotational, and collisional equations of motion applied thereto. These technical advances achieve compelling realism and valid randomization of game results such that the computer may not know the game outcome until after player does, for example when a dice cube teeters and tips onto a winning face that decides the game, or a slot reel hangs and then drops into its final detent, an advance in the art that contributes to the excitement of the inventive games.

In a preferred embodiment, multistage gameplay is conceived, where the build is a progression of animated displays from an initial stage, to a transitional stage, to a transformational stage, with randomization occurring at any one or all of the stages. These stages are executed by a processor configured to make a function call or invocation to one or more RNEs in coordination with programming routines for animation and kinetic randomization of any stage or combination of stages of gameplay.

In the preferred games of “conceal-and-reveal”, all the winning elements are included in every game; there is no illusion—the player actually can win each and every game. For players who are in the zone, multistage betting is conceived to maximize returns on momentum play. Play velocity is shown to rival the fastest slot games, but without the repetitiveness.

These and other features, steps, and advantages of the inventions will be more readily understood upon consideration of the following detailed description of the invention, taken in conjunction with the accompanying drawings, in which presently preferred embodiments of the gaming platform and gaming operations are illustrated by way of example.

### BRIEF DESCRIPTION OF THE DRAWINGS

The teachings of the present invention are more readily understood by considering the drawings, in which:

FIG. 1 is a drawing of a first “scratch” game in play on a gaming system of the inventions.

FIG. 2 is a drawing of a second “scratch” game in play on a gaming system of the inventions.

FIG. 3A is a schematic representation of a random number engine invocation or function call, optionally as part of an iterative loop. FIG. 3B is a schematic representation of operative digital links between a graphics rendering engine, a random number engine, and a processor. FIG. 3C demonstrates how a seed matrix {S} or “seed set” is seeded with a set of winning lottery numbers during play initialization.

FIG. 4 is a block diagram of machine components and subsystems used in building gaming systems of the inventions, including components for network connectivity if desired.

FIG. 5 is a block diagram depicting four stages of the preferred games of the invention.

FIG. 6A is an overview of a user interface of a first embodiment of a gaming apparatus of the invention, and displays an initial stage of gameplay—beginning with generating a set of winning lottery numbers, each set is unique to each game. FIGS. 6B-6D are views of a slot reel display window showing the reel spin and mechanics of transitional and transformative stages of gameplay.

FIGS. 7A-7G are stepwise views of the mechanics of a play stage of gameplay ending in a game win.

FIG. 8A-8B is a view of a flow chart of interactive gameplay on two sheets, the flow chart describing a gaming system as operated to play a game with three rounds of betting.

FIG. 9A-9B is an overview of an alternate game sequence describing a game embodiment operated with a branching decision point in a betting process.

FIG. 10 is a view of an exemplary pay table where number values may represent cash or cash equivalents.

FIG. 11A tabulates comparative results from alternate embodiments of the basic game. FIG. 11B tabulates outcomes a series of 2000 games played in rounds of a 2-4-1 bet-select format.

FIG. 12 illustrates how the rate and size of bets made per game is uncoupled from the rate of initiation of gameplay and the presentation of wins or losses.

FIG. 13 is a view of revenue flow and gameplay in a series of six games, each game having an initial bet followed by up to three rounds of betting per game.

FIG. 14 is a sketch of a casino slot machine reconfigured to operate as a gaming system of the invention. A pull arm may be implemented if desired.

FIG. 15 is a sketch showing a cellphone reconfigured to operate as a gaming system of the invention.

FIGS. 16A, 16B and 16C are schematic views of networked gaming systems, the network constituting a larger gaming system of the invention.

FIG. 17 is an overview of a user interface of a second embodiment of a gaming system of the invention, including a blinded virtual construct of dice in the form of a pyramid and provision for competitive rapid play by two players.

FIG. 18 is a schematic diagram of a lottery play routine as an initial stage of an apparatus of the invention for playing a dice game.

FIGS. 19A and 19B are views of white and black dice cubes with facetypes defined by pips.

FIG. 20 is a view of a transitional and transformational stage of a dice gaming apparatus of the invention in which a dice roll is transformed into a blinded virtual construct. Virtual dice are shown spilling onto a virtual game surface. Game outcomes are controlled by embedded content in the black dice.

FIG. 21 is a schematic view of selected randomization capabilities used in making RNE calls in a gaming system of the invention.

FIG. 22 is a representation of a throw of dice in which a game “transformational stage” is enhanced by programming the display to show the black dice spontaneously jumping from their resting places on the game surface after a throw into a blinded virtual construct (shown here as a cube of 64 dice), several of which are in the process of repositioning themselves into the stack (dashed arrows).

FIGS. 23A-23C are schematic representations of a structured virtual construct, here fifteen dice cubes stacked as a pyramid, as imaged on a capacitive LED screen. FIG. 23C shows the dice as selectable objects; FIG. 23B shows the embedded content of the game matrix concealed in the blinded virtual construct.

FIGS. 24A-24C show a game progressing through a series of three bets and selections to a game outcome.

FIG. 25A is a snapshot view of a game display showing a wall of dice as a blinded virtual construct, where two bets have already been played. FIG. 25B shows the outcome as a match of the player's selections and the lottery numbers drawn for the game.

FIG. 26A is a view of a virtual dice betting game with a game dice pyramid and a plurality of animated avatars as companions when playing the game. FIG. 26B is a representation of a swipeable user control for selecting a game theme from a range of game themes.

FIG. 27A shows a virtual three-dimensional pyramid having four game sides or ‘aspects’. The construct may be rotated (dashed arrow) to select any one of the four aspects for play. FIG. 27B demonstrates how each playing face may be played separately or simultaneously by rotating the pyramid.

FIG. 28 is a perspective view of a virtual pyramid having twenty-eight dice laid flat like a gameboard.

FIG. 29A depicts a pyramid of dice cubes, and may be a two dimensional representation or a three-dimensional representation, each dice facetype representing a “playline”. FIG. 29B is a detail view of the uppermost dice cube.

FIG. 29C is a game display showing “match-to-win ledger” and “player's tally” windows for six simultaneous games.

FIG. 30A shows a casino gaming system or “machine” having technical features of the inventions.

FIG. 30B shows a gaming system of the invention that has been configured as a laptop computer.

The drawing figures are not necessarily to scale. Certain features or components herein may be shown in somewhat schematic form and some details of conventional elements may not be shown in the interest of clarity, explanation, and conciseness. One skilled in the art will understand that the number and content of the entries can be different from those illustrated herein. The inventions do not necessarily reside in any one of these views or aspects taken alone, but rather in the technical advance or advances taken as a whole. The drawing figures are hereby made part of the specification, written description and teachings disclosed herein.

### GLOSSARY

Certain terms are used throughout the following description to refer to particular features, steps or components, and are used as terms of description and not of limitation. As one skilled in the art will appreciate, different persons may refer to the same feature, step or component by different names. Components, steps or features that differ in name but not in structure, function or action are considered equivalent and not distinguishable, and may be substituted herein without departure from the inventive concepts and advances. Certain meanings are defined here as intended by the inventors, i,e., they are intrinsic meanings Other words and phrases used herein take their meaning as consistent with usage as would be apparent to one skilled in the relevant arts. The following definitions supplement those set forth elsewhere in this specification.

“Gaming systems”, also sometimes referred to here as “gaming platforms”, “gaming machines” or “gaming apparatus”, are generally digital electronic devices, at least in part, and include at least one processor configured to execute programmable instructions from non-volatile memory, random access memory for storing transient game data, an interactive player interface with display, attached peripherals, and housekeeping system functions such as watchdog circuits. In some instances, firmware may be equivalent to some parts of the program instruction set and may be substituted in the gaming system without departure from the scope of the invention.

A gaming system is, in the most general sense, a computing machine designed to run a set of program instructions and provides an environment and any facilities needed for execution of those program instructions (such as instructions encoded in a software program), according to a determinative outcome. The system defines the outcome according to a set of rules. The term “gaming system” can refer to different or multiple levels, including a hardware architecture level, an operating system level, any runtime libraries, and combinations thereof, but is fundamentally a machine having an on-board and/or remote computing facility engineered to support the programmable gaming instructions and rules with any necessary hardware, data handling, and background services.

Gaming systems or platforms may include variants such as those devices operating on hardware alone (firmware) in the case of small embedded systems. Embedded systems can access hardware directly, without an operating system. Systems may also include a browser (in the case of web-based gaming software). The browser itself runs on a platform on a remote server. Some platform architectures have multiple layers, with each layer acting as a platform for the one above it. Platforms include virtual machines such as the Java virtual machine. Applications are compiled into a format similar to machine code, known as bytecode, which is then executed by a virtual machine.

Individual devices may be networked as known in the art. Also typical are conventional features such as a bet acceptor and payout subsystem with optical or acoustic accompaniments.

Characteristic of the systems of the invention are unique function calls to RNEs that are configured to operate with kinematic animations (using graphics rendering engines) and to achieve randomness in game outcomes. Particularly preferred are hybrid games having features of lottery games with slot or dice configured in the form of a conceal-and-reveal game. Gaming machines may include computerized devices, including cellphones and mobile devices more generally when said computerized devices are capable of operating animated games of chance as independent devices or as part of networks, such as using a browser to access a website where a game is hosted. Preferred games of chance are interactive, and permit player input during the game. Betting may be optional in some systems.

“Computerized device” is used in a broad sense, and may include gaming systems having logic circuitry, at least one processor, a clock, non-transitory memory or firmware (such as ROM and EEPROM), transitory random access memory (including RAM and Z-RAM), and generally a clock, one or more ports to I/O devices such as a graphical user interface (including display), a pointer, a keypad, a sensor, kinematic and graphical modelling circuitry (including RNE, GRE and kinematic engines), a wireless or wired communications link, and so forth as known in the art. Computers are frequently formed into networks, and networks of computers may also be referred to here by the terms “computing machine” or as components of a gaming platform or system. In one instance, informal internet networks known in the art as “cloud computing” may be functionally equivalent computing machines, for example. Computing machines also include mobile devices having processing capacity for running local applications (“apps”), browser-driven games, and/or cloud-based applications more generally.

“Processor” refers to a digital device that accepts information in digital form and manipulates it for a specific result based on a sequence of “programmed instructions”. Programmed or “programmable instructions” are generally stored as “computer code” in a non-transitory memory medium. Processors may be multi-threaded processors. Processors communicate and receive communications from processing circuitry digitally coupled thereto.

“Routine”—is a sequence of program instructions or a “software engine” forming a functional component of a larger program of a computing machine or server. A routine may also be called a function, a subroutine, an API, a method, a daemon, a loop, a program, or a subprogram in some programming languages. The generic terms “callable unit”, “function call”, or “invocation”, are sometimes used to describe a routine. When called, a routine uses data values in the form of parameters or arguments supplied by the processor from memory to perform a task, often returning data values to memory for subsequent program steps. As used here, tasks performed by a routine include large functional blocks of code or interactions, such as operation of a virtual machine having the workings of a lottery draw, or the operation of a dice throw simulation with kRNE functionality, or for receiving selections on a player interface, or a bet acceptance and settlement software engine, and so forth. In some gaming systems, an “application specific integrated circuit” (ASIC) may be used, limiting the requirement for software.

“Iteration”—defined here as a program or routine in which a set or subset of program instructions are repeated a specified number of times or until a condition is met, typically as a “software loop”.

Parameters or arguments accessed from memory in the process of repeating a set of instructions may be changed by each round of execution, thus resulting in a different outcome for each iteration.

A “game”, as the term is utilized herein (unless otherwise specified), may generally comprise any game (e.g., wagering or non-wagering, skill-based, chance-based, playable by hand (e.g., utilizing non-electric physical components, boards, and/or pieces), and/or electronically playable over a network) playable by one or more players in accordance with specified rules. An electronic game may be playable on a Personal Computer (PC), online in web browsers, on a game console, and/or on a mobile device such as a smart-phone or tablet computer. “Gaming” thus generally refers to play of a game (e.g., by one or more players).

A “social network game”, as utilized herein (unless otherwise specified), generally refers to a type of online game that is played through a social network, and in some embodiments may feature multiplayer and/or asynchronous game play mechanics. A “social network” may refer to an online service, online community, platform, and/or site that focuses on facilitating the building of social networks or social relations among people. A social network service may, for example, consist of a representation of each user (often a profile), his/her social links, and a variety of additional services. A social network may be web-based and provide means for users to interact over the Internet, such as e-mail and instant messaging. A social network game may in some embodiments be implemented as a web browser and/or web-client game, a Flash®, or Java®-scripted game, and/or may be implemented on one or more mobile platforms such as on portable electronic devices.

A “wagering game” or “betting game” may generally comprise a game in which a player can risk a wager or other consideration, such as, but not limited to: slot-style games, poker, blackjack, baccarat, craps, roulette, lottery, bingo, keno, conceal-and-reveal, or action game, etc. A wager may comprise a monetary wager in the form of an amount of currency or any other tangible or intangible article having some value which may be risked on an outcome of a wagering game. “Gambling” or “wagering” generally refers to play of a wagering game.

A “social casino” is an on-line site or mobile app that offers traditional gambling games such as poker, roulette and slots. The games are often played via social networks, by mobile apps and on-line. Players do not win money and do not have to pay to play, but may be offered virtual chips in exchange for a subscription or a cash payment.

“Conceal-and-reveal game”—of or related to a family of games evolved from walnut shell and punchcard games. The old walnut shell game is an example of a conceal-and-reveal game that was generally rigged. Assuming three shells and one “bean”, the expected odds of winning by chance are

$$f = \frac{1}{3} = 0.333 ,$$

or one out of three.

However, by distraction, skillful operators could reliably relieve the mark of his wager most times. The game typically concluded with pure showmanship, where the bean is somehow revealed to be under a shell not chosen. Obviously, electronic cheating on a virtual screen would not be difficult, so controls must be in place. Player retention is best served by making the game fair and credible. In consequence of this history of deception, greater attention to true randomization is needed in configuring a gaming system for operating a conceal-and-reveal game.

“Game of chance”—any game played with an element of a bet or wager having either a cash value or an equivalent of a cash value.

Fold (verb)—to forfeit any chance of winning a bet on a game, generally in order to start a new game of the same type.

The term “game provider” generally refers to an entity which provides games and gaming systems for play. As utilized herein, the term “player” may generally refer to any type, quantity, and or manner of entity associated with the play of a game. In some embodiments, a player may comprise an entity conducting play of an online game, for example, may comprise an entity that desires to play a game (e.g., an entity registered and/or scheduled to play and/or an entity having expressed interest in the play of the game—e.g., a spectator) and/or may comprise an entity that configures, manages, and/or conducts a game. A player may be currently playing a game or have previously played the game, or may not yet have initiated play—i.e., a “player” may comprise a “potential player” (e.g., in general and/or with respect to a specific game). In some embodiments, a player may comprise a user of an interface (e.g., whether or not such a player participates in a game or seeks to participate in the game). In some embodiments, a player may comprise an individual (or group) that enters, joins, logs into, registers for, and/or otherwise access an online game room, session, server, and/or other particular instance and/or segmentation of an online game. A “team” may also be construed in the sense of being a “player”.

“Interactive player interface”—a feature of a computing machine configured to convert a user signal such as a touch, selection, vocalization, or a gesture into a machine command or a response to a machine request for input. The interface is often associated with or part of an interactive display operated by the computing machine to communicate with the player and to receive input from the player.

Some embodiments of gaming systems are associated with a “network” or a “communication network.” As utilized herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration or type that is or becomes known. Communication networks may include, for example, devices that communicate directly or indirectly, via a wired or wireless medium such as the Internet, intranet, a Local Area Network (LAN), a Wide Area Network (WAN), a cellular telephone network, a Bluetooth® network, a Near-Field Communication (NFC) network, a Radio Frequency (RF) network, a Virtual Private Network (VPN), Ethernet (or IEEE 802.3), Token Ring, or via any appropriate communications means or combination of communications means.

Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), and/or system to system (S2S).

As utilized herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard. Information may, according to some embodiments, be compressed, encoded, encrypted, and/or otherwise packaged or manipulated in accordance with any method that is or becomes known or practicable.

The term “outcome” is interpreted in that “outcome” is generally a consequence of a “result”, where a result typically involves one or more game elements or game symbols and an outcome may involve a reference to a pay table or other calculation or logic call to interpret the result and take an action. For example, the “outcome” of a game may be a payout of X credits awarded to the player associated with the game. In other embodiments, an outcome for the player occurs when the player or game character wins or loses the session and the game is resolved by settling any bets. It should be noted that the embodiments described herein encompass awards, prizes, incentives and payouts which are monetary, non-monetary, tangible or intangible.

The term “virtual currency” may generally refer to an in-game currency that may be utilized as part of a game or one or more games provided by a game provider as (i) currency for making wagers, and/or (ii) to purchase or access various in-game items, features or powers (e.g., “premium” upgrades and/or options).

A “credit balance” or “reserve” may generally refer to (i) a balance of currency, whether virtual currency and/or real currency, usable for making wagers and/or purchases in a game and/or (ii) another tracking mechanism for tracking a player's success or advancement in a game by deducting there from points or value for unsuccessful attempts at advancement and adding thereto points or value for successful attempts at advancement.

“Seed matrix”—a matrix formed in an initial state of a game, also termed a “seed set”, the matrix having a set of “embeddable elements” to be used in the game. These may include any winning lottery numbers and generally at least one non-random supplemental game indicium. While matrices are readily implemented in a computer, other coding techniques equivalent to a matrix may be used, such that the term “matrix” is not intended to limit the practice of the invention solely thereto.

“Game matrix”—a matrix formed in a transitional stage of a game, and in a preferred embodiment of the invention, more particularly comprising a full set of selectable object elements at play having embeddedly associated therewith, a set of winning lottery numbers, at least one supplemental indicium, and one or a plurality of non-winning indicia, each selectable object element having an association with one and only one embeddable element. While matrices are readily implemented in a computer, other coding techniques equivalent to a matrix may be used, such that the term “matrix” is not intended to limit the practice of the invention solely thereto.

“Random number engine” (RNE)—any device or routine employed to generate a number or sequence of numbers or symbols that lack an observable pattern, i.e., meet statistical tests for randomness such as the Die Hard Battery tests. For some applications, a “pseudo-random number generator” (pRNG) will suffice, for others not. More particularly, combinations of pRNG, TRNG, and kRNE are used to mimic three dimensional kinematic motions of gamepieces resulting in random outcomes in a game of chance.

Pseudo-random number generator (pRNG)—a computational routine or function call favored by computer gamers, where the operation is configured to generate a sequence of numbers or symbols that lack any obvious pattern, i.e., that appear to be generally random. Most such devices are deterministic and may not pass rigorous testing for randomness. Must such devices are deterministic, and may not pass rigorous testing for randomness.

“True random number generator” (TRNG)—relates to an accessory or component of a system, generally a hardware device, for generating a sequence of numbers or symbols that lack any pattern and meet statistical tests for randomness. Generally randomness is “harvested” from chaotic physical processes or quantum measurement processes of nature. Sequences of random numbers generated by such a device may be ported, networked or stored for future use in gaming applications requiring an occasional random output.

“Kinematic random number engine” (kRNE)—a computational operation, invocation or function call configured to generate a sequence of numbers or symbols that lack any pattern, i.e., pass rigorous testing for randomness, in which bodies in motion are modelled, with or without a gravitational force, and subjected to randomized perturbations such as collisions, acceleration, deceleration, elasticity, and friction such that their final resting positions are truly randomized, thereby generating coordinates and/or vectors (or velocities) that exceed a threshold of motion-associated disorder and increased entropy. An implementation of kRNE may also include a hybrid with a pRNG, where the pRNG is used to assign random initial conditions of location, velocity, vector, and spin in one or more axes, in engineering a rapid routine for achieving a threshold level of disorder. In a typical embodiment, a kRNE is implemented by a kinematic engine (12b) operating with an RNE (12c). As coordinates and trajectories are plotted, a graphics rendering engine (12a) is used to “flesh out” the virtual bodies in an animation presented on the display.

“Kinematic engine” is a machine implementation of an engineering discipline used to describe motion of points, bodies, and geometrical objects, and their properties such as velocity and acceleration. For instance, angular rotation can be represented by elements of the unit circle in the complex plane. Ballistic trajectories are represented by the elements of a parabola. By using time as a parameter in geometric calculus, an elegant computational science (termed here “kinematic geometric calculus”) is developed, by which the study of kinematics can be abstracted into purely mathematical equations that are well adapted for use in processor-operated computing machines. Examples of kinematic equations are given at en.wikipedia.org/wiki/Kinematics (accessed 4 Apr. 2015), which is herein incorporated in full by reference. The use of geometric transformations to describe the movement of gamepieces in a gaming system simplifies the derivation of their equations of motion of a virtual rigid body.

Translational kinematic equations include:

v=v₀+at

Δx=v₀t+0.5at²

v²=v₀²+2aΔx

Rotational kinematic equations include:

w=w₀+at

Δθ=w₀t+0.5at²

w²=w₀²+2aΔθ,

and so forth, . . . and include a three-dimensional frame of reference or coordinate system on which real time is superimposed. For simplicity of discussion, the equations are written for x and θ, but are applied in three dimensions. Coordinate systems may be implemented as Cartesian coordinates (x,y,z) or as spherical coordinates in a space defined by a point of origin and a horizontal or azimuthal plane (r,θ,φ), where r is a scalar distance. Collisional kinematic equations are also known in the art. Vector addition and subtraction are well known and more readily performed by a computer. Mass and momentum are also considered (F=m· [symbol] ) in simulating motion. Momentum is a vector quantity; acceleration is a variable or a constant. Collisions are processed when there is an intersection in the relative motion of two gamepiece bodies (defined as three-dimensional rigid bodies) or between a gamepiece and a solid boundary so that elastic or semi-elastic changes in direction, rotation and velocity can be calculated. Gamepiece attributes are used in calculating motion, such as gamepiece virtual mass, virtual dimensions, virtual hardness, and optionally the gravitational constant. Rotational, translational, and collisional kinematic equations are combined in real time rendering or animation of virtual motion in a GRE.

The simulation includes combinatorial factors for plotting changes in direction and accelerations due to collisions with other gamepieces or with the walls or floor of a gameboard. Deceleration due to frictional losses in momentum and dampening may also be modelled. The outcome of the path followed by the gamepieces becomes randomized by complex motions over time, leading to truly random game outcomes—which as will be appreciated by one skilled in the art—cannot be known by the computer until the actual final resting places of the gamepieces (as here in a blinded virtual construct on a gameboard) are realized. In other words, the player may know what faces are coming up before the computer does, an advance in the art that contributes to the excitement of the game.

Parameters such as gravitational acceleration and time may be varied according to the creative energy of the game operator, but players have an innate sense of realistic physical motion and a preferred game operates to achieve a simulation of realism in a virtual space. Special effects, such a a dice throw in a gravity free environment, or bump in the space time continuum depicted as a slow motion animation, may be provided in the form of selections made by the player during game setup.

“Selectable object” or “selectable object element”—an object element in a computer memory, typically having attributes of a gamepiece such as color, luminance and virtual mass, and incorporating attributes of dimension, shading and spatial location of a virtual representation of a physical object for display and selection on an interactive player interface. Simulated objects include lottery balls, symbols or “segments” on the circumferential strip of a slot wheel, dice, die faces, dice facetypes, tiles, coins, rocks, cards, puzzle pieces, and so forth. More particularly, by “selectable” is indicated the capacity of a player to pick one selectable object element out of a plurality of unselected object elements by using a game interface, as in a game of conceal-and-reveal, whereby the embedded contents of the selection is revealed according to programmable instructions executed by a processor in a gaming system.

“Embeddable element”—a datum element in a computer memory, more particularly such that the embeddable element (also sometimes termed “embedded element”) is reversibly or interchangeably associated with a selectable object element or gamepiece in a transitory memory; where embeddable elements may be concealed and later revealed on a display surface according to programmable instructions executed by a processor of a gaming system.

“Embed”—generally refers to the capacity of gaming system to “associate” a first data value to a second data value in an array or matrix or by a programmable instruction, such as by mapping a winning lottery number and/or other indicia to an embedding element or a virtual position in an array or matrix of elements or virtual positions. “Embedding” is defined as a process for association of a representation of an “selectable object element” or map location with a winning number or other indicia in a memory device such as a random access memory (RAM). An embedding element refers first to a location or object-oriented code associated with the embedded data, and secondly to a visual representation or manifestation that appears on the user interface when an embedded element is selected and revealed. One or more embedded elements may be revealed in response to a first round of betting and selecting, for example. These may match pre-determined winning numbers or indicia and if game conditions or met, result in the award of a game win. In addition to embedded lottery numbers and/or indicia, program instructions (also termed here “function calls” or “invocations”) may be embedded in a game matrix and are executed when a player selects a particular selectable object.

“Indicia”—refer broadly to symbols, signs, indications, or distinctive markers which evoke special significance for gameplay, particularly in scoring wins and losses when establishing outcomes. These include indicia identified by the gamemaker or game provider as, “jackpot”, “free play”, “wildcard”, “bonus”, “power ball”, “game over”, “hotspot”, “instant”, “cherry”, or “bar”, and so forth, without limitation thereto. Indicia generally are presented visually, but may encompass or be formed from sounds, lights or vibrations, or other sensory feedback to the player. Typographical characters such as “wingdings” and foreign language alphabets may also be included and fall within the scope of the meaning of “indicia”. Numbers are also indicia, but are treated here as a distinct class of indicia having distinct significance in playing and betting a lottery matching game, particularly the hybrid lottery matching games of conceal-and-reveal games disclosed here, and related games. Lottery numbers are generally defined as a series of Arabic numerals, for example in the range of 1 to 49, 1 to 59, or 1 to 29 (but not limited thereto), but in some game variants, lottery numbers may be alphanumeric character strings, alphabet characters, or symbols more generally. Numbers indicating currency or face value are also used as indicia and may be selected at random from a pool for insertion into a seed matrix or may be or non-randomly inserted into a game matrix.

“Lottery winning number”—a number selected at random in a game, generally from a pool of lottery numbers in memory, and more particularly representing a first class of “embeddable elements” such that when associated with a selectable object element and selected by a player, a “match” is entered in a win register or “player's tally window”. If sufficient matches are entered, an award is made.

“Supplemental game indicia” refer to a second class of embeddable elements such that when associated at random with a selectable object element and selected by a player, a prize condition is entered in an award register. If all conditions are met, an enhanced award is made. Examples include bonus indicia, progressive jackpot indicia, hotspot indicia, and wildcard indicia.

“Non-winning indicia” include a third class of embeddable elements, and may be selected for example from the residue of non-winning lottery numbers in memory that are drawn on to fill a game matrix.

“Blinded virtual construct”—a construct of selectable object elements virtually displayed to a player so that the player may select at least one plurality of elements from the construct and reveal the embedded elements concealed therein. A blinded virtual construct may be for example a scratchcard having an array of scratch pads (as can be each defined by a frame), a structure made of dice (such as a pyramidal stack) where each occurrence or wall of the structure is playable as a separate game in series or in parallel, and/or each “facetype” (as defined by pip number, color or value) of the dice is playable as a separate game in series or in parallel. Other blinded virtual constructs may include constructs of balls, tiles, or even animated figures, where the selectable object elements are more generally termed “gamepieces”. Gamepieces may be organized into clusters, walls, pyramids, towers, disordered stacks of jackstraws, blocks, tessellations, puzzles, polygons and so forth, without limitation. Preferably the gamepieces have attributes sufficient for 3D rendering and animation.

“Dice” (plural of “die”) is a virtual gamepiece having multiple sides or faces, each face is identifiable by a particular pattern of pips, or by a color or value where by faces may be classed into facetypes. The number of faces may six as in a cuboidal die, but may be greater or less than six if desired.

Playline—a row, column, diagonal, ladder, stair, or facetype on a blinded virtual construct having an associated award if matched.

“X”—a set of winning random lottery numbers as played in a game, where X is the number of the elements in the set.

“Y”—a set of supplemental game indicia as played in a game, where Y is the number of the elements in the set.

“Z”—a set of non-winning lottery numbers as played in a game, where Z is the number of the elements in the set.

“N”—the total number of selectable object elements or gamepieces in a game matrix, where N=X+Y+Z.

“ΣQ*”—the total number of matches in a player's tally.

“Initial stage”—of or related to an initial visual state of a game displayed to a player, more particularly however including formation in memory of a seed matrix for a conceal-and-reveal game.

“Transitional stage”—of or related to expansion of a seed matrix and formation of a randomized game matrix including a full set of selectable object elements paired with embeddable elements.

“Transformational stage”—of or related to transformation of a game matrix into an interactive game presentation with a “blinded virtual construct” (also sometimes termed a “gameboard” but not limited to 2D constructs), including provision for receiving selections and/or bets. Generally includes an animation with motion and a kinematic engine for randomizing said motion, such as the trajectories of dice or the spin of a wheel. The animation contributes to the randomization of gamepieces in the blinded virtual matrix and may also involve randomization of the associations of embedded elements with selectable object elements of a game matrix if desired, for example “reel hopping” of embeddable element associations during a reel spin during a multi-reel slot simulation as may be useful to assemble a complete set of winning lottery numbers in a randomized distribution in the “window” of the simulated slot machine.

“Play stage”—indicates a presentation state where a player must interact with the game as displayed according to rules of gameplay executed by a processor; typically including responses to various interactive controls operated by the player such as in making a selection or placing a bet.

Relative terms should be construed as such. For example, the term “front” is meant to be relative to the term “back,” the term “upper” is meant to be relative to the term “lower,” the term “vertical” is meant to be relative to the term “horizontal,” the term “top” is meant to be relative to the term “bottom,” the term “inside” is meant to be relative to the term “outside,” and so forth. Unless specifically stated otherwise, the terms “first,” “second,” “third,” and “fourth” are meant solely for purposes of designation and not for order or for limitation. Reference to “one embodiment,” “an embodiment,” or an “aspect of the invention,” means that a particular feature, structure, step, combination or characteristic described in connection with the embodiment or aspect is included in at least one realization of the present invention. Thus, the appearances of the phrases “in one embodiment” or “in an embodiment” in various places throughout this specification are not necessarily all referring to the same embodiment and may apply to multiple embodiments. Furthermore, particular features, structures, or characteristics of the invention may be combined in any suitable manner in one or more embodiments.

It should be noted that the terms “may,” “can,” and “might” are used to indicate alternatives and optional features and only should be construed as a limitation if specifically included in the claims. The various components, features, steps, or embodiments thereof are all “preferred”—whether or not specifically indicated as so. Claims not including a specific limitation should not be construed to include that limitation. The term “a” or “an” as used in the claims to refer to an element does not exclude a plurality of said element.

“Conventional” refers to an article or method designating that which is known and commonly understood in the technology to which this invention relates.

A “method” as disclosed herein refers to one or more steps or actions for achieving a described end. Unless a specific order of steps or actions is required for proper operation of the embodiment, the order and/or use of specific steps and/or actions may be modified without departing from the scope of the present invention.

Unless the context requires otherwise, throughout the specification and claims that follow, the term “comprise” and variations thereof, such as, “comprises” and “comprising” are to be construed in an open, inclusive sense—as in “including, but not limited to.”

The appended claims are not to be interpreted as including means-plus-function limitations, unless a given claim explicitly evokes the means-plus-function clause of 35 USC §112 para (f) by using the phrase “means for” followed by a verb in gerund form.

“Adapted to” includes and encompasses the meanings of “capable of” and additionally, “designed to”, as applies to those uses intended by the patent. In contrast, a claim drafted with the limitation “capable of” also encompasses unintended uses and misuses of a functional element beyond those uses indicated in the disclosure. Aspex Eyewear v Marchon Eyewear 672 F3d 1335, 1349 (Fed Circ 2012). “Configured to”, as used here, is taken to indicate is able to, is designed to, and is intended to function in support of the inventive structures, and is thus more stringent than “enabled to”.

### DETAILED DESCRIPTION

Described here are representative gaming systems and games embodying principles of fun, freshness, familiarity and velocity of play. In the world of game engineering, these and other aspirations are advanced by the technical contributions of the present invention to the art. In a first embodiment of the inventive gaming systems, kinematic randomization engines are described based on virtual modelling of chaotic physical processes, providing non-deterministic means for generating randomness. Game outcomes are not knowable until the gamepieces stop moving, ensuring that the computer has not determined the game outcome until play is ended.

This art is particularly relevant to games of “conceal and reveal”, in which every game includes all the winning elements—the player has only to select the correct gamepieces to win a concealed prize. These games have a long history of deception, going back ancient shell games in which the player had to choose the walnut shell under which a bean was hidden, but were frustrated by sleight of hand and trickery. Players know that most electronic betting games are over before they begin, the computer having already determined the result, and thus a gaming system in which a player is able to discern the game outcome before (or at least at the same time as) the computer is an advance in the art. A solution to this problem rests in the way in which randomness is engineered into gaming systems.

The gaming systems of the invention are configured to display randomized motions for a plurality of virtual gamepieces, termed here “selectable object elements”, each selectable object having a concealed “embedded element” that is revealed by selection during gameplay. In the preferred systems, the motions of the gamepieces are so realistic as to result in random distributions of the gamepieces when motion stops. Players are then offered a limited number of selections to guess the right gamepieces and win a prize. A player's control of the outcome is not an illusion, a series of correct choices will ensure a win, but the game is made more challenging and interesting by including non-random supplemental game indicia that enhance the prize but decrease the odds of winning, and by breaking the gameplay into a series of escalating bets such that the player must decide to continue for higher stakes or to fold based on a subset of selections.

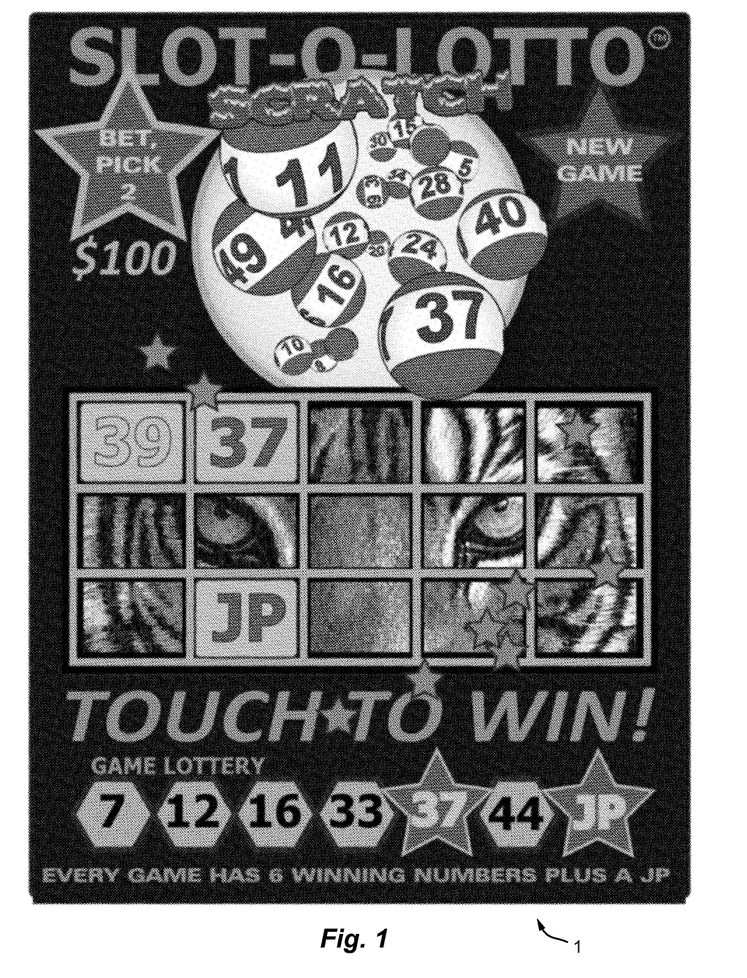

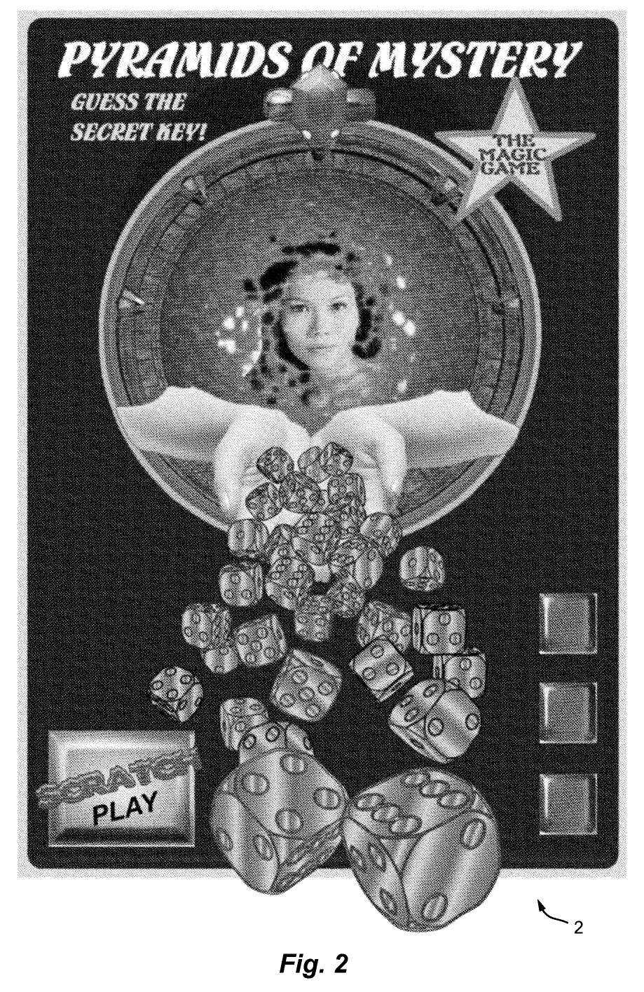

Synergically, the improvements in kinematic modelling used to achieve valid random outcomes also result in startlingly realistic animations, no two of which ever repeat. Examples of dramatic visual effects tied to a random number engine of the new gaming systems are given in FIGS. 1 and 2.

FIG. 1 is a drawing of a first “scratch” game 1 in progress, SLOT-O-LOTTO SCRATCH™, played on a gaming system on the invention. A virtual scratchcard is depicted, and shown are a player's initial selections. An object of the invention is to realistically simulate motion in all respects, even the tiger's eyes move like a living animal pacing in a cage. Lottery balls stream out like bullets, mesmerizing the player, who must match a plurality of the lottery numbers drawn for the game (bottom row) with his own picks from a scratch card in order to win. Generally the player must place multiple rounds of bets in order to win big. The game is a hybrid of lottery, slots and scratch games. Slot reels morph into a scratch card, the scratch card having concealed instant win lottery numbers. The jackpot indicium (JP) is a non-random selection that is inserted in all games.

FIG. 2 is a drawing of a second “conceal-and-reveal” game 2 in progress, termed here “Pyramids of Mystery”, played on a gaming system of the invention. Shown is a dice roll in which dice cubes appear to fly and bounce from a player's cupped hands in an endless stream. The view represents a simulation of the visual accompaniments of a dice throw in a gaming machine by which random winning lottery numbers are selected, mixed with non-random game indicia, and embedded, one each, in a subset of the dice cubes presented to the player. The dice will assemble into a blinded visual construct that embodies an array of winning numbers and other random and non-random indicia. A dice roll morphs into a virtual construct for a three-dimensional conceal-and-reveal game in preferred embodiments of the games. The two games illustrated have common technical features and are “conceal-and-reveal” games played with a mixture of random and non-random embedded elements.

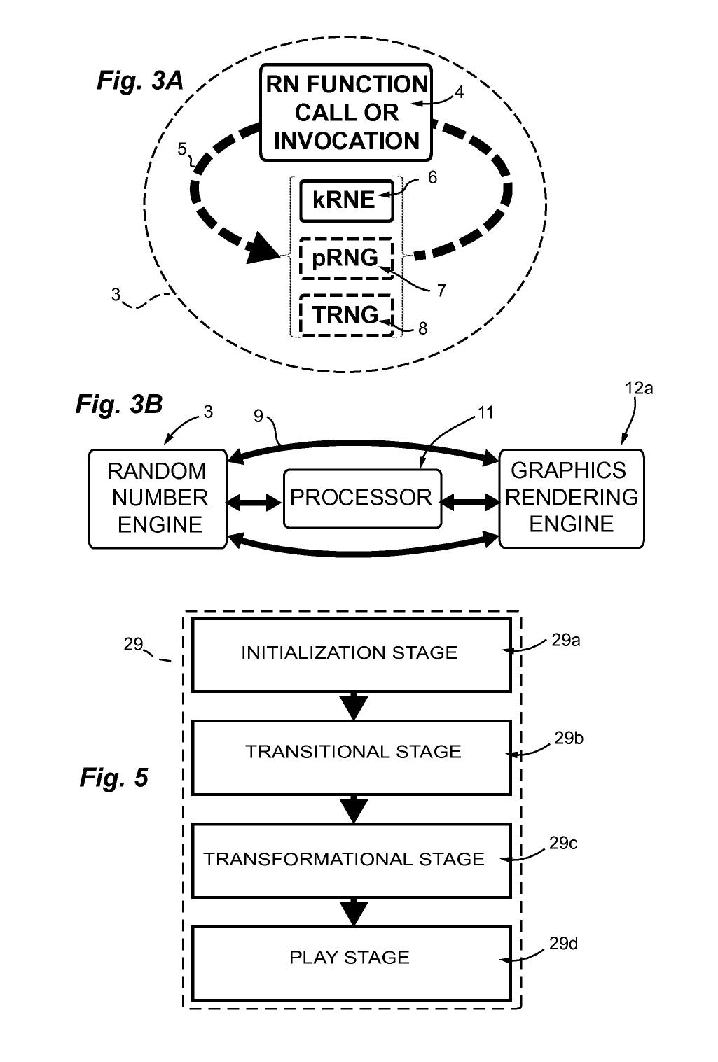

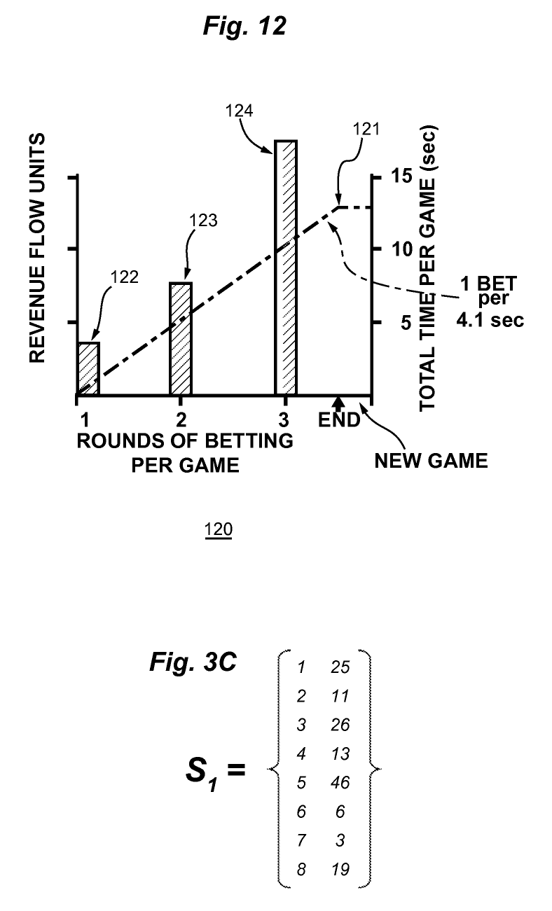

FIG. 3A is a schematic representation of a random number engine “RNE” 3. A function call or invocation 4 of the RNE may take a number of forms depending on the game requirements. The process generally operates as an iterative loop 5 during motion of the gamepieces. Kinematic equations of motion, including spin (as in the case of a slot reel) or spin, translational and collisional motion (in the case of dice) are solved in real time as part of the virtual mapping of the gamepieces in motion. One of three or a combination of two or more RNEs, indicated here as including a kinematic RNE (kRNE, 6), a pseudo-RNG (pRNG, 7) and a true RNG (TRNG, 8) are used to randomize outcomes. The simplest form, a pRNG may be used for example to establish initial positions of gamepieces and in less authentic games, quickly assign pseudo-random lottery numbers. The TRNG is generally a hardware device or is accessed via an internet connection but can be used by storing random numbers in advance of a game. The kRNE is an elegant solution, allowing the kinematics of motion to establish a random outcome. When gamepieces are agitated, percolated, rolled, bounced and collided, the changes in direction give rise to an inherent level of disorder such that no computer determinative process can predict their positions over time. The gamepieces must come to rest and be selected before their embedded content can be known.

pRNGs are commonly used in computerized games because execution of a simple software function call is efficient and requires minimal coding; most such function calls are native. However, the player will likely know that the game is not truly based on random chance, and that knowing may dampen the player's interest. Such games would fail stringent tests for randomness.

Although randomness may be achieved by the independent operation of a TRNG, where large numbers of iterations are needed, porting a TRNG live feed from a commercial supplier may slow the processor. Thus where alternatives exist, TRNG is reserved for truly critical randomizations. More preferably, kRNE may be used because of the synergy achieved by a more realistic and entertaining visual simulation. Typical implementations of kRNE may involve simple calls for pRNG initialization variables to be substituted into the equations of motion of a virtual rigid bodies. These variables include initial position, velocity and spin. Once initialized, random variability increases as the gamepieces move. However, randomness is not dependent on initial conditions but is in fact inherent because of the uncertainties in timely detecting an impingement of a gamepiece with another gamepiece or a boundary, so an entirely native kRNE is possible, i.e., an implementation in which the laws of kinematics, when iterated for a system in motion, will produce a disordered result independent of any initial parameters. Thus the trajectories of gamepieces percolating in a virtual machine will reach a state of disorder in which gamepiece positions and orientations are valid for strict tests of randomness.

True randomness is not an input, it is an observation of the output of a system, and by applying multiple variables and multiple degrees of freedom in a kRNE subroutine, a large series of collisions will occur between virtual flying gamepieces and the virtual walls or floor of a virtual gamespace will occur. A random output of a game is achieved by a combination of a player's inputs by way of selection of randomized gamepieces and what we term a “kRNE” capability of a gaming machine, a technical advance in the art. The random number engine operates cooperatively with a graphics rendering engine and a kinematics engine.

pRNGs may be useful for kinetic modelling in hybrid systems as suggested in FIG. 3A, where multiple rounds of RNE function calls occur. Initial gamepiece weight and dimensions are likely constant, but the direction, texture and speed of a prime mover can be randomized, or alternatively, the initial velocity, acceleration, vector, and multi-axial spin of the gamepieces (or other gamepieces) can be randomized using pRNG values that are substituted in a kRNE motion calculator. Matrix and vector calculations can then be used to implement the laws of motion and to track position, spin, velocity and vectors. Algorithms for collisional reactions are known in computer graphics. pRNG may again be used to select bounce and elasticity properties, and collision detection (virtual objects will impinge in flight but detection of contacts between walls will be inexact), if needed. These simulations may all be handled by software (or firmware) using iterative and conditional trees, but surprisingly are inherently non-deterministic because the end result perceptibly is never repeated when running the same software twice—due to the large number of degrees of freedom in the variable structure and steps in the flight path in a three-dimensional space. Just as a leaf does not fall from a tree over and over to the same spot, each rendering of a gamepiece in motion will take a unique path. TRNGs may also be useful, such as in associating embedded elements with selectable object elements and for operations such as reel hopping as will be described below.

Animations are then based on dimensions and realistic kinematics of gamepieces in motion, but also including the appearance attributes such as color, lighting and perspective. The initial modelling of motion and of graphical rendering are thus very similar and may be performed in a coordinated iterative calculation. The complexity of calculating various kinds of motion, including ballistic trajectories, rotary and spinning motions, as well as collisions and bouncing, can be reduced by use of Geometric Algebra (GA), which has emerged as a powerful alternative to classical matrix algebra and calculus as a comprehensive conceptual language and computational system for computer science. Included by reference are a series of texts on physical animation relevant to the simulations. These include: DORST, L et al. 2007, Geometric Algebra for Computer Science: An Object-Oriented Approach to Geometry, Morgan Kaufmann (Waltham, Mass.), 664 pp; VAN DEN BERGEN, G. 2012, Collision Detection in Interactive 3D Environments, Taylor and Francis, 278 pp; and ERLEBEN, K et al. 2005, Physics-Based Animation, Charles River Media (Rockland Mass.) 817 pp.

In the gaming systems of the invention, linear and angular velocities (and also momentum) are modelled for complex solid objects to produce animations (simulations). A variety of computer graphical techniques known in the art may be used to cover and color the underlying models once the coordinates and vectors are known relative to the eye of the player. These include 3D vector modelling, ray trace, ray casting, and texture mapping polygon engines, and more generally, “voxel engines” as are currently used to simulate virtual realities. The 3D rendering engines may be implemented on iOS (Apple Computer, Cupertino Calif.), CHROME (Google Inc, Mountain View, Calif.), Android (Google), ARM (Arm Holdings, Cambridge UK), Windows (Microsoft Corp., Redmond Wash.), QNX (Blackberry, Waterloo ON CA) and other operating systems on a variety of computerized machines, including most cell phones, mobile devices, and also in casino gaming machines by supplying the needed programming on compatible EEPROM devices.

Thus fortuitously, in an effort to improve the realism of the graphics, the problem of determinacy in computer random number generation may be overcome. Hybrid pRNG and kRNE systems or pure iterative kRNE systems operated in a virtual three-dimensional simulation of animated motion will result in non-deterministic outcomes and are computationally inexpensive improvements of existing graphics engines.

This implementation goes against conventional wisdom. In the conventional art of gaming, during the transition of lottery games (and slot machines) to electronic formats (e.g., video slots), once a game was activated, the result was already decided (i.e., the formulaic pRNG function call is deterministic). A pre-packaged pRNG call in the software decided on an outcome of the game the instant the player pulled the lever, and then engineered the graphics to present the result. As a result, betting velocity could be increased substantially because the actual game is over in nanoseconds. Of course the player increasingly is aware that the Goddess of Luck is no longer the deux ex machine, forfeiting some of the magic of the game to its logic and its circuits.

Typically the RNE function call is part of an iterative loop 5. Initial motions of gamepieces are repeatedly redirected by collisions with other gamepieces and with boundary layers of the simulation. The net result is a randomization of coordinates and vectors, and may also be used to produce strings of random numbers from embedded data for use in other calculations requiring an TRNG or an RNG seed whereby essentially the kRNE becomes a source for TRNG-equivalent random numbers in storage. Thus the RNE call may be a multi-functional iterative call involving kRNE, TRNG and pRNG as shown in FIG. 3A.

A first application is a lottery draw simulation, randomization is achieved by applying kinetic equations to balls percolating in a lottery hopper. Drawing a series of winning lottery numbers is then achieved by selecting balls by pRNG in a way that appears to be random, or may be achieved using a TRNG to control an animated ball capture device. In another instance, kRNE may be implemented such that only balls having a certain trajectory and/or momentum are captured, thus providing the game designer with several ways to achieve a truly random outcome.

Importantly, these machines are tested to certify a statistically random output that is not achievable with a purely software-driven pRNG. Random behaviors are demonstrably aperiodic and meet reliable tests of statistically testable randomness such as the Diehard Battery tests. For example, random generation of lottery numbers is valid if any numbered ball drops with a frequency that is essentially the same as the frequency that other numbered balls drop (when a large sampling of ball drops is made) and also, as a corollary test, a histogram of pairs of balls that drop in sequence is essentially flat for all such pairs. More precisely the null hypothesis is not rejected with a high degree of confidence. These are basic statistical tests and are easily implemented in any quality evaluation of a gaming system.

For comparison, the familiarity and visual excitement of a real lottery draw is drawn from special machines configured with transparent cages or hoppers of numbered balls that are agitated in all directions by a paddle, rotating plates, or by a jet of air, and the effect and verisimilitude is lost when an electronic instant list of numbers appears on a display. Because a lottery draw machine cannot be supplied to every mobile device or gaming system, alternatives are needed that more successfully emulate the excitement of the draw in a computer display but do not jeopardize the fairness of the draw.

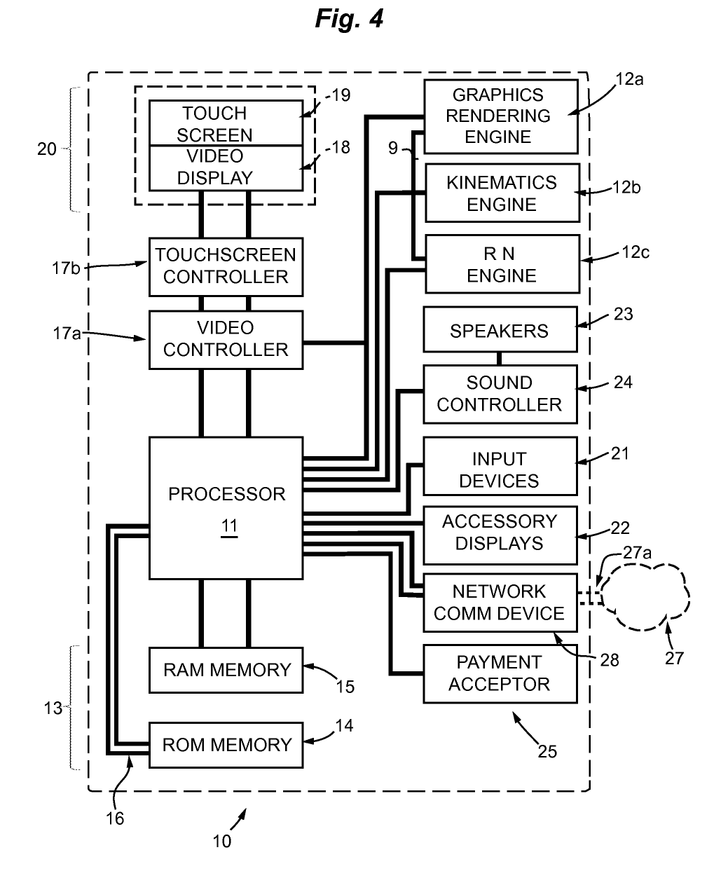

FIG. 3B expands these concepts and is a schematic representation of operative links between a graphics rendering engine 12a, a random number engine 3, and a processor 11. The random number engine and graphical rendering engine are capable of independent and/or cooperative operation 9, as a daemon, an ASIC, or an independent processing thread, and may make periodic outputs to and receive new input from a central processor (CPU) 11 that manages or administers the overall progress of the game. The GRE may receive inputs from the RNE, but may also provide randomized outputs to the RNE. The integration may also include a kinematics engine as described in FIG. 4, or the kinematics modelling may be executed in the processor with instructions from ROM. A video card (video controller, 17) may be slaved to the graphics rendering engine in some system architectures.

Kinetic collisions and trajectories are highly unpredictable en masse, even in a virtual environment, and advantageously provide a more realistic presentation of the ball motion. An acceptable level of randomness is achieved without installing additional hardware (not even a dongle) on a consumer mobile device. Each lottery ball is constructed from a larger table or matrix, such that each ball in the matrix represents a selectable object element (a virtual representation of a ball) and is assigned at random an initial vector, velocity and spin using a pRNG. Kinetic computations are then made to interact the balls; collisions and bounces become increasingly unpredictable and pass a threshold of disorder such that the frequency of selecting any one ball is essentially equal to the frequency of selecting any other.

An example of a result, such as a lottery draw, is shown in FIG. 3C. The winning lottery balls are shown as a matrix, termed here a seed matrix {S₁} or seed set. Each number is an object, a ball, and each ball has attributes of diameter, coloring, shading, and mass. For each ball, the seed matrix also contains an embeddable element (a lottery number embeddedly associated with the ball). Thus when six, seven or eight balls are dropped, the lottery numbers associated with those balls are transferred to a seed matrix in transitory memory and are accessed by the computer processor in operating the remainder of the game. The non-winning lottery numbers associated with the remaining balls in the hopper are returned to a table or “pool” in memory and may be used in later stages of the game as needed. Attributes of the seed matrix may be contained in an object database and may include for example spatial coordinates of a virtual object, gamepiece model features, and an associated embeddable element.

It should be noted that for purposes of a “conceal-and-reveal” game, the lottery numbers need not be random, only the positioning of the winning numbers in the blinded virtual construct must be random. Thus in one embodiment of the invention, a lottery ball drop animation is not used, and players are given other visual cues that a randomization is occurring, such as a dice throw.

The invention is not limited to lottery draws, which lack a meaningful interactive component for engaging a player directly. In preferred games of the invention, a lottery draw is coupled to a conceal-and-reveal game. Regardless of what lottery winning numbers are drawn for the game, the player must actively select them after they are randomly distributed and concealed on a game board. Thus the draw of any particular lottery number in a lottery machine, virtual or not, does not affect the odds of winning in a conceal-and-reveal game where the lottery number must be revealed by a player selection.

By way of comparison, the odds of matching a lottery draw against a defined series of six winning numbers, where 49 balls are at play, are:

$$f = \frac{6}{49} + \frac{5}{48} + \frac{4}{47} + \frac{3}{46} + \frac{2}{45} + \frac{1}{42} = 0.000000075 ,$$

or one out of Ser. No. 13/348,188. Add a power ball and the odds become astronomical, discouraging most players.

But for a pick game of conceal and reveal, where the payer must match the winning lottery numbers concealed under 15 blinded tiles, the odds are:

$$f = \frac{6}{15} + \frac{5}{14} + \frac{4}{13} + \frac{3}{12} + \frac{2}{11} + \frac{1}{10} = 0.000199800 ,$$

or about one out of 5000, a much more fun and winnable game.

Thus the games (traditional lottery versus conceal-and-reveal games) are clearly distinct, and a new kind of randomization is needed to ensure that each embedded element (a winning lottery number) and each tile (representing a selectable object on a player interface) are truly randomly positioned in a blinded virtual construct. This is most efficiently and synergically achieved by randomizing the motions of gamepieces during assembly of the virtual construct. This principle applies to spinning slot reels, to dice throws, and to other means of assembling gamepieces for a “shell game” of any kind

FIG. 4 depicts components of a computerized gaming system 10 configured to operate a game of chance, the processor 11 having a connection to a graphics rendering engine “GRE” 12a, a “kinematics engine” 12b, and an “RNE engine” 12c. The rendering, randomization and kinematics system may be an integration of the three components (12a, 12b and 12c) and may operate independently, in tandem, with the processor as a subordinate functionality, or independently of the processor. The RNE (12c) may include a plurality of selectable component functionalities as suggested in FIG. 3A. Synergically, the RNE, kinematic engine, and GRE function cooperatively operate to simulate realistic motions of gamepieces, enhancing the game quality and excitement while ensuring fairness. Some components may be implemented as firmware or as application specific integrated circuitry (ASICs).

Other components of FIG. 4 are introduced here. The components shown may encompass but are not limited to components useful in enabling the games. Conventionally known components and accessories may be omitted for clarity. The processor may be a microprocessor, a multi-threaded processor, a CPU, or any digital controller known in the art. The processor 11 is digitally connected to a memory utility 13. Shown here are read-only memory elements (14, ROM) and random access memory elements (15, RAM) such as are known to facilitate execution of a program by a processor. ROM elements may contain programming instructions in generally non-volatile storage form, and RAM elements typically store data temporarily, data that is reset such as at the start of a game or a game series, or in the course of iterating a program loop. RAM is used for recording the set of randomly selected winning lottery numbers associated with a particular game, for storing matrix data associated with embedded elements in that game, and for recording bets made during a game, for example. RAM typically has memory locations associated with game status, accessory display status, and soft button status on the user interface. These memory locations store information about the indicia at play, user preferences such as themes selected by the player, the bets placed, the player's winnings, the speed of the game, data for automatic play, analytics, and so forth. ROM elements include memory for storing program instructions used to run the games. Program instructions may be stored on a hard disk (not shown), or in the cloud, but are more typically stored in local ROM 14. Advantageously, the ROM memory may be an erasable programmable read only memory (EPROM), and yet more advantageously, the program instructions may be updated at will (flashed) from an external link 16 under control of the game operator.

In some gaming machines, an application specific integrated circuit (ASIC) may be used, limiting the requirement for software. These integrated circuit memory storage components are well known in the art so are not discussed further. The advantage to providing all game logic on a network connection (16) or on EPROM, is that a game and/or associated programmable thematics and style elements may quickly and easily be updated, or a different game program be loaded to run on the computer without having to reconfigure any circuitry. In contrast, the ASIC approach offers speed of execution, reduced processor size, reduced bandwidth requirements, improved manufacturability and simplified troubleshooting capability; this kind of firmware finds application for game boxes or casino gaming machines, for example.

Peripheral devices associated with the processor may include a video controller (17a) and video display (18). In some embodiments, the video controller is embedded in the processor, but is a functional component identifiable as providing control of the video display, including typically image buffering, which may be an LED image, an LCD image, a rasterized image of a CRT, or a projection in augmented reality glasses, for example. For gameplay having an integrated touch screen capability, the video display may be intimately associated with a capacitive touch screen (19) as part of a display panel (20). The touch screen and video components may share data, and operate in digital communication with closely associated video and touchscreen controllers (17a, 17b) and the processor.

The processor may also be connected to other peripheral devices such as a game management console having one or more accessory input devices (21), accessory displays (22) and speakers for audio effects. The speakers (23) may be driven by an audio controller (24). Also linked to the processor is an optional payment acceptor (25) as known in the art, which may be a coin, token, or card acceptor configured to allow a player to place bets according to commands received by the processor from the player. Means for dispensing game awards are known in the art and may be included as needed, however gaming systems are increasingly networked so that award subroutines are handled by a remote server or cloud-based service. Network communications device (28) may be a network card for connecting the gaming system (10) at 27a to a central computer or server, such as through a cloud-based portal (27).

Gaming platform programs may be written in object database architecture or relational database architecture. For example if the blinded virtual construct is an object database of selectable object elements, each selectable object element is assigned object rendering attributes such a color and dimensions, kinematic attributes such as mass, a unique embeddable element value that is concealed until scored, and a set of spatial coordinates at rest, such that the spatial coordinates, unique embeddable element value, kinematic and rendering attributes define the selectable object relative to other selectable objects of the blinded virtual construct.

FIG. 5 is a block diagram of a multistage game 29. In a preferred game type, each game combines several simulations with animation, each simulation an emulation of a familiar gaming device such as a lottery ball drop, a slot reel machine, a scratch card, or a dice throw. More particularly, in the games illustrated, program instruction sets executed by a processor in four interlocking stages are configured to direct a “conceal-and-reveal” game type. Stages of gameplay are stored in state memory and can be recovered if power is lost or a dispute arises.

Shown are boxes for an initial stage (29a), a transitional stage (29b), a transformational stage (29c), and a play stage (29d) as representative of an exemplary game architecture. The inventive randomization functionalities are operative in one or more preliminary stages of the game architecture, but not after a player takes control of the game in the “play stage”.

The initial stage (29a) may be a lottery draw simulation, where a lottery draw machine is emulated using a kinematic RNE with graphical rendering engine and optionally pRNG and TRNG to simulate random motion of percolating lottery balls. The draw is completed by selection of a set of winning lottery numbers. To win the game, the player must match a plurality of the winning lottery number by making selections of selectable objects from a randomized blinded virtual construct represented on the display. While randomization of the winning lottery numbers is suggested, it is not necessary to achieve true randomization in the subsequent steps of “conceal-and-reveal” gameplay; it is however useful to establish player trust.

The second stage (29b) is a transitional stage. A seed matrix having the winning lottery numbers is expanded to include supplemental game indicia (such as bonus indicia, wildcards, a progressive jackpot indicium, and hot spots) and non-winning lottery numbers. At least one supplemental indicium, generally two supplemental game indicia, are non-randomly chosen by the game operator and are included in the game matrix before spatial randomization. The seed matrix is expanded into a game matrix that comprises a selectable object element (as will be displayed to the player) and an embedded element (as will be concealed from the player until a selection is made). Non-winning random lottery numbers or other random non-winning game indicia are used to fill out the game matrix.

The third stage (29c) is a transformational stage. The game matrix is transformed in one or more virtual kinetic events to move and randomize the elements; the transformation is completed by presenting the player with a scratchcard or some other blinded virtual construct of selectable object elements. The simulations involve kinetic randomization steps such that embedded data and selectable object elements are fully randomized. Randomization in an RNE may occur by a combination of pRNG, kRNE and TRNG function calls that operate cooperatively with a GRE and a kinematics engine for solving equations of motion.

Once the presentation of the game setup is complete, the player takes control and the game play stage (29d) begins. The gamepieces and associated embedded elements are fixed and cannot be switched. The player will then interact with the gaming system to make selections and receive awards for matching embedded content with the winning lottery numbers, as modified by any supplemental indicia in the players selections.

The various stages may be merged in some instances, for example the first three stages from initialization to transformation are generally performed without player inputs so may be combined as a “presentation stage”, followed by a “play stage”, such that the game has two stages, not four. The conceptual value of separating the stages is in demonstrating how random and non-random indicia may be incorporated into conceal-and-reveal games and how nested simulations may be run to make the play more interesting.

Use of kRNE in randomizing animations of the transformational stage is described by example. First, taking slot reels, emulation of the path of a symbol (such as cherry, bell, bar, etc.) on an outside strip of a slot reel is a function of time and may be described mathematically as a rotation on a cylindrical path using classical vector notation. Using computing machine-driven angular momentum calculations, a non-linear virtual force of axial rotation may be modulated or degraded randomly by an unsteady resistance to model a slowing of the rotation of the slot reel and a stop at a detent. Similarly, using the more elegant bivectors of “geometric calculus”, acceleration and slowing are easily computed so that a graphical simulation of a spinning slot reel in motion is life-like and is randomly non-determinant. The player will view the slot reel accelerate to a blur; then slow and stop such that the final resting position of the symbols is not known until the spin is completed. While this is an intuitive explanation, the kinematic mechanics (“kinematics” is used here sensu lato to describe “virtual selectable object representations” as bodies in motion) are readily implemented in a gaming system of the invention, and after several revolutions in which acceleration and slowing are modulated without any periodicity) an essentially random outcome is achieved. Similar analysis may be applied to a variety of rotational motions, including roulette wheels and fortune wheels. Fundamentally, the equations are indifferent as to whether the objects are real or virtual.

It will be apparent that the symbols on the virtual reels (each reel is segmented on its circumference) may be represented in a matrix in the memory of the processor, one for each reel. The symbols or “segments” of the reel are thus selectable objects and may be read from the virtual window of the slot machine by daemons assigned to track them. Embedded content may also be associated with each symbol or with some symbols, for example winning lottery numbers may be associated at random with the selectable object elements of each reel. Where the number of symbols on the slot reels exceeds the number of selectable object elements in the game matrix, the kinematics engine tracks the two classes and, once a state of disorder is reached, reassorts the symbols so that the selectable object elements containing the number of embedded elements required for the game may be isolated in the slot reel window. This simply requires an overlay such that the selectable elements visible in the slot reel window are in flux but the embedded elements of the game matrix are locked in their spatial distribution in the slot window when a valid random distribution is achieved. Equivalently, reel hopping is conditionally permitted such that the embeddable elements are able to hop from reel to reel and be associated with a selectable element that stops in the slot machine virtual window once valid randomness of their distribution is ensured.

Slot machine reel simulations are difficult to animate because the reels must rotate so as to speed up and slow down to stop. Part of the excitement is watching the blurring streak of the spinning wheels slow down so that the winning symbols drop into place on the payline. But in classical video slot play, the winning result is already decided at the instant the game begins. This is because a random number generator (pRNG or TRNG) throws up a set of symbol combinations that are predeterminate of the outcome. The reels are programmed to “stop” according to the intended game outcome. The spinning is just a video equivalent of a sleight of hand; the outcome was never a matter of blinded luck. Any additional pay lines are also pre-determined. Advantageously, the slot gaming systems of the present invention overcome this problem and can legitimately restore a player's confidence in the fairness of the game.

New to the field of electronic gaming machines are virtual representations of dice. Dice are not yet broadly represented because of the difficulties in representing visualizations of dice in flight and also the due to the slowness of play. However, using geometric or classical calculus, and by selecting variables from initial position in the hands or in a cup from which a dice throw is made, along with spin, velocity, and vectoring, gamepieces such as dice may be shaken and thrown onto a gaming surface in virtual space and will realistically collide and bounce to ensure that the final resting place and orientation of each die is at random. This can be very satisfying to the player and enhances the player's confidence that the game is not rigged. The outcome of the dice throw is not known until the gamepieces come to rest.

From these examples, the benefits of operating a kRNE engine readily become apparent. While useful in generating random outcomes, the same calculations (in a 3D virtual space) have the unexpected benefit of achieving more realistic, satisfying and fun visual presentations. We now address the benefits of combining familiar elements of games into new and exciting combinations. Two such games will be discussed, but the inventive principles and components of the invention detailed here are meant only as a guide and the invention is not intended to be limited thereto.

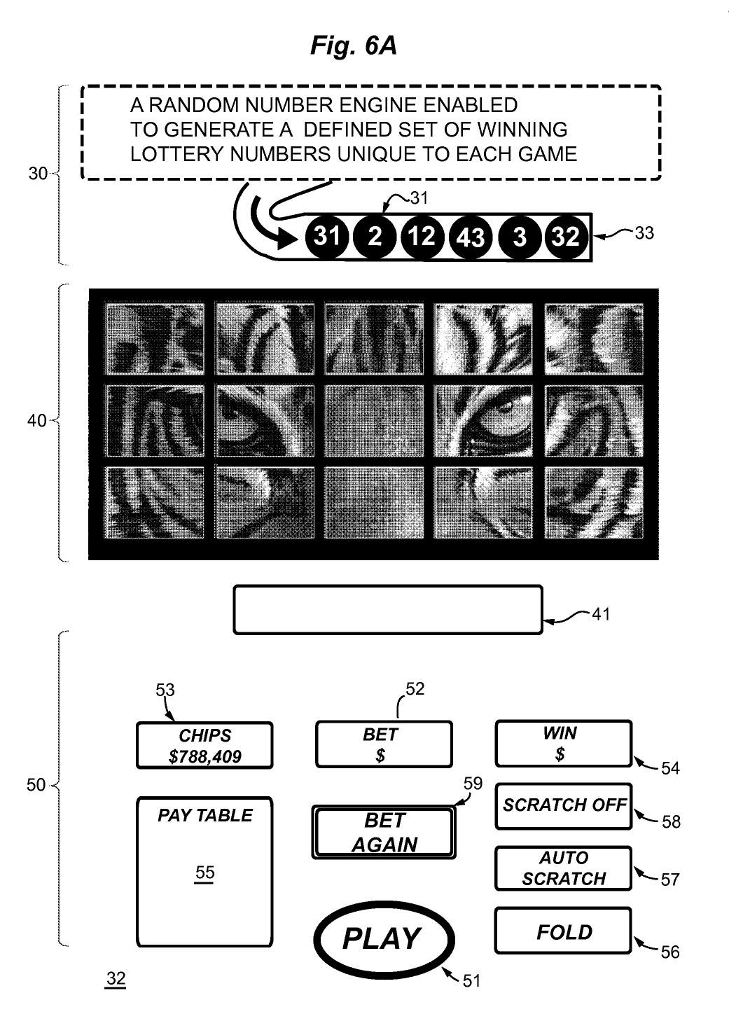

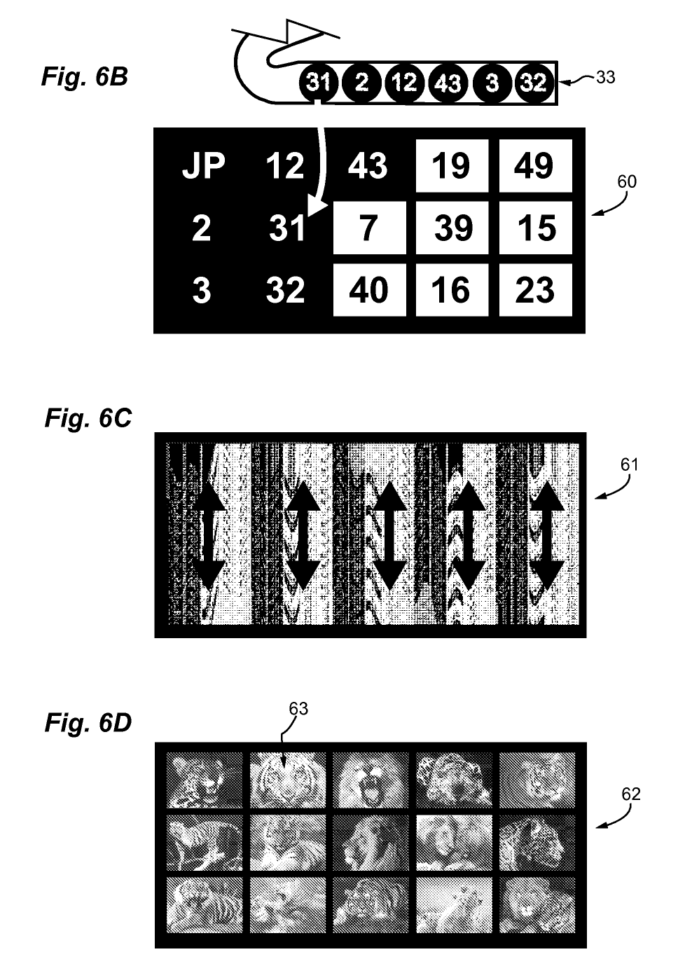

FIG. 6A is an overview of a player interface (32) of a first embodiment of an apparatus of the invention, and displays an initial setup or “initialization stage” of the game structure for the player. The operation of a lottery draw machine, slot reel spin, and scratchcard play are familiar to most players, a factor that has been found, somewhat paradoxically, to be among the top three of importance in encouraging player adoption of new game content. Thus familiar themes are also chosen with attention to evoking a feeling of recognition and familiarity. The player must press the play button to advance the game.

Lottery gameplay is indicated schematically; the lottery simulation (30) results in a row of balls (31) that drop into the “match-to-win” window (33) at the start of a game. Each ball carries a winning lottery number. Here six balls are picked. Lottery numbers are not drawn from an infinite set of integers but are usually picked from the set 1 to 49, 1 to 39, or 1 to 60, while not limited thereto. The six balls define the “seed matrix” for the sample game.

Below the lottery simulation is a representation of a grid (40) or window with frames. In this view of the initial state of the game, a tiger's eyes are seen in close-up; the tiger pacing behind the grid. Sound effects carry the theme. At this stage, the 3×5 grid represents five reels of a video slot machine, each reel with three segments in view, and in subsequent play action, the winning lottery numbers appear briefly as the reels spin up and then are lost in a blur of motion. The win ledger (41) or “player's tally” is empty in its initial game state, and is reserved for matching lottery numbers and supplemental game indicia accumulated in the play stage.

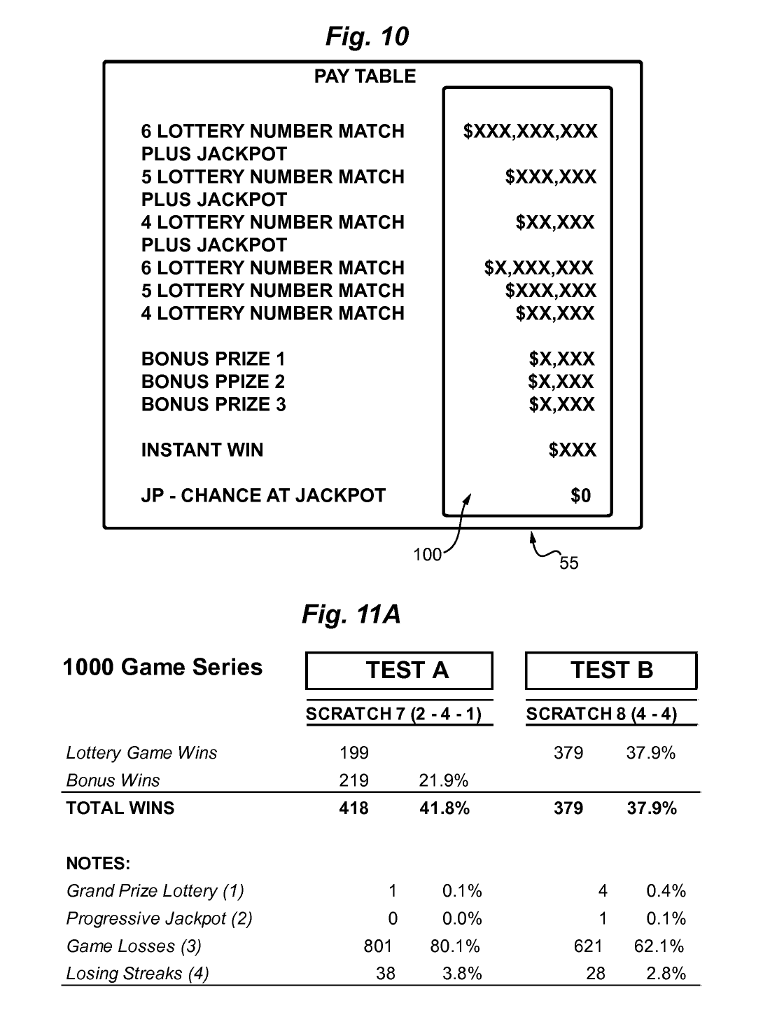

Also shown is a representation of a “game management console” (50). Pressing PLAY (51) initiates a game. An empty bet window (52) is displayed at the center, next to the player's available reserve (53). The win window (54) is also empty. The pay table window (55) may display winning combinations with their valuations (see FIG. 10). Other controls are also provided and are shown here as buttons: a “fold” control (56) for forfeiting a game rather than placing an added wager; an “auto scratch” button (57) for accelerating play; a “scratch off” control (58) for showing the results of a selection; and a “bet again” button (59) that eliminates the need to specify a bet amount at each round of betting. These controls are presented as a sample of a game interface and may be augmented or reduced by the gaming system designers.

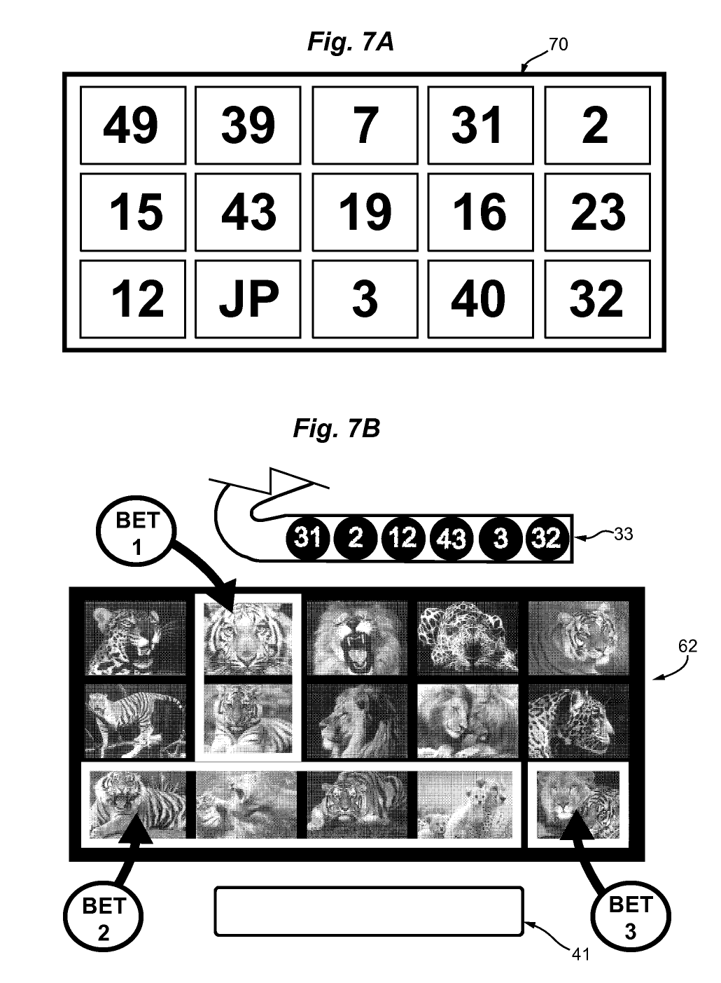

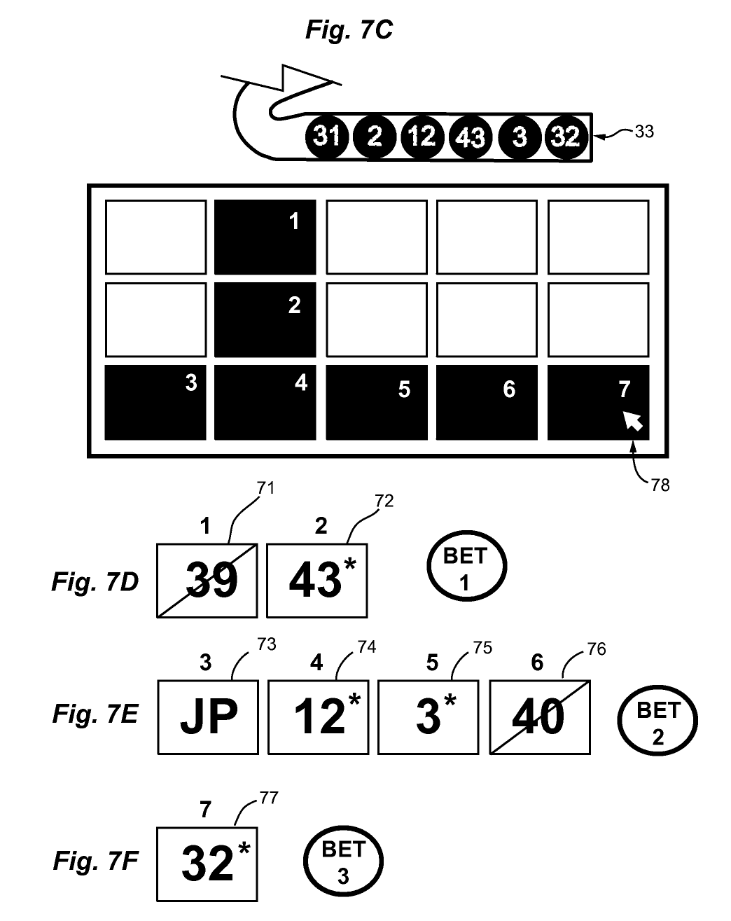

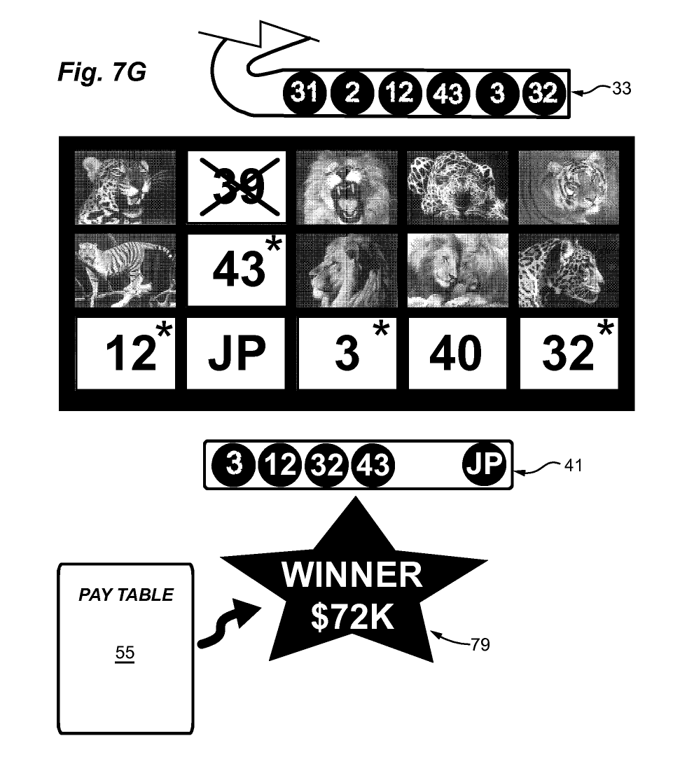

Steps of a first sample game are reviewed in FIGS. 6B through 6D and 7A to 7G. The game follows a multistage “conceal-and-reveal” game type, with an initial stage for a lottery draw, a transitional stage to fill out the game matrix, and a transformational stage to present a blinded virtual construct (here a scratchpad). In “play stage” the player then takes over control of the gameplay such that any game may be played all the way to a win—and until the game is completed—the outcome is entirely unknown and unknowable.

FIG. 6B shows how the winning lottery numbers are used to populate a game matrix. Each game starts by generating a set of new winning lottery numbers 33; generally the numbers are integers in the range of 1 to 49, or 1 to 60, but the number of winning numbers and the range of numbers may be adjusted according to the rules of the game. A set of winning lottery numbers having X members is defined in this way. Generally the set of winning numbers has four to ten numbers, more preferably six, seven, or eight numbers, as controlled by the programming.

The winning lottery numbers (white on black) and a supplemental game indicium (JP) are loaded into an array (60) simulating a window of a slot machine, shown here with five “reels”. Non-winning game numbers (black on white) fill the remaining spaces in the grid. The completed grid defines a “game matrix” unique to this particular sample game. The game matrix includes X winning lottery numbers, Y supplemental game indicia (here just the JP), and Z non-winning lottery numbers. Each of the N members of the grid is an “embeddable element”, further such that such that N=X+Y+Z.

The game designer's decision to incorporate one or more supplemental game indicia will affect the player's game experience. Because the player is offered a limited number of selections during the game (the selections being Q₁, Q₂, Q₃ . . . Q_{T}, where Q_{T} is less than N and Qᵢ* indicates a matching selection), each supplemental indicium that the player selects reduces the probability of drawing the X matching lottery numbers and thus limits overall payout. Various supplemental indicia may increase the overall number of wins while reducing the typical prize. Players will be attracted to very large prizes, even at long odds, and the player who matches a JP indicium plus a plurality of winning lottery numbers wins a progressive lottery. At the same time, other bonus indicia add variety to the gameplay, and decrease the length of losing streaks if offered in sufficient number.

Instant wins, hotspots, hot streaks, or added bonus wins for special combinations of non-lottery numbers, for example, adds fun for the player, but generally require smaller payouts. The number of lottery numbers and the number of concealed indicia also control game odds. These various incentives can be balanced by the game operator based on game analytics collected by the gaming system.

During the initial stage, the player is entertained with a simulation of a lottery draw machine having a hopper full of air-blown balls from which several are collected and put on display. The animation may be accelerated or abbreviated so as to shorten the game if desired. Advantageously, a kinematics engine and RNE with graphics rendering engine may be used to enhance the realism of the simulation.

FIG. 6C is a view of a slot reel display window (61) in which five reels are spinning, and illustrates the mechanics of a transitional stage of gameplay during which the game matrix is randomized in motion and blinded. The slot machine reels are represented figuratively as spinning so fast that the indicia on the reels are blurred. During this play action, the selectable object elements and associated embeddable content are being intermixed and disassorted and will morph into a simulation of a scratchcard (62) in the next game stage.

During the slot animation, the slot machine reels are simulated to spin hypnotically, and may be otherwise be manipulated with color, light and sound so as to fascinate and distract the player while the embedded elements are jumbled and reassorted. Unlike real slot reels, the simulation may spin, pixelate, swirl, flow, fade, pulse, and ripple if desired. Reels may spin horizontally or vertically, as limited only by the creativity of the game designer. More preferably, a realistic view of a “traditional” slot reel is emulated using a kRNE-linked graphics rendering engine.

FIG. 6D brings the reels to a stop. The slot reel window is then transformed into a familiar view (62) of a digital scratchcard (or other blinded virtual construct), here having three rows and five columns. Each scratch pad (63) is a square in a matrix of “selectable object elements”, and is blinded by an image that conceals any “embedded elements”. Here cats are shown and the game has morphed into a “conceal-and-reveal” game with two or more classes of embedded elements concealed in a blinded grid or “blinded virtual construct”. (The “embedded elements” are associated in RAM memory and are revealed only when the “selectable object element” or “skin” is picked by the player.)

For illustrative purposes, the scratchcard is represented as a 3×5 grid in FIG. 6D. Selectable object elements may be images or video clips, for example. In FIG. 6D, photos of feline predators are chosen as skins on each scratch pad. These may be adjusted as part of a theme that permeates the game and optionally, that can be adjusted by the user from a list of themes. Such themes may include for example, animals, birds, pets, dogs, cats, fish, sports figures, surfers, fruits, celebrities, faces, clowns, national parks, flowers, beaches, hieroglyphs, lightning strikes, vintage cars, Indians, coins, cowboys, states, cities, dinosaurs, MONOPOLY® game addresses, and so forth. Scratchcards may be offered in other dimensions, having 3×6 pads for example.

The presentation is now complete, there has been a buildup of excitement and play action, and the player may now make a bet and take control of the game. FIGS. 7A-7G are stepwise views of the mechanics of a “play stage” ending in a game win. In FIG. 7A, the concealed indicia of the blinded scratchcard pads are shown here in grid form fully revealed (70) for reference but are not visible to the player. FIG. 7B shows a detail of the player interface as it appears to the player, including the match-to-win window 33. To make selections, the player uses a pointer device or a touch of a finger. Also shown for reference are three bets and selections (BET 1, BET 2, BET 3, as indicated by a white border) that the player will make. Any matching selections Q* from each round of betting and selection are added to a second window (41) so that the running tally (the cumulative number of matches ΣQ*) and optionally the order of matches (Q₁ through Q_{T}) can be scored. The layout of the game is depicted schematically in FIG. 7C, where the player's selections Q are numbered in sequence from 1 to 7.

Gameplay interactions become earnest with the first bet (BET 1, FIG. 7D). Upon receiving the bet, the machine is configured to display the embedded contents of selections Q₁ and Q₂ (71, 72). In play, the selected squares may be highlighted to confirm the player's selection(s).

FIGS. 7E and 7F show the results of second (BET 2, 73, 74, 75, 76) and a third and final round of betting (BET 3, 77). By having the player make all selections before the first bet is played, the game can be accelerated in subsequent steps. Matches of winning lottery numbers are indicated here by an asterisk for clarity of explanation.

In BET 2 (FIG. 7E), two winning numbers (and the JP symbol were selected, giving the player a chance at a progressive lottery jackpot. However, because selection #6 is a non-winning number (76), the player actually will be lucky to rescue a game win at BET 3. Only three of the remaining eight squares are winners. Because the play appears to be close to a win, the player did not chose to fold and made BET 3 (FIG. 7F, 77). Shown here, the final selection (#7, cursor, 78) is a final winning number (77), so the game is a win for the player, who matched four of the six winning lottery numbers and scored extra for the jackpot supplemental game indicium (73).

FIG. 7G summarizes the results of the game; matching lottery numbers are shown in the player's tally window (41) and in the scratchcard with an asterisk. A prize of $72K is awarded for the game. Game resolution may include pulsing stars (79) or strobing lights and auditory effects such as the sound of falling coins designed to add excitement to the game and encourage additional gameplay. These and other aspects of the operation of a gaming machine are described in U.S. Pat. Nos. 6,505,118, 6,722,979, 6,811,482, 6,988,948, 7,354,344, 7,530,893, 7,850,524, 7,887,404, 7,988,549, 8,092,292, 8,092,298, 8,109,828, 8,221,213, 8,267,765, 8,272,934, 8,360,846, 8,480,479, 8,651,943, and published applications 2012/0077583, 2013/0244757, and 2014/0004950, all of which are hereby incorporated in full by reference for all purposes. All accounting functions associated with betting are supporting components of the gaming machine or are centralized in a remote computing platform or server. The pay table (55) is a lookup function for computing the game winnings and as a matter of conventional best practice, is typically displayed to the player.

Preferredly, more than one round of betting is needed to be awarded a win. Rounds of betting are broken up so that each selection of a subset of scratch pads is made after a bet is placed. After each bet, a defined number of selections are allowed, where a first subset of selections Q₁ through Qᵢ, follows a first bet, a second subset of selections Qᵢ₊₁ through Qⱼ follows a second bet. This amounts to an iteration of a betting and selection step. A third round of betting may define selections Qⱼ₊₁ through Q_{T}, for example, where the distribution of selections between the subsets is defined in the game. In this game variant, the player makes selections only after a bet is place. Advantageously, the size of the subsets of selections per round of betting can be adjusted so that a player cannot win unless two or more rounds of betting are completed. Players must judge their prospects based on the first round of betting and either forfeit or go another round. The game is challenging and sticky when played in a 2-4-1 or in a 4-2-1 format, where the number of selections per each of three rounds of betting is indicated here and programmed into the gameplay or is selectable by the player.

Also relevant is a scoring management routine having a loop of code for iteratively receiving bets and selections and for displaying concealed indicia associated with any selected scratchcard loci or scratch pads. The scoring management subroutine must contain logic circuits for evaluating the truth of propositions such as “Embedded in selection Qᵢ is a number Xᵢ which is a winning lottery number”. The processor will tally the number of matches ΣQ* before resolving a game. Under preferred game rules, the content of each player's selection will match either (a) one or more of the set of winning lottery numbers, (b) one or more of the supplemental game indicia, or (c) will not count in the player's tally. The number of rounds of bet/select and the number of selections per each round of play will be defined so that the total number of selections Q_{T} is less than the number of selectable object elements N in the game matrix. Generally Q_{T} is an integer equal to a plurality or a majority of the X members of the reference set of winning lottery numbers.

Scoring may also include bonus prizes for lesser wins associated with non-winning numbers or other indicia so as to promote player loyalty. These can include drinks, meals, giveaways, credits toward gaming, bonus rounds, other incentives, and so forth. Optionally, the game matrix may be revealed at the end of the game so that the player may see the embedded elements in the entire scratchcard and verify where the winning lottery numbers were concealed.

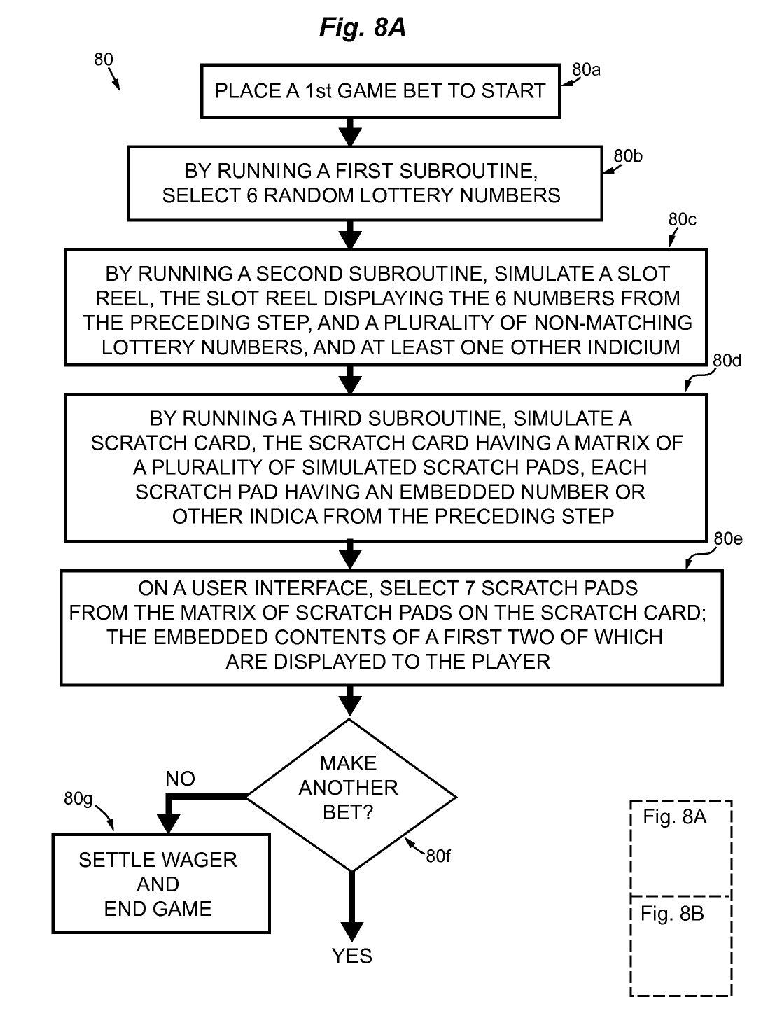

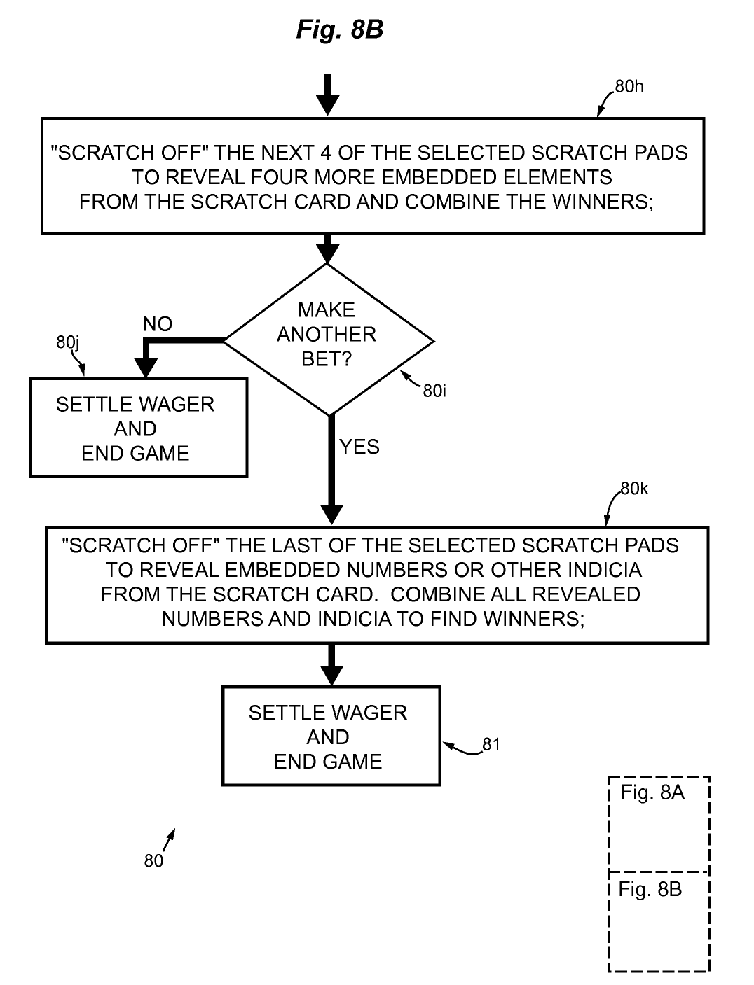

Gameplay is reviewed in FIG. 8A-8B in the form of a flow chart 80 for the sample game, the flow chart describing a gaming system configured to play a game with three rounds of betting. In an initial step (80a) the player must make a first bet. The gaming machine runs a first subroutine (80b) to select six lottery numbers, at least four of which must be matched by the player's selections to win the game. Then by running a second subroutine (80c), the reel action of a slot machine is simulated in which the winning numbers and other non-winning indicia are displayed and then spun on the reels until intermixed and out of position so that the player has no chance of following their movement. As a result of this play action, each virtual scratchcard is disassorted and intermixed so that the concealed datum in each selectable embedding element cannot be known by a player. In a third subroutine (80d), the processor executes instructions to simulate a scratchcard, the scratchcard having hidden indicia and winning lottery numbers in simulated scratch-off scratchpads. The player may then select up to seven of the scratch off scratchpads out of fifteen (according to the rules of this sample game) and for example, the first bet will reveal the first two embedded contents of the selections to the player (80e).

The player must then decide (80f) strategically whether to make a second bet or not. Not betting will forfeit the game (80g) but continuing will expose the player to greater losses if the initial draw is weak. After making a second bet, the embedded contents of three more of the selected scratchpads will be revealed (80h). These will be combined with the first round betting results to match any winning lottery numbers or other supplemental game indicia of significance in the play.

The player may then choose (80i) to make a third bet to see the final selected locus, and if not will forfeit the game (80j). Choosing “yes” will cause the machine to scratch off the last of the selected scratch off scratchpads so that any combination of matching winning numbers and indicia is revealed (80k) and ΣQ* is tallied. The machine will then settle all the wagers and end the game (81). A win may be accompanied by a rollout and a prize award. In some embodiments, a coin or token bin is included in the game, and a win is accompanied by the actual dispensing of coins or tokens into the bin. All RAM data is then reset after the winnings are recorded, and the player may immediately begin a new game. Players who forfeit at an earlier step will already be playing the next game.

Advantageously, user interface screens having touch-sensitive functionality allow the player to simply touch the scratchcard to select the scratch pads for scratch off. In some realizations of the gaming machine, all functions are controlled by a display screen, which is provided with living touch-sensitive virtual “buttons” and other features that respond (according to the rules of the game) to touch or gestures by the player. Capacitive, inductive, thermal, or motion-detecting technologies are keyed to elements in the display screen for a rapid, seamless integration of play action and the player's motions. In other realizations, switches, buttons, keypads, joysticks, mouse, pointers, or other analog devices are used to control gameplay and user selections. Gestural control systems may also be used.

For a more compact game presentation, the lottery seed expansion view (60), the slot reel view (61) and the scratchcard view (62) may appear sequentially in a single window so as to minimize the display footprint. Game console control features (50) may be configured to appear in rule-sensitive gaming context so that a small screen, such as on a mobile device, can support a full gameplay experience.

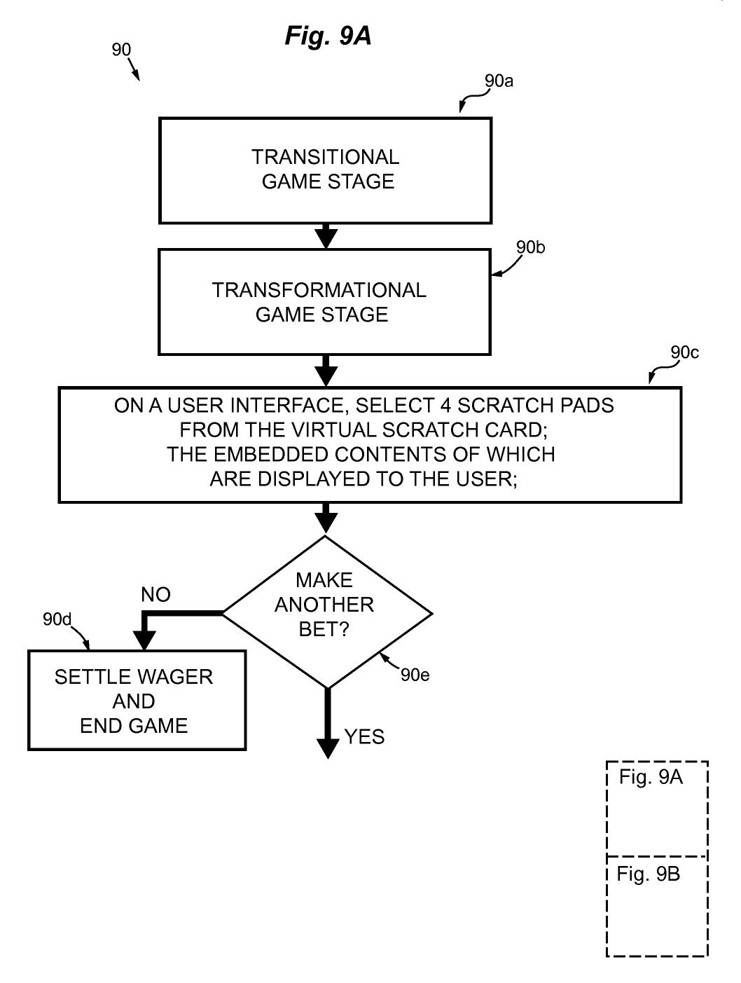

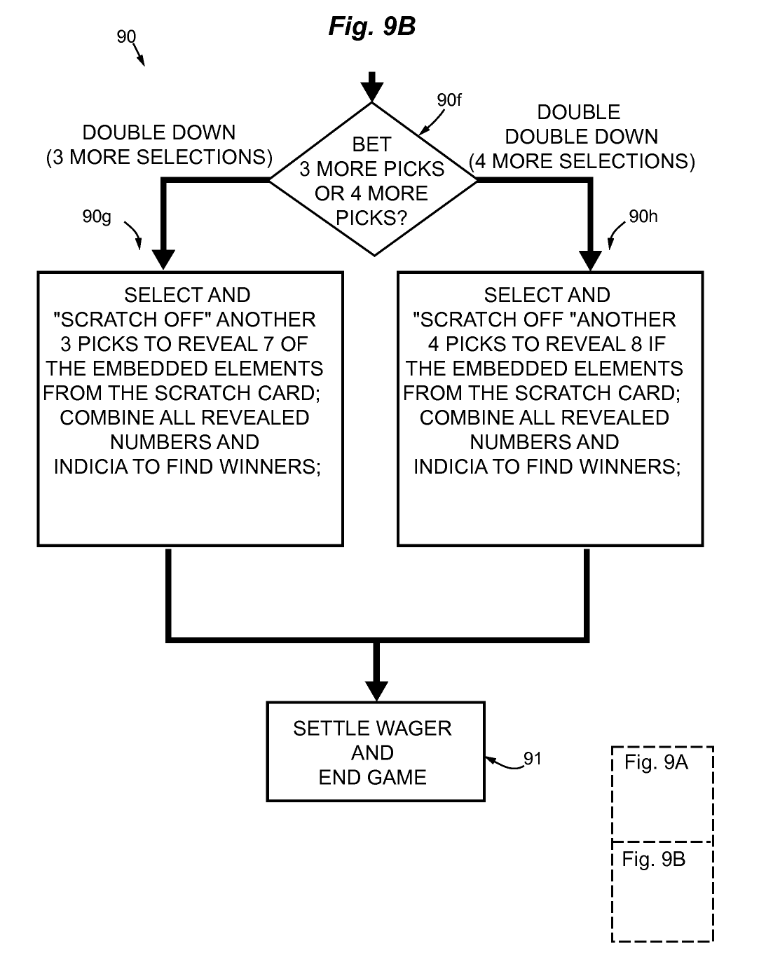

FIG. 9A-9B illustrates a flow chart (90) of yet another sample game enabled by the gaming machines of the invention, where the gaming system is configured to offer a branching decision point in the betting process. The player must choose between two possible kinds of play strategies, one betting on the next three selectable objects or loci of a blinded game matrix and the other requiring a higher bet, but offering to reveal the embedded contents of four more selectable object elements.

As before, this game begins with a bet; the machine then picks six random lottery numbers defined as the winning set. Executing a second subroutine (transitional game state, 90a), the processor displays the “match-to-win ledger” numbers and invisibly disorders and mixes them in a matrix sized to fill a scratchcard while spinning slot reels associated with the mixing operation (transformational game stage, 90b). A kinematic engine with RNE and graphics rendering engine may be used to augment the reality of the slot machine display.

Game play then begins. A “conceal-and-reveal” game is played with a virtual scratchcard (or other representation of a blinded virtual construct). The scratchcard is simulated on the display so that the user can select choices of scratch pads to be “scratched off” according to a multi-round betting structure where each betting round gives an expanded but partial view of the embedded elements concealed in the blinded game card. The display includes an active user interface as described above, and the player may make selections (90c) of four of the scratch pads according to intuition. Based on the luck of the draw, the user can then elect to fold (90d) if the results are not promising, or may choose to make another bet (90e).

The game then branches. The size of the bet, whether to “double down” (90g) or “double double down: (90h) determines whether the user can select three more picks to win, or four more picks. This decision point is represented by branch point (900 in the flow chart. Winning numbers are then scored along with any related indicia and the game bets are settled (91).

FIG. 10 is a view of an exemplary pay table 55 where number values may represent cash or cash equivalents, such as a virtual currency or a substitute for money, for example gaming chips having face values. Shown are a range of prizes (100) associated with lottery wins and selected bonus prizes. The large numbers may appeal to high rollers, and may represent cash or cash equivalents, such as a virtual currency or a substitute for money such as gaming chips having higher denominations. Exemplary prizes may include a “six-out-of-six” matching number lottery win, a “five-out-of-six” matching numbers lottery win, a “four-out-of-six” matching numbers lottery win. In this instance, the game operator defines an integer ΣQ*min which corresponds to the minimum number of matching lottery numbers needed to win a lottery match prize. Generally ΣQ*min is at least a majority of the lottery numbers drawn for the game, so for example if the set of winning lottery numbers has six members, any game matching four to six numbers would be a winner; players matching only three numbers would not win unless wildcard play is part of the game and a wildcard supplemental game indicium is picked. Game rules determining a win and the kinds of wins depend on the venue and the game operator. In a preferred game format, ΣQ*min is a larger number than the number of selections a player may make in a first round of betting, thus enabling the player to fold without making a second bet for weaker draws, and requiring a player to increase the stakes in order to have a winning game. Advantageously, this format has the surprising effect of increasing house revenue per unit time because games that result in a fold go very quickly and games that are fully played out have multiple rounds of betting, each of which contributes to the flow of revenue from the game. Payout ratios are calibrated to the betting generally so as to create a positive cut for the house, and in some jurisdictions the ratio is subject to statute, but in other countries for example, some gaming machines will provide very high payouts in excess of revenue in—in order to stimulate play in machines proximate to the higher paying machine or other business interests. This occurs for example where the gaming is subsidiary to other business interests such as retail or restaurant franchises. Popular games that stimulate customer loyalty are preferred for this kind of business practice.

Players who also match a JP indicium in their game are candidates to win a “progressive jackpot”, which has been shown to be a major draw for players seeking instant fortune, and frequently is offered by the larger casinos or casino associations having slot machines. Generally the progressive jackpot advances by the minute, so the gaming machines are networked and configured to display the rapidly increasing pot. The games of the present invention may be tied in a network to the house's progressive jackpot for slots, or could have an independent progressive jackpot. The popularity of this game is expected to equal or exceed that of slots, and if odds of winning are calibrated to generally match the house odds on slots, then a common pooled progressive jackpot is expected to stimulate rapid spread of the games of the invention. The amount paid for the progressive jackpot is usually far higher than any single slot machine could pay on its own. Generally the progressive jackpot is rewarded when a player matches all the lottery numbers and one or more supplemental game indicia.

To meet the player's need for periodic positive reinforcement, players may be instant winners in some games. The gaming machine may be configured to randomly select certain loci of the game matrix for a special prize that is independent of the lottery game. In a preferred realization of this, a function call or script is inserted into a game matrix at one or more loci corresponding to an embeddable element of the virtual blinded construct so that when a player selects these elements, the prize is triggered but the game continues. Parallel games of this type are known to stimulate player interest and add the enjoyment of more frequent wins. As another accessory prize, players who pick certain combinations of non-winning numbers or special indicia may be rewarded with a minor prize. For example, players who pick a combination of non-winning numbers totaling “21” may receive a bonus prize of a lesser amount, or a free game ticket, a drink on the house, and so forth. Because any player who selects three or more non-winning loci will have a reduced chance of a game prize, these accessory prizes serve as a sort of consolation price. Special prizes of this type are illustrated here by example. Players who score the JP indicium on the opening ante may receive the “BONUS PRIZE 1” shown in FIG. 10. Players who score the JP indicium on the last round of betting may receive the “BONUS PRIZE 2”. Players who score any three non-winning numbers adding to “twenty-one” may receive “BONUS PRIZE 3”. These rules may be varied according to the game operator's preferences and to game analytics. Programmable instructions for the pay table (55) are adjusted accordingly.

Players may also be rewarded for patterns of repeat business. By monitoring return player activity, game operators may identify preferred players for special status, and may be given preferred odds, a bonus stake, or other perks in recognition of their loyalty in the manner of a frequent flyer program or admission to a special club facility on online site.

By offering the game with familiar elements such as slot reel spin and a scratchcard, user acceptance of the new game is higher. Iterative programming for multi-round betting ties gameplay to a continuous stream of bets and accelerates gameplay velocity by inducing players who draw weak opening picks to forfeit their first bet and go on to a new game. Games may have two, three, four or even five rounds of betting. In a preferred game, the player cannot win on the first round, ensuring that either the player folds or must place an added bet in order to continue the game. Paradoxically, this allows the house to be more generous in offering prizes without loss of revenue per unit time.

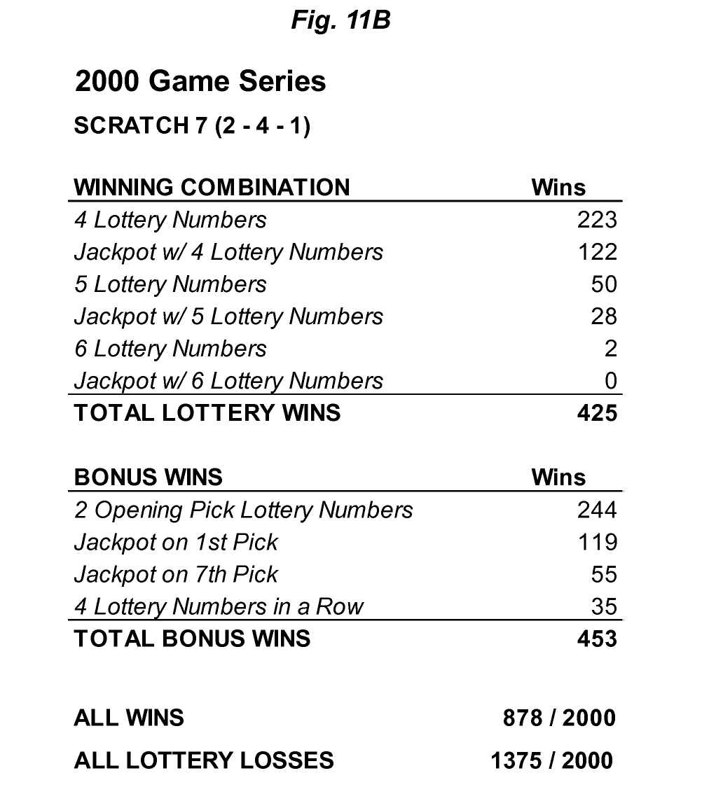

A more detailed analysis of gameplay is now presented. FIG. 11A compares results of 1000 games played with two different variants of the rules. The effect of a rule change on win and loss data is shown. In a first game variant “TEST A”, the player may scratch seven out of fifteen squares on the scratchcard (out of grid squares of a 3×5 array) over three rounds of betting, such that the first round bet reveals two concealed numbers or other indicia, the second round bet reveals an added four, and the third round bet a final datum. This game is termed “SCRATCH 7”.

For reference, a flow chart for SCRATCH 7 gameplay is shown in FIG. 8A-8B. Players may fold after the first or second round. As the game rules are structured here, ΣQ*min is four, so the player must make at least two bets in order to have a winning match. Players may elect to make a third bet, either in hopes of improving their win, or rescuing a lost game. SCRATCH 7 is compared in column one with a second variant “SCRATCH 8” in column two.

In TEST B, a “SCRATCH 8” game is presented. This gameplays the same as TEST A with three exceptions: [1] A total of eight matches are needed to win the progressive lottery prize (the set of winning lottery numbers has seven members, and 1 Jackpot icon is included in each scratchcard); [2] The bet sequence is reduced to two bets per game; the first as an entry bet to scratch off four squares and a second bet (double down) to scratch off the final four squares; [3] The game is played strictly on a win loss basis, that is, there are no bonus $ chips awarded. ΣQ*min is 4.

The SCRATCH 8 game differs in that players make two bets, and each bet reveals four concealed data. Thus in this variant, players may win on the first round of betting because the number of winning embedded indicia revealed is equal to ΣQ*min. Problematically, this has the potential effect of reducing betting (players who win on the first hand may elect to take their earnings without making a second bet) and increasing overall wins so that house payout is higher. Also the rhythm of the game drives the player into a repeating pattern of “bet/bet/bet/bet” that may be less desirable.

For these reasons, at this time the SCRATCH 7 game is preferred as an exemplary embodiment. The test proved that in 1,000 games, SCRATCH 7 had better control of the gameplay (more interaction)—received instant bonus awards (more fun)—stayed connected longer (more options) than SCRATCH 8, despite the higher percentage of lottery matching wins (37.9%) in the latter.

The trial shows that game payouts are reduced, as compared to SCRATCH 8, by reducing the number of player selections from eight to seven, and surprisingly, by adding lesser bonus prizes, can be achieved without markedly reducing the number of wins. Both lottery wins and progressive lottery wins were substantially reduced while total wins actually went from 37.9% to 41.8%: a 4 percentage point increase. Paradoxically, the data reveals that 80.1% of all SCRATCH 7 games are lottery losses for the player, but 41.8% are wins overall. This paradox is explained by the 21.9% bonus prize wins, which may be scaled according to the needs of the game operator: growth targets include growth of the game, player loyalty, associated business, return business, and house take; these are all considerations that may be reflected in the programming details.

Certain details are dependent on operator experience. So, as to speed play, players may make all their picks at the opening of the game, and the blinded game data is then revealed in a pattern “2-4-1” of subsets of the seven picks allotted for the game. Each revelation follows the corresponding betting rounds and the matches are tallied as gameplay tightens . . . , but the selections have already been made. Alternatively, the player may deposit a first bet and reveal a first set of 2 picks, then based on that result, make a second bet and reveal 4 picks, and then make a final bet to reveal a final pick. In this format, players are repeatedly engaged to do more than bet. In testing, players operating a touch screen readily completed a game with three independent rounds of betting in under 15 seconds (even allowing for hesitation in making the selections), a bet velocity essentially equivalent to video slot play on electronic slot machines.

FIG. 11B tabulates outcomes a series of 2000 games played in 2-4-1 rounds of bet and select in the SCRATCH 7 format. As shown in FIG. 11B, in this extended series, wins were 44.0% and losses were about 78.7%. Included in wins are non-lottery bonus wins that are linked to supplemental game indicia inserted into the game matrix. Bonus play wins accounted for 22.6% of all wins. Two grand prize wins (lottery matches scoring six-out-of-six matching lottery numbers) were played, but a progressive lottery win was not. Pure losses (players who won nothing) occurred in 66% of games.

Players who score in first round betting by matching a lottery number or a supplemental indicium are more likely to continue playing. However, the outcome of the first two selections was predictive of a win in only 9.9% of games, and predictive of a loss in 10.5% of games. Similarly, losses were reversed in the final round of betting in only 10.1% of games.

Game openings having no matches on the first two selections occurred in 28.2% of games. It is likely that many of these will convert to voluntary player forfeits, adding to the house take and increasing gameplay velocity and momentum as players quickly discover that perhaps 70% of games have at least one match in the first pair of selections.

A game configured to allow selections in a 4-2-1 format was also found to be attractive, and offers a level of “stickiness” that players will find attractive. These parameters and other formats of the game can be configured to be selectable by the player if desired, promoting an experience of discovery that builds customer retention.

FIG. 12 illustrates conceptually how the rate and size of bets made per game (120) is uncoupled from the rate of initiation of gameplay and the presentation of wins or losses. Revenue flow units and total time per game (121, dashed line in seconds) are plotted against the rounds of betting per game. Games going one round of betting (122) were over almost as fast as they started; games going to two rounds (123) lasted less than ten seconds, and games going three rounds of betting (124) in a 2-4-1 game format lasted about 12 seconds per game, thus each game is associated with up to 3 rounds of betting, or 1 bet per every 4.1 seconds! New games can be commenced immediately after finishing a first game because the presentation after each round of betting is instantaneous. This velocity is faster than slot machine game turnover rates in typical casino play.

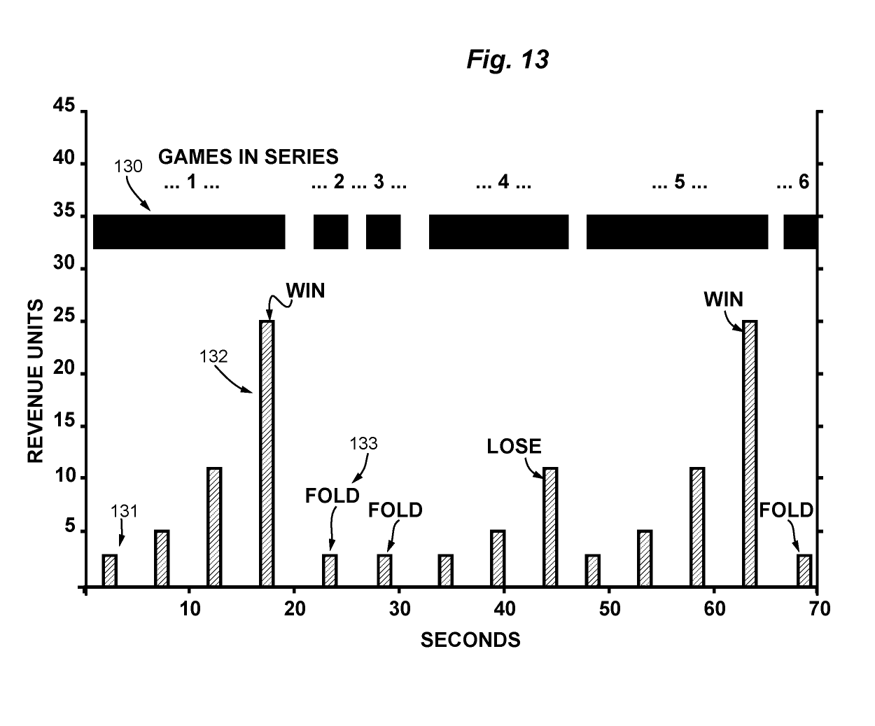

FIG. 13 is a view of revenue flow and gameplay in a series of six games, each game having an initial bet followed by up to three rounds of betting per game. In this model of gameplay versus time, six games (Game 1 et seq, 130) are played in about 70 seconds, but 14 bets are received in that same period of time. Each vertical bar is a bet plotted in revenue units. A first bet (131) initiates a series of four betting rounds leading to a win. Other games are folded on the first round or played to a win or a loss. When initial play is promising, higher stakes are played (the height of the vertical bar 132), demonstrating that players are drawn to the pace of the game and feel its momentum. The ability to fold (133) when the initial selections are weak has the effect of accelerating the game. The durations of the game and the betting patterns have an irregular sawtooth feel, or resemble a Morse code percussion of dots and dashes that is distinct and novel over video slot machine play, . . . but at the same velocity of betting!

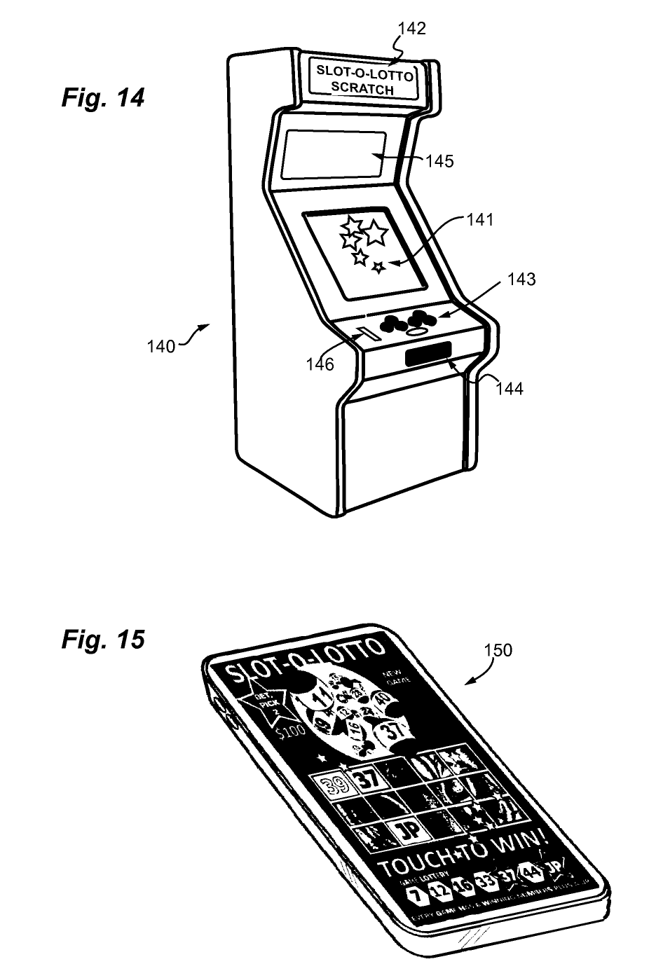

FIG. 14 is a sketch of a casino slot machine 140 reconfigured to operate as a gaming system of the invention. While shown with conventional features, the internal workings and any system connections are configured for supporting a game having an initial stage, a transition stage, a transformational stage and a play stage, or for supporting other game formats having a function call in support of kinetic randomization routines associated with animations of gamepieces.

The gaming system features a user interface with display (141), a logo (142), a player control console (143), a tray or bin for dispensing payouts (144), and a financial transaction support device (365) such as a card acceptor that may also be used with casino chips or tokens. An accessory display panel or panels (145) may include space for a pay table, for a leaderboard, or for advertising tied to the consumer's preferences. At least one of the controls, either an analog hard button or a soft selection control on a user interface may be used to select from the available themes for the game. The display 141 may also be used to show rules or support of a demo game mode that plays continuously when no player activity is sensed. Where appropriate, the gaming systems may be modified to include different and/or additional components besides those discussed above.

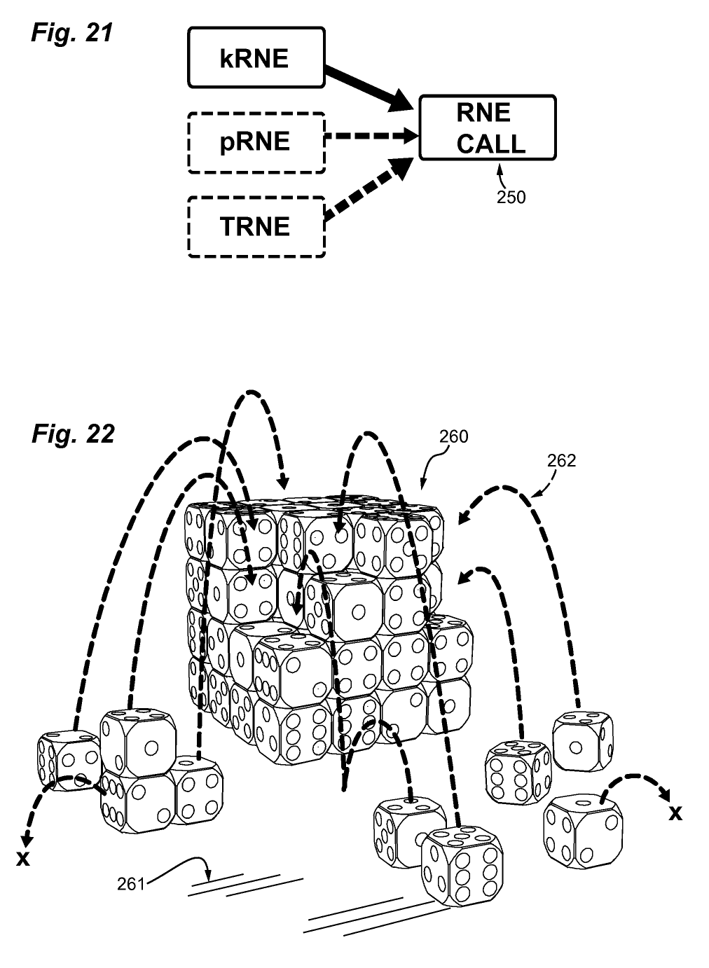

FIG. 15 is a sketch showing a cellphone 150 reconfigured by installing an “app” or visiting a website to operate as a gaming system of the invention. Cellphones offer exciting additional platform components for the gaming systems of the invention. Fortuitously, most “smartphones” are equipped with gyroscopes, accelerometers and magnetometers, typically as a “6-axis” or 9-axis” solid state package. The gyroscope allows us to offer a “tilt feature” in dice games of the invention. A player may “steer” the dice on the playing surface, and bounce them up or drop them down in the virtual play space. Thus the game of chance becomes interactive within the kRNE motion calculating routine by allowing the player to define unnatural forces that affect the trajectories and final resting places of the dice, for example. While this is a fun feature of the game, it does not affect the randomness of the outcome of a “conceal-and-reveal” game because randomization of the blinded game matrix is performed as described in FIG. 6C or FIG. 22 and is not disturbed, as will be described below. The tilt feature is an advance in the art and finds use in other applications of kinematic engines in implementing games of chance on gaming systems.

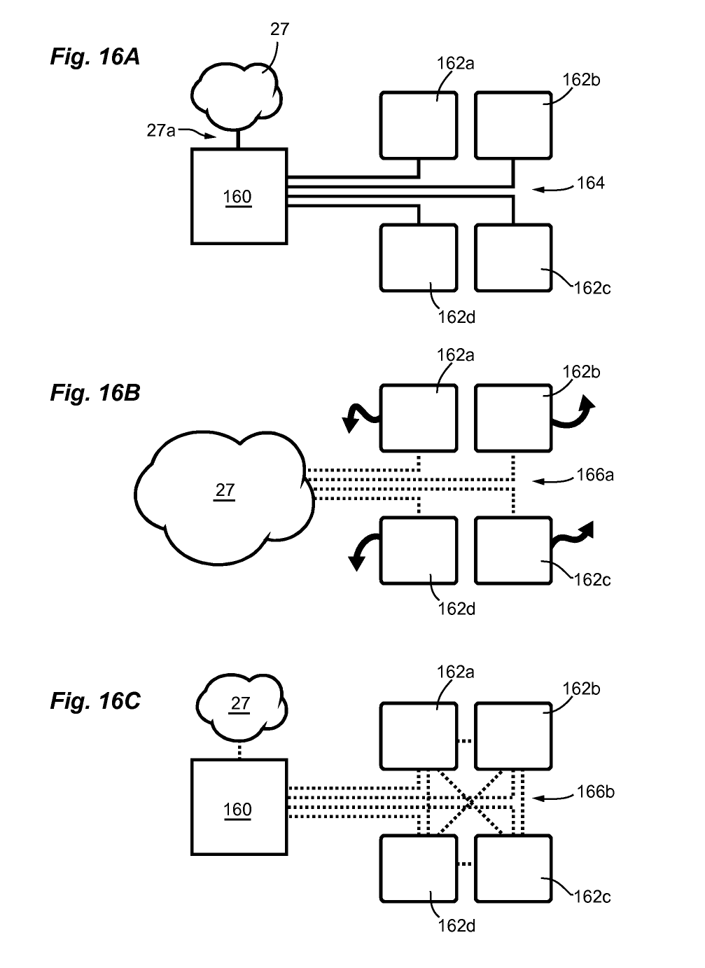

FIGS. 16A, 16B and 16C are schematic views of networked gaming systems, the network constituting a larger gaming system of the invention. Network, browser, and cloud mediated gaming systems are attractive for a number of reasons. The cloud may be used for accounting, bookkeeping, and/or security purposes, or for downloading new game software or game software upgrades and/or for controlling or monitoring the operation of the game via a network if desired. Analytical data may be collected. When game software is on a remote server in the cloud, games may be played over a local area network (LAN) operatively linked to the cloud, or over a remote network operatively linked to an internet-type domain via a browser. Advantageously, by retaining some code on a remote server rather, proprietary aspects of the game or machine operation can be held as trade secrets.

Wired and wireless communications platforms are known to those skilled in the art. Exemplary networks are depicted in FIGS. 16A, 16B and 16C. In each view, a cloud connection (27, 27a) is depicted figuratively. Although cloud-based computing machines or networks increasingly dominate many establishments, the gaming machines of the invention may also be operated as stand-alone machines having no remote digital connectivity or having digital connectivity as a standby feature; containing a processor, a memory utility, user interface features, GRE, kinematic engines and programming sufficient to operate one or more games.

Digital network connectivity may be hard wired or wireless as known in the art. In general, the figures depict hard wired data buses with solid line and wireless serial data buses with dotted lines. Shown are a representative number of possible combinations. In FIG. 16A, a connection (27a) between a cloud-based (27) computing facility and a local server 160 is represented by a solid line or lines, such as via a fiber optic line. Digital connection protocols are generally bidirectional unless otherwise indicated. The gaming system is configured to work as a component in a networked environment including a local server (160) (e.g., a slot machine server of a casino) that is in communication via a communications network (164) with one or more gaming machines (162a, 162b, 162c, 162d).

Wireless transceiver linkages useful in establishing networks broadly encompass cellular signals, WiFi, Bluetooth™, Zigbee, and radio in general, including digital radio and analog radio. Cellular protocols include GSM, 3D, 4G, LTE, or WiMax, for example. In some instances, peer-to-peer or star networks are created. Mesh networks having no centralized node may also be used. Mesh networks may be homogeneous and heterogeneous, for example employing gaming machines of the invention along with other kinds of nodes. Wireless networks, including ad hoc networks in general, are known to those skilled in the art and may be used in communication between devices and modules of the network. Frequency ranges are generally in the megahertz to gigahertz range, although lower frequencies may be used for longer distances. Each device of a network is typically assigned an address or identifier for communications, although the address may be static or dynamic. Encryption is optional, but is frequently used for communicating financial transactions and/or personal information. For wired network transmissions, serial transmission is generally contemplated, such as by UART-equipped devices, by Ethernet, or by fiberoptic communications protocols.

A variety of communications protocols may be integrated into the gaming system schematically depicted in FIG. 16A or an equivalent system, including but not limited to: Ethernet (or IEEE 802.3), UART, USB, SAP, SAS™, SuperSAS™, ATP, Bluetooth™, TCP/IP, Token Ring, cable, satellite, or via any appropriate communications protocol or combination of communications protocols. Further, in some embodiments, various communications protocols endorsed by the Gaming Standards Association (Fremont, Calif.), may be utilized, such as (i) the Gaming Device Standard (GDS), which may facilitate communication between a gaming device and various component devices and/or peripheral devices (e.g., printers, bill acceptors, etc.), (ii) the Best of Breed (BOB) standard, which may facilitate communication between a gaming device and various servers related to play of one or more gaming devices (e.g., servers that assist in providing accounting, player tracking, ticket-in/ticket-out and progressive jackpot functionality), and/or (iii) the System-to-System (S2S) standard, which may facilitate communication between game-related servers and/or casino property management servers (e.g., a hotel server comprising one or more databases that store information about booking and reservations). Transmissions and records may be encrypted to ensure privacy and prevent fraud in any of a variety of ways known in the art.

Each of the gaming systems 162a, 162b, 162c, and 162d, may comprise a processor (11) having functionalities and peripheral devices described in FIG. 4, and may be adapted to communicate via a network 164 with a server 160, with one or more remote computing facilities via a cloud connection (27a), or generally in peer-to-peer networks.

The gaming devices need not be stationary to be networked; as suggested figuratively by FIG. 16B, mobile devices having capacity for gameplay are frequently linked via a cloud-based Internet or in a LAN operated at 2.5 GHz over short distances, and some or all of the game content may be remotely supplied to the mobile devices. In one instance, gaming systems 162a, 162b, 162c and 162d are coordinated from a cloud-based facility via a wireless communications protocol and network (166a). In other instances, as shown in FIG. 16C, gaming systems 162a, 162b, 162c and 162d may communicate directly with each other in a LAN or mesh network (166b) while also communicating with a server 160. Any number and type of gaming devices may be in communication in a computerized network. Other configurations will be evident to those skilled in the art.

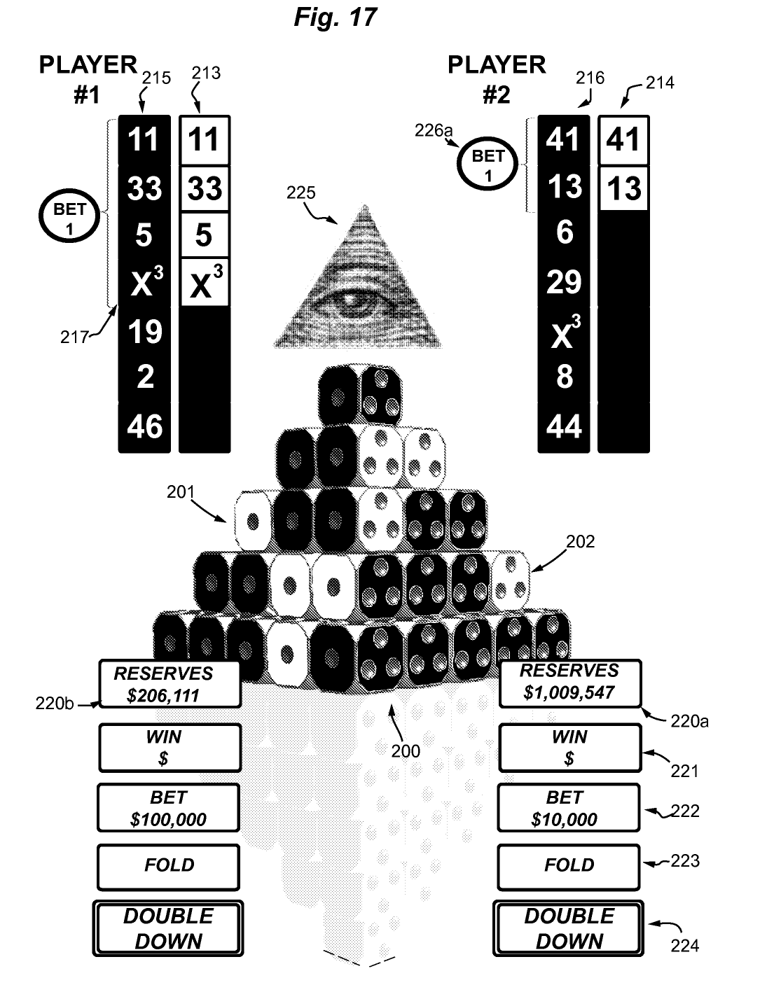

FIG. 17 is a view of the working of a second apparatus of the invention, where the apparatus is configured for operating a game of chance (termed here Pyramids of Mystery) in which elements of lottery play, dice play, and conceal-and-reveal play are combined. A blinded virtual construct of dice is provided (200) and provision is made for competition by two players.

Shown are a graphical user interface and gameboard with superimposed soft buttons and displays, all of which may be presented on a touch screen so as to increase the gaming velocity and momentum. This view also demonstrates ways in which a game platform may be adapted for play by more than one player at a time. Here two faces of a three dimensional pyramid (200) are being played. The game matrix for each pyramid face is unique to that face. Player #1 is playing dice cubes having one pip per face (201); Player #2 is playing dice cubes having three pips per face (202). As before, dice cubes selected by a player are shown with white bodies. The game is represented as being in a first round of betting and the relative scores may be seen on each player's win ledger (213, 214). The “match-to-win” bar (215) for Player #1 is distinct and different than the corresponding bar (216) for Player #2. In this sample game, Player #1 has picked up three matching numbers and a chance to triple his winnings. The significance and rules around supplemental game indicia such as the “X³” indicium (217) are up to the game operator, or may be subject to player preferences mutually agreed before gaming is started. Player #2 has matched two numbers and needs to improve his position in a second round of betting. Also shown is a player game management console with windows for tracking each player's stake (220a, 220b), winnings in the game (221), bet size (222), and other soft windows and “buttons”, for example, for exposing a set of selections or for forfeiting a game (223), and a “double down” control (224) that a player exercises to double a bet. Software may be configured so that the soft buttons shown are appropriate for the circumstances of the game, for example one button may be used in conjunction with a touch-responsive screen when selecting dice so that a player who is dissatisfied with his selections can back through them and make changes before pressing a “LET'S SEE” button (to be shown only when the player is locked in on his selections) that reveals the concealedly embedded content and determines his winnings. The BET button (222) shows the size of the bet and also may be pressed to increase (or decrease) the bet size depending on whether the soft button is toggled near the right margin or the left margin, for example.

The green pyramidal eye (225) is shown while players are in the process of making selections and is a gameplay timer. During the selection process the eye will begin to blink rapidly or change color as time is running down. The timer is a conventional game timer as used in chess matches; it is coupled to the processor's clock, and serves to limit the time a player has to complete a process. The timer resets each time a round of selections are received by the machine and the win ledgers are updated. Players must then race to double down (224) and make a next round of selections or to fold (223) and forfeit their initial bets. Players who do not complete the process in the allotted time will be penalized. The bet status indicator (226a) will update to BET 2 as the player enter a new round of betting.

The initial setup of a conceal-and-reveal game played with dice is analogous to the stages and simulations outlined in FIG. 5, and is operated on a gaming system essentially as shown in FIG. 4. Conceptualizing the program routines as separate functional blocks or stages is helpful for explanation, but as known to those skilled in the art, the routines may be combined or overlap in a set of program instructions, and may not be entirely distinct or separable. And while lottery numbers are preferred the form of winning indicia deposited in game matrix, other winning indicia displayed in the “match to win ledger” may be played. A child's game for example might involve a set of animals constituting the “match to win ledger”, and each embedded element is a matching animal, a non-matching animal, or a supplemental game indicium.

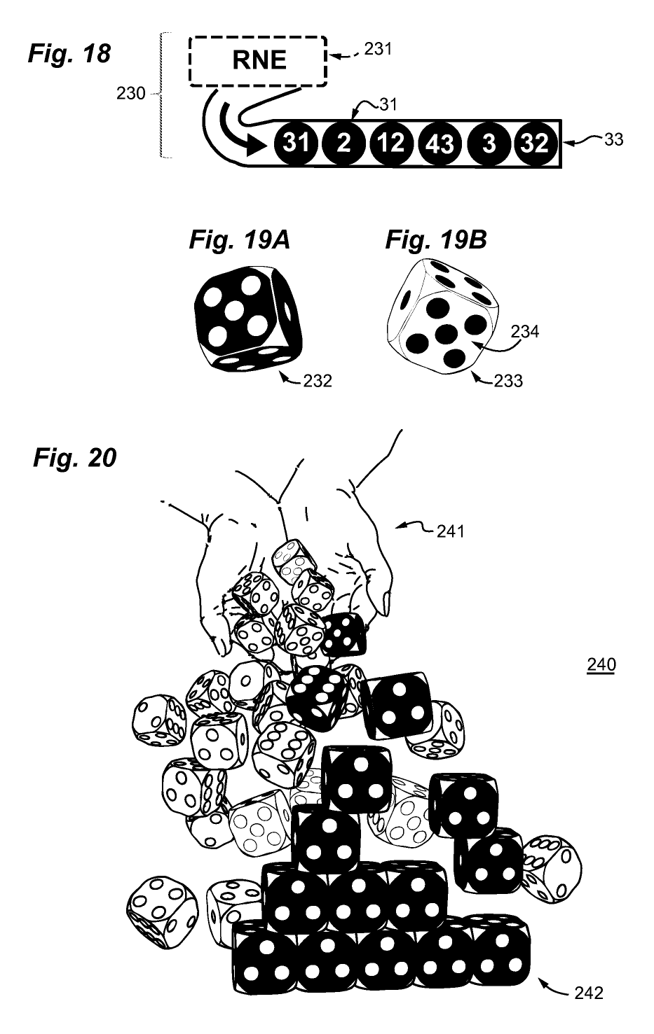

FIG. 18 is a schematic of an initial lottery play (230), shown here powered by an RNE (231). A match-to win-window (33) displays the winning lottery balls (31) unique to each game. Each set of winning lottery numbers has X members and is stored in a seed matrix. A lottery simulation can add excitement, but may also be presented in abbreviated turbo form (or run in background) in favor of the visuals of a dice throw. Use of an RNE in a lottery draw routine was described earlier with reference to FIG. 6A.

FIGS. 19A and 19B are views of a black (232) and a white (233) dice cube. These are depictions of virtual dice drawn by a computerized solid modelling system and may include concealedly embedded data associated in a memory of the dice object in the computer that created the object model. An individual face of a dice cube (234, here identified as having five pips), may also contain embedded data in the associated memory record.

The gaming system is configured to expand the seed matrix into a game matrix by associating each member of the set of winning lottery numbers (each an “embeddable element”) with a corresponding member of a set of N virtual dice cubes (each a “selectable object element”) for the game. The N×2-dimensioned matrix is further populated with non-winning numbers, non-winning indicia, or null indicia. In a preferred embodiment, the transitional stage also involves associating at least one non-randomly chosen supplemental game indicium with the dice cubes of the game matrix, such that N=X+Y−Z, where N is the number of selectable object elements, X is the number of winning lottery numbers, Y is the number of non-random supplemental game indicia, and Z is an integer number of non-winning lottery numbers or accessory game indicia. The non-winning numbers or indicia and supplemental game indicia populate any vacancies in the game matrix {G} such that no more than a single indicium is associated with each dice object. Thus each game matrix has paired data associating a dice cube with a game indicium drawn from the seed matrix, at least one non-random supplemental game indicium randomly inserted, and accessory indicia such as a non-winning lottery number as needed to fill the matrix.

The completed game matrix {G} is then subjected to a transformational stage process, in which a processor executes program instructions to simulate a dice throw. This typically involves a kinematic engine operatively coupled to a graphics rendering engine, the two of which may be combined in a program routine and may operate essentially as a single independent functionality, ASIC, or daemon when called.

The dice throw (240) includes a simulation along the lines of the animation sketched in FIG. 20, where a stream of dice pour from cupped hands (241). Certain dice in the throw are members of the game matrix and are organized into a virtual blinded construct, shown here as a growing pyramid of black dice (242). Not all dice in the throw need be used as gamepieces; some are intended only for entertainment and may simply vanish.

Visuals are enabled using conventional ray trace and animation arts to simulate a throw of a multiplicity of dice cubes so as to form a representation of a “blinded virtual construct” of N dice cubes, each dice cube of the array concealing a winning number or other indicia of the game matrix. The virtual construct of dice to be played are displayed on an interactive user interface and is analogous to the scratchcard of the preceding embodiment, and in fact fifteen selectable object elements are again included. In a preferred game, bets and selections are received in sequence, each round of betting corresponding to one or more selections of dice.

The gaming system is tasked to intermix and disassort the game matrix before or during the dice throw, so that the blinded virtual construct that results is a “disarray” of the initial game matrix. For fairness, locations of winning lottery numbers cannot be tracked in the process. Aspects of this intermix and disassort process are illustrated in FIG. 21 and FIG. 22.

Describing the blinded matrix in noun form as a “disassortment” means that the game matrix is both blinded and disordered such that the population of indicia in the initial rows and columns of the expanded seed matrix are now intermixed and disassorted with non-winning indicia and/or null indicia so as to be jumbled, jumbled, shuffled and confused as to the positions and order of the winning numbers in the dice construct. One and only one number or indicium of the matrix is associated with each one and only one virtual dice object (where a dice object may be the dice cube or a dice face of a dice cube) and all of the winning numbers are in the game matrix and thus the winning lottery numbers are embedded elements in the dice construct. Each game is unique and the number of possible unique combinations in each face of a pyramid of FIG. 17 is on the order of 10¹² (15 factorial), depending on the details of the lottery match game. If six winning lottery numbers are present, the possibility of selecting all six in a row is

$$f = \frac{6}{15} + \frac{5}{14} + \frac{4}{13} + \frac{3}{12} + \frac{2}{11} + \frac{1}{10} = 0.000199800 ,$$

or about one out of 5000, exactly as calculated for the scratchcard game, demonstrating the close relationship of the two games. Larger pyramids may be implemented to extend the play time if desired.

FIGS. 21 and 22 are considered together. The workings of the gaming system are designed to provide a realistic simulation of flying and bouncing dice, and at the same time to randomize a set of winning lottery numbers in a virtual dice construct that will become the “gameboard” for a “conceal-and-reveal” game.

In a preferred embodiment, outcome of the dice throw is not a mere pick of a random number generator. An RNE call 250 is made in support of a kinematic engine and graphics rendering engine working together to produce a realistic and fully random dice throw. At the start of the throw, dice are vectored according to their relative position in a virtual hand, and the mathematics of elastic collisions and rotational and translational momentum are used to plot a final resting position for each dice cube on a virtual surface. The disassorted dice are then assembled into a disassorted virtual blinded construct with no loss of randomness. The dice operator will ensure that the outcomes are random. This programming approach is more exciting to the player than an approach in which a random number generates an outcome and then feeds the predetermined end result to an animation routine that back calculates a simulation of a dice throw back into a cup before showing the dice throw on the view screen. Simply put, the outcome of the dice throw is not known to the computer and is unknowable until the dice have formed the virtual dice construct. Then and only then may the player interrogate the dice to reveal their embedded content.

FIG. 21 is a schematic view of randomization capabilities used in making RNE calls in a gaming apparatus of the invention. Programming in support of realistic simulations of virtual dice trajectories derives from kinematic equations for solids in motion. These are modelled by a kinematic engine in cooperation with a kRNE engine and GRE such that the solid dice forms displayed in FIG. 22 at any time t will include coordinates and vectors of motion. Bodies in motion are modelled in three dimensions, with or without a gravitational force, and subjected to randomized perturbations such as collisions, acceleration, deceleration, dampening, and friction such that their final resting positions are truly randomized, thereby generating coordinates and/or vectors (or velocities) that exceed a threshold of motion-associated disorder and entropy characteristic of a fully randomized result. As suggested in FIG. 21, an implementation of kRNE may also include a hybrid with a pRNG, where the pRNG is used to assign random initial conditions of location, velocity, vector, and spin in one or more axes, so as to engineer a more rapid transition over a threshold level of disorder.

Following the dice throw, the final resting positions of the dice are randomly scattered on the playing surface. In a second transformational algorithm, dice having embedded content are randomly stacked into a virtual dice construct (shown here as a block, 260) as drawn in FIG. 22, the construct forming a block having sixty-four individual dice, fifty-six of which have at least one face on an outside wall. A TRNG engine may be used to animate this motion in cooperation with a kinematic engine for calculating the parabolic “hops” and “bounces” needed to bring the dice into alignment, as suggested in FIG. 21; thus the RNE call 250 may be implemented with one or a combination of individual RNE function calls, invocations, or daemons. As shown, the pRNG and TRNG calls are alternatives or options. For example, the kRNE, TRNG or kRNE/TRNG combination may provide the modelling for the chaotic motions depicted in FIG. 22. Where randomization has been achieved by kinematic modelling as in the dice roll of FIG. 20, a stacking command based on order of increasing or decreasing proximity will not decrease the disorder, each dice having an embedded attribute that designates it for a particular face of the cube.

FIG. 22 depicts a virtual dice polygon 260 construct on a virtual gameboard boundary or surface 261. The dice have been randomly scattered on the game surface by the kRNE engine as described in FIG. 20, and are now spontaneously jumping into position of the growing cube. Parabolic flight paths, modelled by ballistic equations for solid body trajectories in a gravitational field, are indicated by dashed lines 262. Some dice take two hops or more, adding to the visual drama. Some collide and fall, and must be re-inserted. Dice that are not directed to the construct are shown scattering away on trajectories marked with an “x”. In one embodiment, dice will jump faster on hot days than cold, or will freeze in the air if a phone call interrupts the game. The trajectories can defy physical laws but be convincingly realistic, depending on the kinematic equations in the software engine.

How are the dice instructed where to position themselves in the block? In a simple model, dice constructs are built from the bottom up, and the dice that fall closest to the construct are the first (or the last) to be assembled. Each dice that will be played has three faces that can be selected from the cube, therefore the rotational alignment of the dice in the construct is also factored when placing dice. In other instances, a TRNG may be used to re-assign embedded content to the dice faces in play, simplifying the task. In the end, the dice block shown has six sides, each of which may include a game matrix that is playable in the game. In one variant, the number of winning lottery numbers on each side of the dice block may be randomized by the kinetics of the assembly, leading a player who sees a deficit of matching lottery numbers after playing one game, may choose to play another on the same dice block with the expectation that an excess of matching lottery numbers are to be found on another side. Playing six sides at a time eliminates this bias and simply increases the odds of winning one or two of the six simultaneous games and losing an equivalent number.

By associating an indicium with a face of an individual dice cube rather than the dice cube as a whole, the game played on one face of a larger polygonal construct will be uniquely different from the game played on a second face, i.e., there need be no degeneracy of the game matrix at the common edges. From experience testing how the game flows and how wins and losses distribute over thousands of plays, a number of dice in the range of 15 to 30 is preferred; but this range is simply current best mode and the invention is not limited thereto. We have found that for a typical gamer, a number of dice equal to about fifteen results in a high game velocity and escalating betting when the game is operated as disclosed here. Lottery-based “conceal-and-reveal” dice games having nine to twentyeight dice are currently preferred.

The simulation of a virtual throw of dice (240) with dice bouncing on a solid surface and spontaneously assembling into a virtual solid construct can be accomplished about two seconds; faster than “counting to two”. A player making seven selections from a dice construct on a touch sensitive gameboard can accomplish the task in about 3 seconds. Other ways of accelerating the presentation of a virtual construct are readily envisaged, but the dice throw concept incorporates an entertainment value during the mixing and disassorting step, not unlike the spin of the reels in a slot machine game, and does not slow betting.

The game may also be played for fun. A player may test the integrity of the game by tilting the virtual gameboard and noting that the roll of the dice extends over a longer trajectory because of the increased momentum when the gameboard is tilted down, and a shorter trajectory because of the decreased momentum when the gameboard is tilted up without any loss of the realism of the dice throwing simulation.

The “tilt” function is readily implemented in specialized gaming systems such as “smart phones”, where a gyroscope and multi-axis capacitive accelerometer have come to be standard hardware. The gyroscope is used in the phone to orient the user's display from portrait to landscape when the user turns the phone from vertical to horizontal. However, considering the phone display as a game surface, the gyroscope may be “hacked” to allow the player to tilt the game field. When tilted, gamepieces no longer bounce up but instead bounce sideways or are thrown against the “virtual ceiling” of the game space, offering many unique possibilities for entertainment. This offers the player an illusory capacity to bias the game to individual gamepieces. However, in the “conceal-and-reveal” games of the invention, any randomness reduced in the transition stage is recovered in the transformational stage, as described above.

Play with dice having special shapes is another advance in the art that is realized in the games of the invention. Because virtual dice may be non-cuboidal, and may include tetrahedrons, octahedrons, regular dodecahedrons, or regular icosahedrons, and more complex geometric representations of dice constructs, sensu lato, are possible, including geodesic spheres, for example, where players select triangles, pentagons and hexagons displayed on the surface of a geodesic sphere or a higher order tesselation, almost endless game variants are possible. MahJongg type variants may also be designed with four walls of virtual constructs, one per player. At this filing, a pyramid is preferred because of the mythology that surrounds it and because of its familiarity to a typical gamer. A three-dimensional pyramid may give rise to multiple two-dimensional isometric pyramidal projections. An octahedral pyramid having an up apex and a down apex and eight faces is also preferred, the octahedron offering eight possible game matrices. Games of the invention may also be designed for groups of players partial to cubes of cubes, rectangular constructs, or rows or columns of dice or blocks, without limitation. In one interesting variant, a cube having 18 dice (3×3×3) may be nested within a cube having 64 dice (4×4×4), which in turn may be nested in a cube having 125 (5×5×5 dice) by varying the size of the dice in each shell, so that games of increasing complexity may be played one after another by adding layers of discovery and fresh content.

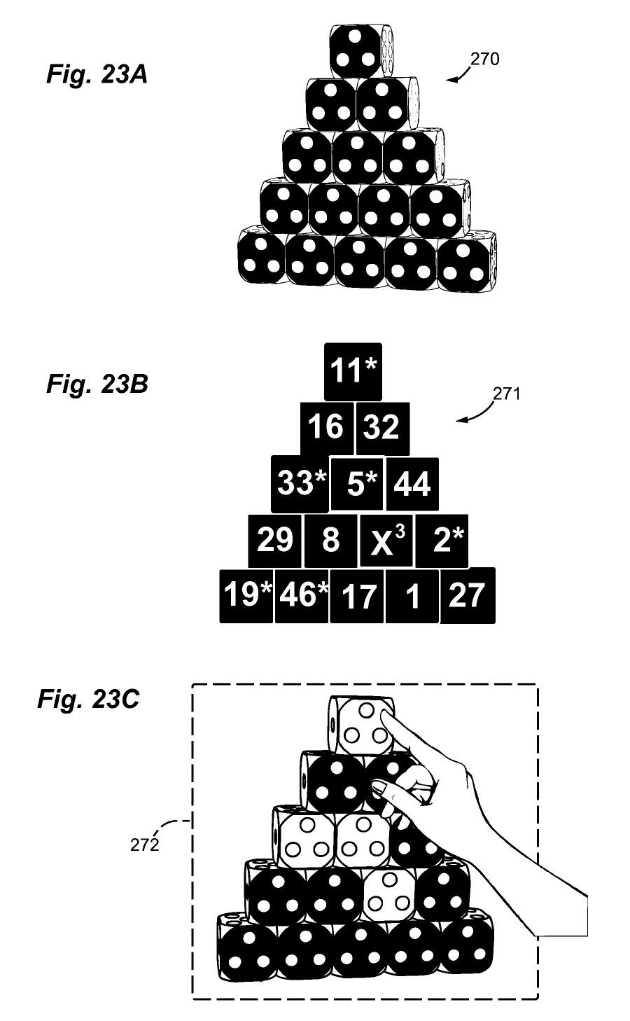

FIG. 23A is a schematic representation of a “conceal-and-reveal” gameboard played with a structured construct of dice (270) in an initial “game opening” state. Following a dice throw (FIG. 20) the dice cubes have formed an organized pyramidal construct of fifteen elements and any unused dice simply disappear. In this view, each dice cube is oriented so that the face having three pips is displayed front forward. In alternate games, playable in parallel or separately, other faces such as the four pip face or the six pip face may be presented. In other words, the dice cubes may be oriented so that all dice have a common orientation of each of the dice cube faces and hence up to six games may be played in parallel simply by provided each dice cube face with an independent game matrix.

In a basic game play stage, typically the player will make a first bet and then pick one, two, three or four dice from the blinded construct 270. The player may make a second bet and chose additional dice. The bet/select routine is iterated for best effect. For reference, a sample game matrix (271) is revealed for reference in FIG. 23B; an asterisk indicates a winning lottery number from an earlier lottery draw stage of the game. FIG. 23A shows the dice as selectable object elements; FIG. 23B shows the embeddable elements of the game matrix. FIG. 23C demonstrates how individual dice on a display screen 272 are selected by a player. A player, by touching parts of the screen, is able to select individual dice cubes he or she wishes to play. The dice that have been selected are white, the as-yet-unselected dice are black.

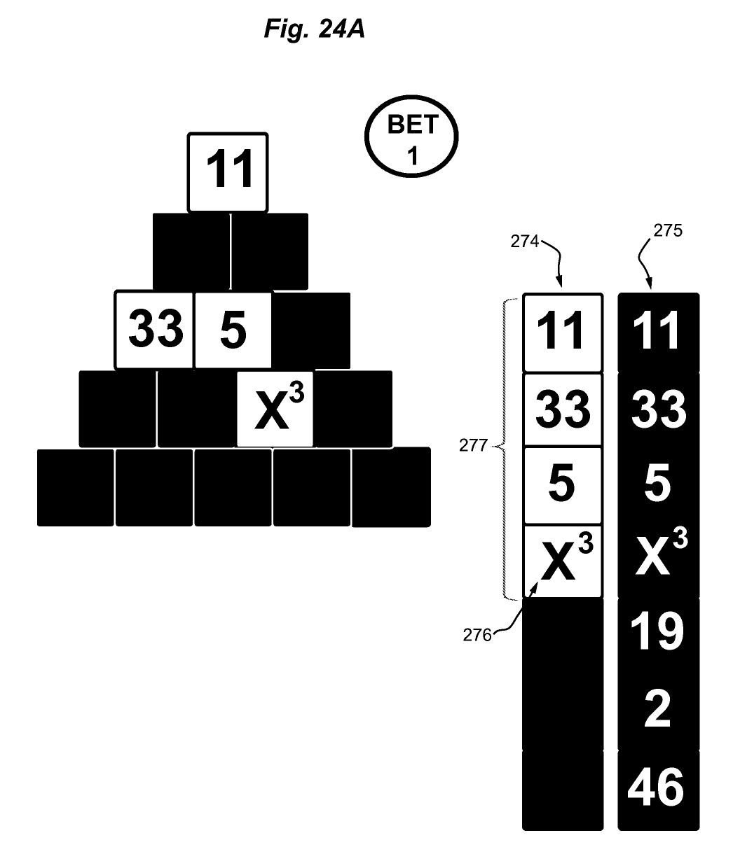

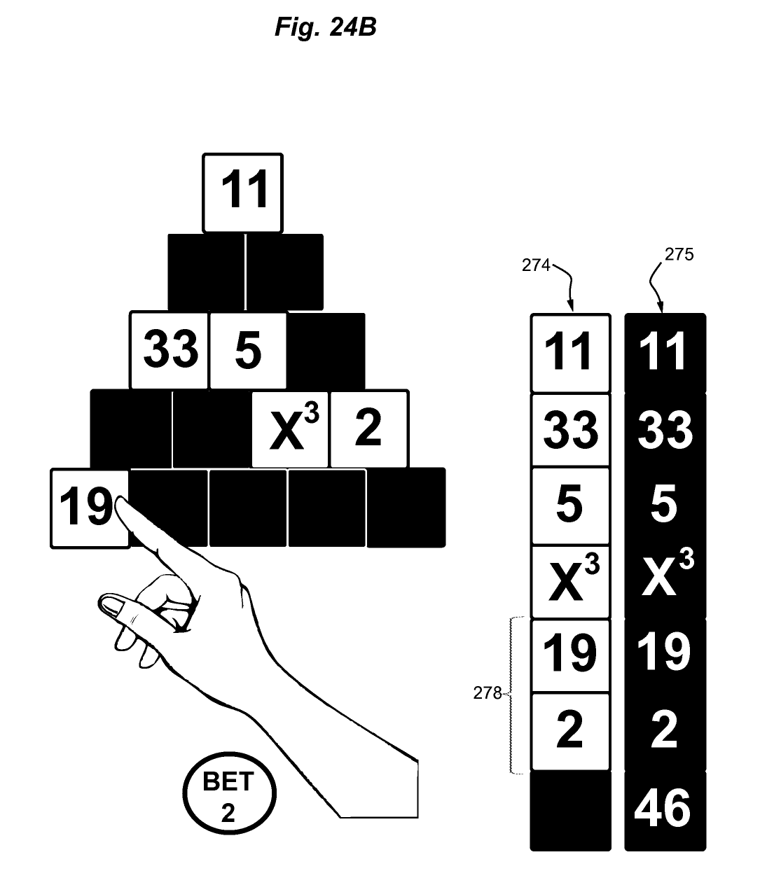

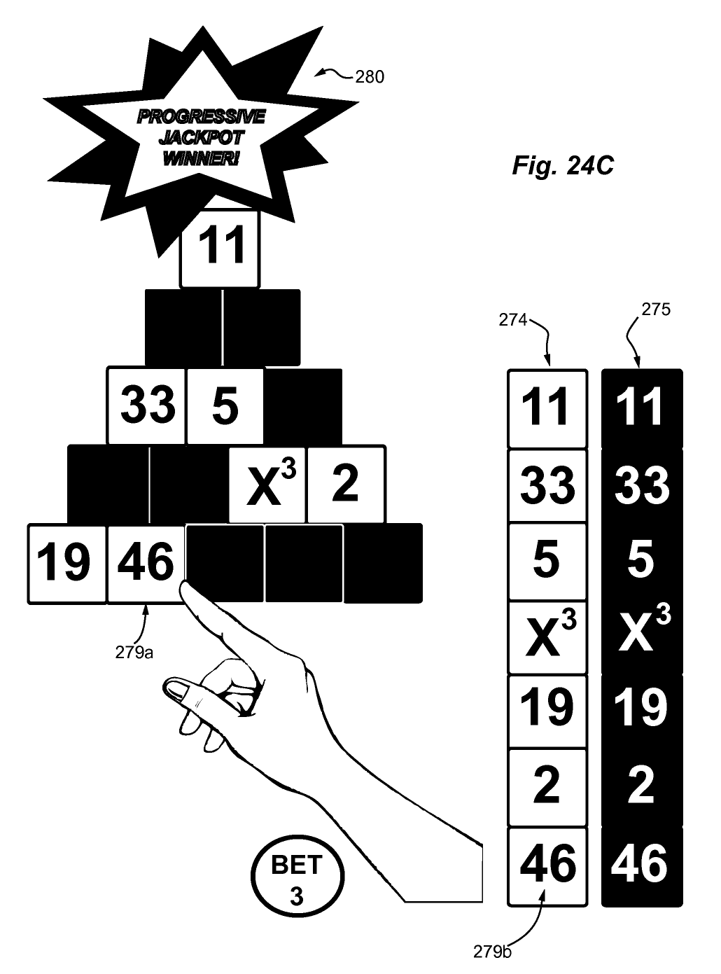

These and other features of a sample game are illustrated in step-by-step play in FIGS. 24A through 24C. While not shown here, also a component of a gaming machine of the invention is a graphical user interface and interactive display for receiving from a player one or more selections of dice to be played. Preferably the betting sequence has a plurality of iterations. The gaming machine, on receiving a first bet, will display a blinded game construct, accept one or more user selections of dice faces, and display the embedded winning lottery numbers or other content associated with the selected dice. Subsequent rounds of bets are associated with subsequent rounds of selection. After each selection, the embedded contents are displayed to the player and any winning selections are transferred to the win ledger. The user interface also includes player data such as wins, losses, credit balance, win table, bonus rounds, betting windows, and so forth as needed to play the game and display the game outcome.

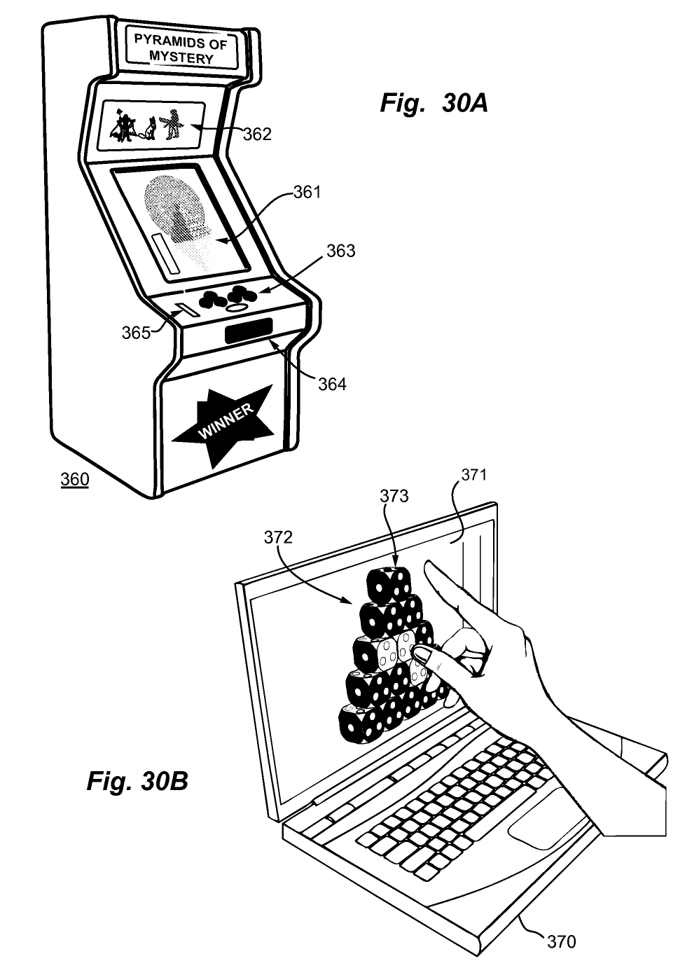

As suggested in FIGS. 14 and 30A, and also FIGS. 6A and 17, control surfaces of the user interface may include “hard” or “soft” buttons, joysticks, trackballs, keyboards, motion sensors, windows, and so forth as known in the art. Preferredly, the user interface includes a touch screen for selection of dice cubes from the game construct and for other functions so as to speed play. The graphical user interface will also include special effects, animations, video clips, and help functions, or even a demonstration mode, and may be programmed to permit the player to select a set of themes according to user preferences.

The game progresses through a series of three rounds of betting and selection, leading to a game outcome. The player is awarded a progressive jackpot for scoring a perfect game. A first set of four selections (BET 1) are represented schematically in FIG. 24A. This represents the results of a first round of gameplay. White dice squares in the pyramid indicate the player's selections. The black dice squares remain masked.

The vertical bars of squares on the right represent a “win ledger” (274) showing any matches awarded to the player and a “match-to-win” column (275) showing the full reference set of lottery numbers already drawn for the game (in white on black). In the first round of betting (BET 1), three winning numbers and a power bonus indicium (X³, 276) were matched (277). Players having this luck will almost certainly choose to go for a second round of betting.

In FIG. 24B, after placing a second bet (BET 2), the player touches the video screen (finger) or moves a cursor, for example, to select a second round of dice cubes, here two in number. Two winning dice cubes are selected and the results displayed in the player's win ledger (274). The two selections are winning lottery numbers (278). For simplicity, only winning lottery numbers and supplemental game indicia are shown in the player's win ledger. One skilled in the art will recognize that non-winning numbers are not displayed so that the player can more readily grasp the progress of the gameplay. After BET 2, the player now is “in the money”; he has five of the six lottery numbers needed to win a grand prize, and also has a shot at the progressive jackpot in his last bet. The player has a strongly winning game and will take the option to bet again on a final cube in hopes of increasing his winnings.

FIG. 24C is a view of a perfect game, in which a lucky player selects all six matching lottery numbers and a power jackpot indicium X³. In this view of the game display after a third bet (BET 3), a final dice cube (279a) was selected. The embedded content of the cube is revealed and a sixth matching lottery number (279b) is transferred to the player's win ledger (274). All numbers and indicia match the contents of the “match-to-win” window (275) and an image or series of images and accompanying sounds are displayed (280) to indicate a big win that draws a crowd.

Often a plurality of gaming machines are linked together in a way that allows the group of machines to offer a particularly large prize, or “progressive jackpot.” Each gaming machine in the group contributes a small amount to this progressive jackpot, awarded to a player who picks the full set of matching lottery numbers and a jackpot indicium. The amount paid out for the progressive jackpot prize is usually far higher than any isolated gaming machine could pay on its own.

In this sample game (FIGS. 24A through 24B), the game has three rounds of betting and a total of seven selections were made. The selections were split so that two selections were made in a first round, three selections were made in a second round, and a final dice was selected in a third round of betting. The number of members in the set of winning lottery numbers is X, the number of supplemental game indicia is Y, and the game matrix has N selectable object elements corresponding to N embeddable elements, wherein N, X, and Y are integers and N is greater than (X+Y), such that any one of the winning lottery numbers and supplemental game indicia is associated with one and only one selectable object element of the game matrix. The strategy of the game is to select the right choices over multiple of rounds of betting, reveal the embedded contents, and to match a threshold number of the set of the winning lottery reference numbers. The number of selections the player is permitted to make is Q, where Q is always less than N but is generally greater than or equal to X. So for example where Q=7, the player will pick seven dice members on a touch screen out of the total of N dice in the construct and the results for the game will be determined from any matches of the X lottery reference numbers revealed in the selections, as modified by any special game indicia. To win a lottery prize, the player must match a number of lottery numbers (including any wildcards) equal to or greater than a threshold count ΣQ*min of matches defined by the game operator.

The chances of winning are adjustable by selecting the number of dice (i.e., dimension N of the game matrix), the number of lottery numbers X in the winning lottery number set, the range of lottery numbers to be matched, the total number of selections allowed for the game Q₁-Q_{T}, the threshold number of matching lottery numbers ΣQ*min needed for a win, and the number of supplemental game indicia Y or bonus prize and consolation extra win combinations. Where the set of supplemental game indicia has a non-zero number of members, the supplemental game indicia, non-winning numbers or other non-winning indicia may be inserted into the game matrix when the seed matrix is expanded and intermixed. Supplemental game indicia generally lower the overall chances of winning a lottery matching prize while increasing the size of the prizes (with the exception of wildcard indicia). Bonus wins having lower payouts may be included if desired. The operator of the game will define an N, Y, X, Q_{T}, and ΣQ*min having favorable play characteristics.

Also relevant to the function of gaming machine of the invention is a scoring management subroutine (24) having a loop of code for iteratively receiving bets/selections and for displaying concealed indicia associated with any selected dice cubes. The numbers N, Q, X, and Y are integers. The scoring management subroutine must contain logic circuits for evaluating the truth of propositions such as “Embedded in selection Qᵢ is a number Xᵢ which is a winning lottery number”. The processor will tally the number of matches ΣQ* before resolving a bet. Under preferred game rules, the content of each player's selection will match either (a) one or more of the set of winning lottery numbers, (b) one or more of the supplemental game indicia, or (c) will not count in the user's win ledger. The number of rounds of player selections and the number of user selections per each round of play will be defined in number so that the total number of selections Q_{T} is less than the number of rows or columns N in the game matrix. Generally Q_{T} is a number that is a plurality or a majority of the X members of the reference set of winning lottery numbers. The order of the matching lottery numbers is coincidental and is not generally a required factor for winning the game.

The scoring subroutine also serves to evaluate other win and lose scenarios and the game status. When the machine determines that a game has been terminated, either by forfeit or in a winning or losing status of gameplay, a final display is assembled having the needed status information to be displayed to the player, including win value, bet value, and any additional relevant scoring information. Alternatively, scoring may include bonus prizes for lesser wins associated with non-winning numbers or other indicia so as to promote player loyalty. These can include drinks, meals, giveaways, credits toward gaming, bonus rounds, other incentives, and so forth. Optionally, the game matrix may be revealed at the end of the game so that the player may see the embedded contents of all the members of the dice construct and note where the winning lottery numbers were concealed.

Bonus play may involve supplemental game indicia, or non-winning numbers in the game matrix, or more generally, non-winning indicia, where “non-winning” indicates that the selections are not effective elements in winning the lottery match game. A wildcard is a supplemental game indicia that may impact the outcome of the lottery matching game; a JP (any “jackpot”) indicium may be associated with a chance to win a larger progressive pot when combined with a set of winning lottery numbers; hence these are termed “supplemental game indicia”, not “non-winning” indicia. Bonus play often involves games where the lottery match game is a loss. So the bonus will require a less stringent win combination, such as three numbers defined by the processor in the residuum of the matrix after two negative selections and matched in subsequent play, whether lottery numbers or not. Careful assessment of odds permit the game operator to factor in smaller wins in determining the overall profit potential of a game design, but there is no substitute for high traffic and a game that has many happy winners is desirable in some business models.

To meet the player's need for periodic positive reinforcement, players may be instant winners in some games. The gaming machine may be configured to randomly select certain loci of the game matrix for a special prize that is independent of the lottery game. In a preferred realization of this, a function call or script is inserted into a game matrix at one or more loci corresponding to objects or loci of the matrix display so that when the player touches these elements, the prize is triggered but the game continues. Parallel games of this type are known to stimulate player interest and add the enjoyment of more frequent wins. As another accessory prize, players who pick certain combinations of non-winning numbers or special indicia (such as slot machine indicia) may be rewarded with a minor prize. For example, players who pick a combination of non-winning numbers totaling “21” on a row of the simulated dice construct or in random positions, or on the first play of the game, may receive a booster prize of a lesser amount, or a free game ticket, a drink on the house, and so forth. Because any player who selects three or more non-winning loci will have a reduced chance of a game prize, these accessory prizes serve as a sort of consolation price. Special prizes of this type are illustrated here by example.

Players may also be rewarded for patterns of repeat business. By monitoring return player activity, game operators may identify preferred players for special status, and may be given preferred odds, a bonus stake, or other perks in recognition of their loyalty in the manner of a frequent flyer program or admission to a special club facility on online site.

A matrix may also be used to define “hot spots” that govern “instant win” plays such as by adding an additional column to the game matrix, defining the significance of particular loci in that column, and playing essentially a second bonus game in parallel with the lottery matching game.

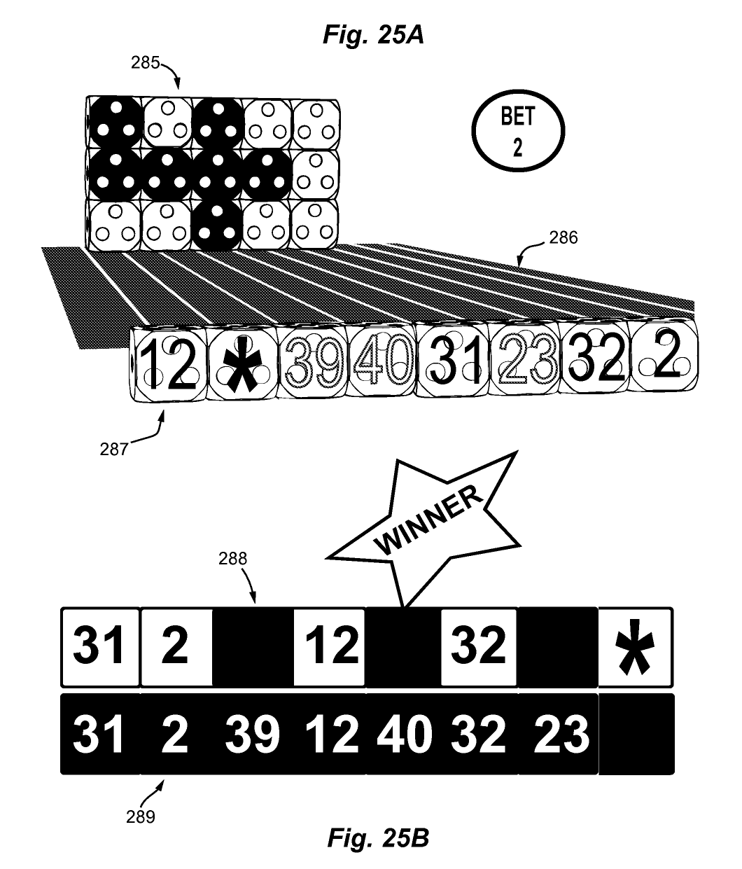

FIG. 25A is a snapshot view of a game display showing a wall of dice 285 (3×5 like a scratchcard) as a blinded virtual construct, where two bets have already been played. The player is a winner. A virtual game surface 286 is highlighted. The score is tallied in the win ledger (287) at the front of the gameboard, where * is a wildcard. Winning lottery numbers “12”, “31”, “32”, and “2” have been selected; four matches out of six, plus the wildcard, clearly a winning game where rules for this game specify ΣQ*min≧4.

A view of an alternative win ledger (288) as a horizontal window above a “match-to-win bar (289) is shown in FIG. 25B, allowing the player to quickly grasp the outcome of the game. Winning lottery numbers that were not matched are shown as blank black squares in the player's ledger. However, counting the wildcard (*), the player has matched five winning lottery numbers, and the gaming machine will consult a win table in memory to calculate and display the player's winnings. Five winning lottery number matches out of six generally is a significant prize.

Alternate views of the win ledger may include glowing neon, paper lanterns, balloons or tiki torches at the front of the playing stage, depending on the game theme selected by the player. The background may be shrouded in darkness, with fireflies drifting around and over the gameboard so as to evoke a sense of relaxation and enjoyment, for example. Or a win may be accompanied by skyrockets exploding above the gameboard, and in one simulation, dice will be removed from the game construct as they are selected and transferred with a sliding motion to the front of the gameboard. In a preferred embodiment, the sights and sounds of the game may be controlled by the user by simply dialing in the kind of entertainment they are looking for. In other embodiments of the game, a click on the screen in a corner may enable a selection menu from which a set of companion players may be selected to assist in making the game picks as will be described next.

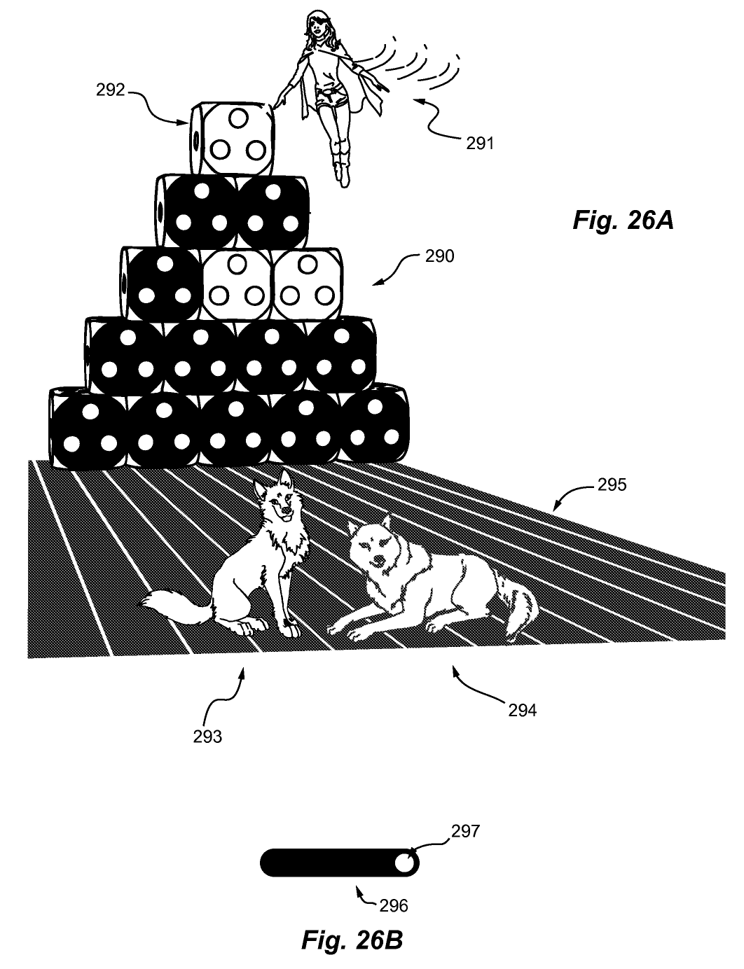

FIG. 26A is a view of a game with a pyramid (290) and a plurality of avatars as companions when playing the game. In this instance a flying nymph (291) accompanies the player to the third cube he has selected, here the apical dice cube (292) is indicated as a selection. A pair of wolves (293, 294) await player commands and are at rest on a game surface (295) that adds depth and significance to the game display. In more advanced augmented reality displays, the perspective will change as the player moves.

FIG. 26A is representative of multiplayer gaming as enabled by the gaming machine of the invention. In a first embodiment for three players, three player-designated avatars are simulated on a gameboard composed of a pyramid of dice 290, perhaps with a backdrop of moving clouds, fields of waving grass, an African savannah, or star fields of the Orion nebula, deep space, and an occasional supernova or meteor exploding in the play space without warning. Avatars may be assigned by lot, be chosen by a draw, or by preference. Each avatar provides added entertainment when assisting in making selections. While a first player may have chosen the nymph 291 as a guide or companion, another player may have chosen the adult wolf 294, and a third player the juvenile wolf 293. The two wolves may interact, expressing a bond or pairing felt by two players of the three. Each avatar may have different characteristics selected to be discovered as play progresses and optionally to have different rule sets in navigating the game. When a wolf is chosen, the animal may sniff at the dice to give a hint as to the best cubes to pick and will climb or jump to reach the upper cubes. In other embodiments, an archer may be tasked to target individual cubes under the direction of the player, extending the game audience so that casual players may pay to play it recreationally. In a preferred mode, visual thematics, music and animations are designed to complement and enhance gameplay—in the same way as Vanessa White has served to light the squares on a television game titled “Wheel of Fortune”. The avatars break the rhythm of “bet-present” with diverting animations and engaging expressions of encouragement. Periodically new characters are introduced so that the game content is always offers fresh for adventurous players. The current level of skill in putting flesh, light and shadows on wireframe animations is approaching lifelike representations, so that stick figures or puffy cartoon caricatures no longer meet the standard of excellence to which game operators may aspire.

For a three player game, three game matrices are embedded in the dice, one for each player. Each player has a win ledger. Players take turns picking dice and compete for the highest score in a final outcome. At each turn, direct interactions between the avatars may change the course of the game; for example such that an avatar may prevent other players from picking a particular dice cube by guarding it or one player may have a handicap. The game matrices are independent and the player's dice selections are displayed only during the player's turn so as to avoid confusion. Alternatively, where each player has a dedicated user interface, such as in networked applications of the gaming apparatus, the appropriate game matrix manifestations are directed at the individual screen and a general representation of the dice construct, the gameboard, the avatars, and win ledger bars for each player are shared, as in a tourney where the scoring is competitive. Where player betting is permitted, the house may take a part of the winnings, or casual players may settle their bets at leisure.

If four players are playing on a square gameboard, the number of bets increases to the equivalent of one bet every 3 seconds. With an online gaming platform, the number is almost irrelevant, because thousands or tens of thousands of game matches can be played simultaneously using asynchronous parallel processing, so quickly that even betting a dollar rapidly compounds to a continuous transglobal revenue flow in four or five figures per hour for a popular game.

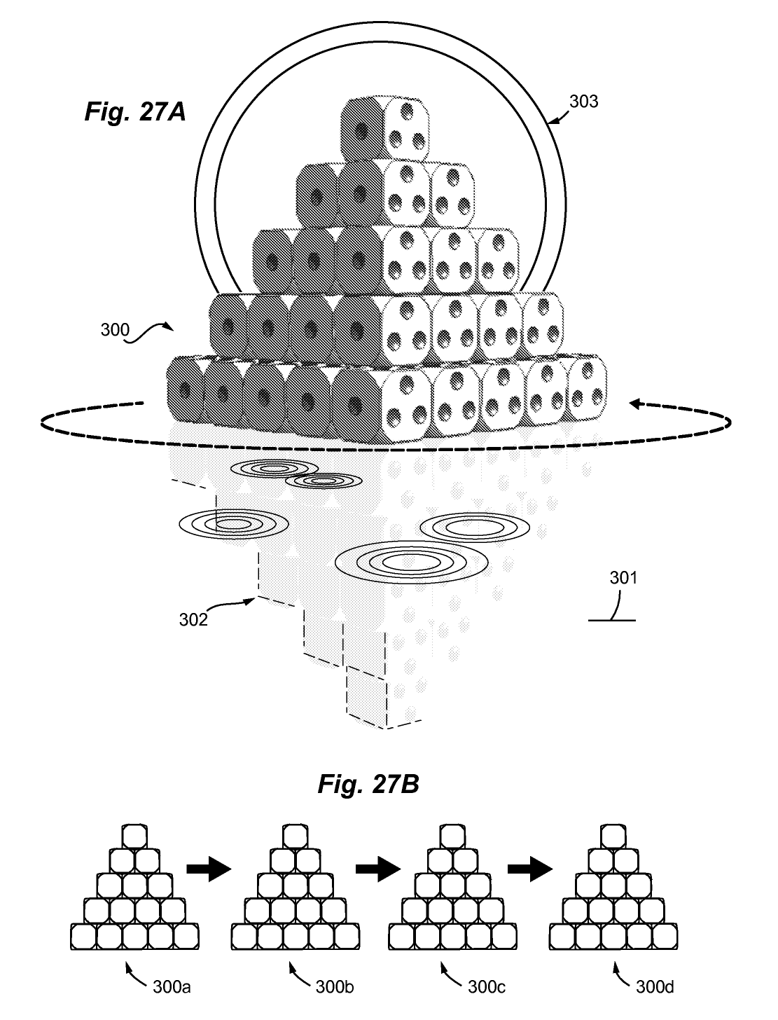

FIG. 27A is a view of a virtual three-dimensional pyramid 300 having four game sides or ‘aspects’. The construct may be rotated (dashed arrow) to select any one of the four aspects for play. The construct may include a virtual game surface 301, here shown as a reflecting pond with reflection 302 and raindrops (ripples) for a calming mood.

FIGS. 27A and 27B provide another dimension to the range of entertaining variants that are possible with the gaming machine of the invention. A player may play four games, one on each face of the pyramid, either in series or in parallel, while the pyramid rotates as the game sequence progresses. A mandala or kaleidoscopic image 303, or a moving cloudscape, for example, may accompany the game to provide a sense of depth and adventure, for example by rotating and pulsing with the gameplay. In one embodiment, the impression of raindrops is given by a pattern of circular expanding ripples moving across the playing surface 301 of the gameboard. A dark background enhances the effect of mystery as the mandala 303 slowly revolves and radiating color and pulsatile intensity draws the eye to the game, enhancing the mystery of the pyramid 300 in the foreground. A rainbow appears in rays of sun when the player wins, or the raindrops transform into snowing cherry blossom petals and a gaming system fitted with a scent dispenser mists the air with a bouquet of essential oils. In other embodiments, the mandala is replaced by a fractal image wrapped in infinity, and expands to fill the screen as the Mandelbrot set is iterated during play.

In other realizations, the reflecting pond in the foreground of the gameboard may be inhabited by fluorescent fish, fish that jump at the dots in the dice and disappear into the pyramid, emerging as birds on the other side in an Escher-like tableau. These fantasies are updated at intervals by flashing the EEPROM in a casino gaming machine, for example, or by uploading new game themes to a browser-accessed gaming platform through external link 16 so that content is never dull and commands a price for each download, if desired.

FIG. 27B illustrates the use of three dimensional pyramids to set up four game sets (300a, 300b, 300c, 300d). As the pyramid rotates against a background of a mandala, a player or a player's avatar may pick any one of the faces of the pyramid for a first game.

At the end of the first game, the view revolves into a second game with new content, a third, and a fourth (300d) for fast presentation of multiple games in series. Each game in the series is played with a different face from the original pyramid (as viewed isometrically). These could be conceived as East, North, West and South for reference. Alternatively, all faces may be played at once for each face of each dice cube, allowing for 4*6=24 playlines.

An astute observer will recognize that the overall pattern, including the reflection, is that of an octahedron, so that up to eight games may be played in a single screen simply by showing playlines with win ledgers for each of the eight dice construct faces of the octahedron. These games can be played in parallel or in series, if desired, without degeneracy.

Multiple “playlines” (which may be played independently in parallel) allow the player to select the most promising games for increasing the betting while abandoning (and forfeiting) games that offer limited chances for a higher return. In an exemplary playline, the player interacts with a graphical user interface by making a first bet and selecting one or more simulated “object elements” from a static construct of dice; the selections reveal a first set of embedded numbers and indicia. Other embedded indicia of the game matrix remain concealed. Over two or more rounds of betting, each set of selections reveals additional concealed content, so that winning combinations are defined when a player matches a plurality of the lottery winning numbers, or all of them.

Other adaptations for multiplayer games are disclosed. The game setup typically will include non-random supplemental game indicia associated with the dice objects of the game matrix during the intermix. Supplemental game indicia may also include machine code for animation routines linked to the game and the betting. Using extended function calls, social gaming that includes avatars and/or animation becomes intense and riveting, and the gaming machine may support online competitions and gamebox versions. Several “game-within-a-game” embodiments that merge gambling and gaming are disclosed. The duration of winning and losing streaks may be scientifically proportioned to maintain interest and increase gameplay velocity with an ultimate incentive of winning a progressive lottery or other jackpot, for example. Revenue streams from the game may be based on betting, on-line gambling and casino gaming, memberships, advertising, tournament play, or on downloadable content deliverables (such as “apps” used in social gaming) while not limited thereto.

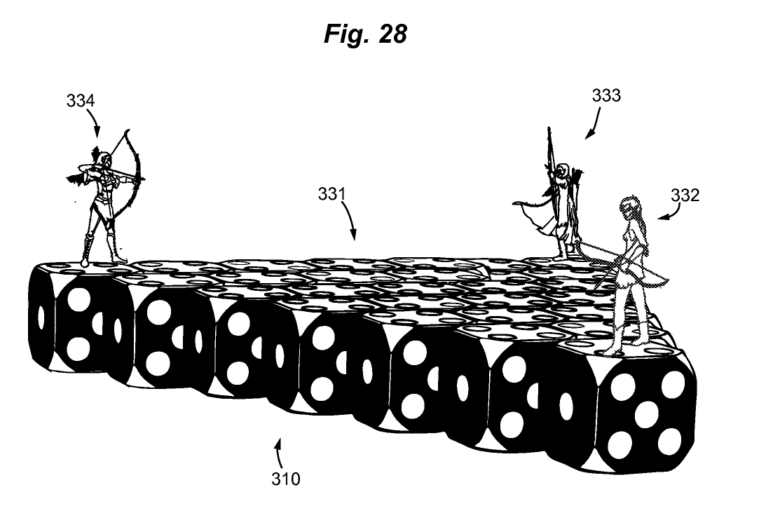

FIG. 28 illustrates a virtual tiled pyramid (310) having twenty-eight dice laid flat to simulate a raised surface of a gameboard (331). At the game opening, each apex of the triangular gameboard is occupied by an avatar (332, 333, 334) representing a player. The players must compete on the gameboard while betting to match winning lottery numbers embedded in the dice. The game is a multiplayer game-within-a-game having motion and interaction of the avatars. The betting and selecting subroutines may be operated by function calls. In this instance of complex social gaming, non-winning indicia such as an embedded trigger symbol (an ampersand symbol for example), may be used to activate special function calls. In fast action, players must duck arrows while traversing the gameboard.

At this level of programming, a gaming platform such as a game box or computerized network with cloud-based programming is capable of conducting a first betting game of matching winning lottery numbers while simultaneously executing a second game in which the players hunt each other's avatars with weapons such as bow, axe, sword, spear, pistol, laser rifle, or knife, for example, in a virtual world. If each game takes 1 minute and involves three players, for example, and each player makes 5 escalating bets (about 1 every 12 seconds), then the total revenue flow in units per unit time is 15 bet units per sixty seconds, equivalent to 1 bet every 4 seconds. During the betting, the avatars progress across the board one, two or three dice cubes at a time, so that play is fast and decisive. Progression is generally toward the center of the board. Any player's draw (selection) that includes a “skull and crossbones” indicium gives one player the opportunity to claim another player's winnings by battle ending in sudden death. The programming and artistry required to create an animation of this type is well within the skill of game designers upon understanding of the gaming systems disclosed here.

FIG. 26B is a representation of a slideable player control for selecting a game theme or format from a range of game themes and formats. For example, any of the formats and themes described in FIG. 24A through FIG. 28 may be selected. A similar sliding control may be used to control the rate of gameplay or to accelerate certain steps such as a lottery simulation or a dice throw. The slider 296 is shown as having a soft button 297 that may be moved across the slider so as to select a game theme or to speed or slow play depending on the context.

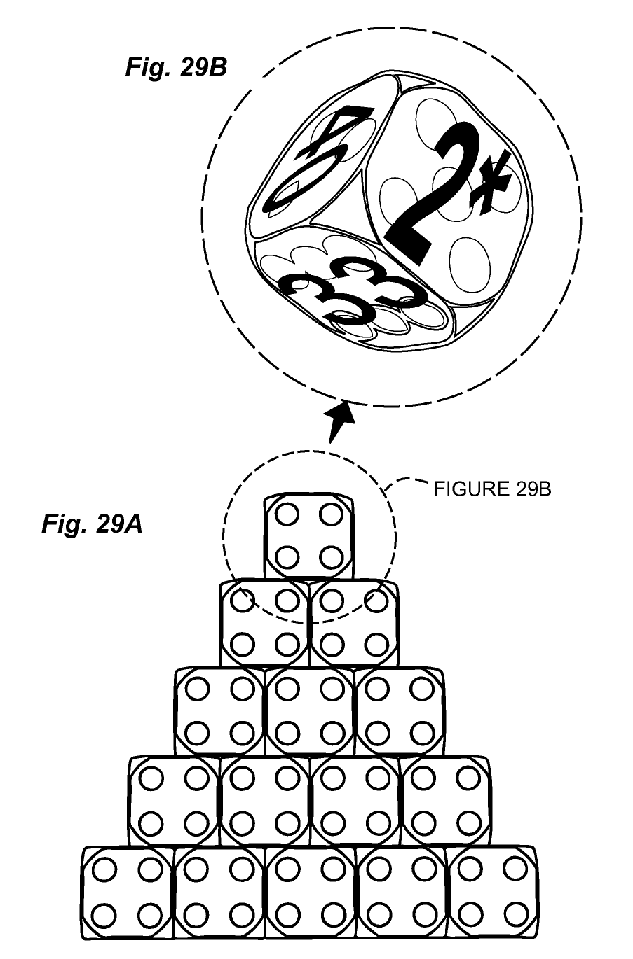

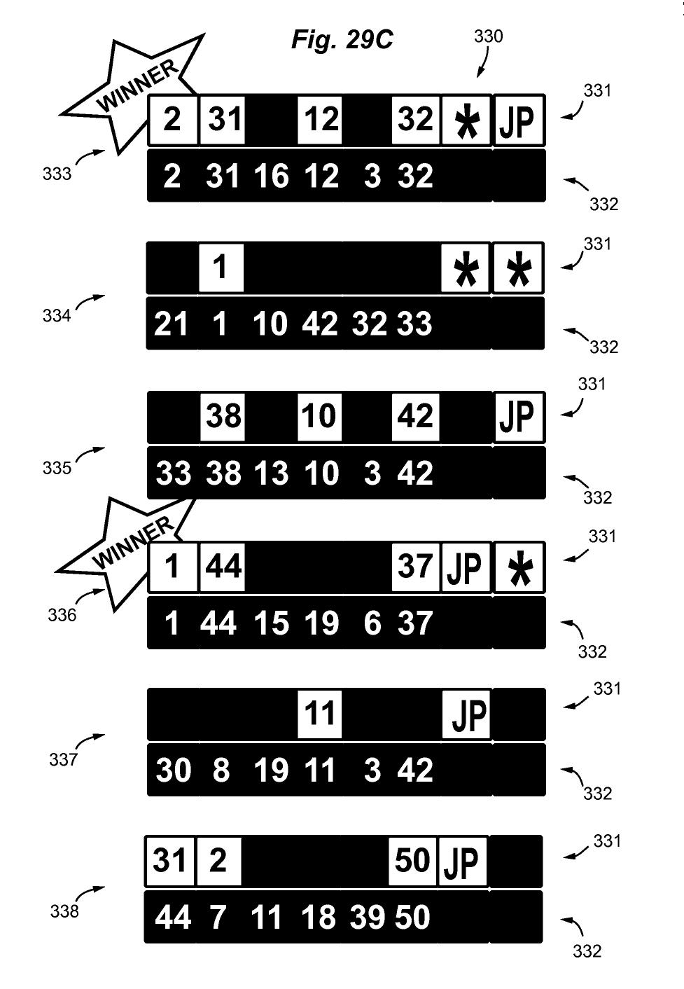

FIG. 29A illustrates a pyramid of fifteen dice cubes, and may be a two dimensional isometric representation or a three-dimensional representation with full perspective. FIG. 29B is a detail view of several faces of the uppermost dice cube. Each facetype of each dice cube may be associated with one of a different winning lottery number, a non-winning number, or another indicium. The game operator has merely to rotate the dice cubes of the virtual construct from one facetype to another and a new game matrix is available for play. Thus any individual pyramid as represented here can be played six different ways depending on which facetype is presented to the player. By providing multiple win ledgers, bets may be placed on up to six games played at once. These are termed “playlines”.

FIG. 29C is a game display showing “match-to-win” and “player's tally” windows for six simultaneous playlines. Rather than consider a single matrix associated with a construct of dice cubes, six matrices are envisaged that are associated with each face of a dice cube construct. The lottery simulation is adapted to generate six sets of winning lottery numbers, one for each dice face. The dice throw simulation includes capacity to create virtual dice constructs where each dice face of the construct may contain a corresponding game matrix. The user interface is expanded to permit display of multiple playlines and win ledger bars in a readily accessible format. The scoring routine is adapted to permit multi-playline scoring so that users may bet or fold in up to six simultaneous games.

A game display 330 compactly defines “match-to-win” (331) and “player's tally” windows (332) for each of six simultaneous games (333, 334, 335, 336, 337, 338) is shown. In this game, two out of the six games (333, 336) are winners. The player likely would have folded for Game 337 after the first bet and lost his bet on Game 334 in spite of a pickup of two wildcards (*) early in the game. Games 335 and 338 are also losers for the player (despite the enticement of the JP). But Games 333 and 336 make up for it; Game 333 is a four number lottery match jackpot winner and Game 336 is also a jackpot winner by combining three lottery matches and a wildcard. This demonstrates how a player will experience multi-playline dice games of the gaming machines of the invention, . . . wildly better than multi-payline video slots because of the stepwise buildup.

This multi-face technical feature, which is unique to dice, allows the player to play up to six games simultaneously on the familiar cubic dice, and bet on each separately. This could seem to resemble the offering of multiple “paylines” in slot machine games, but because the player can fold or increase his stake in each of the games individually, adds a whole new dimension to multiple levels of simultaneous play, each of which is termed here a “playline” for contrast.

Thus in another embodiment, a subroutine or software engine of the inventive gaming machines is configured with instructions for (i) executing a first subroutine in response to a play command, said first subroutine defining a number of sets of randomly selected winning lottery numbers according to a corresponding number of F faces of N dice members to be played, said sets each having X members, such that (F*N) sets are defined, wherein a uniform dice face type is assigned to each set such that the number of face types is equal to the number of faces per dice member, one face type per face for N dice members, each face type of N dice members defining a unique game matrix for each of F playlines; (ii) for each game matrix of F playlines, executing a second subroutine, said second subroutine comprising instructions for intermixingly and disassortingly associating a matrix row or column containing said randomly selected winning lottery numbers with a matrix row or column of matrix elements or loci corresponding to one of the face types of said N dice members, and further preparing a simulation of a virtual dice construct, said dice construct having N dice members, wherein N and X are integers and N is greater than X, such that any one of said winning lottery numbers is associated with no more than dice member and no one dice member is associated with more than one winning lottery number of said each playline; (iii) executing a third subroutine, said third subroutine comprising instructions for displaying said dice construct in said interactive user interface wherein said dice members are displayed while concealing said winning lottery numbers of the F playlines associated on the F faces thereof, and further where said dice members are displayed uniformly to each present a uniform face type when displayed from any common viewpoint; (iv) executing a fourth subroutine, said fourth subroutine comprising instructions for accepting a bet and accepting a selection of said dice members of said dice construct on one or more playlines, then revealing any winning lottery numbers of at least a subset of said selection of any playline in play; (v) iterating said fourth subroutine, each consecutive iteration comprising instructions for accepting a next bet and a next selection, then revealing additional winning lottery numbers associated with at least a subset of said next selection of any playline in play; and, terminating play and displaying any winnings according to a win table accessible by said processor for each playline in play.

FIG. 30A is a view of an exemplary casino gaming machine 360 having technical features configured for playing the games of the invention, essentially as described with reference to FIGS. 16A through 16C and 17 and may be operated as part of a network or as a standalone gaming system. The system features a user interface with display 361 and internal workings essentially as indicated in FIG. 4. An accessory display panel or panels 362 may include space for a pay table, for a leaderboard, or for advertising tied to the consumer's preferences. At least one of the controls 363, either an analog hard button or a soft selection control on a user interface may be used to select from the available themes for the game as suggested by FIG. 26B.

Also shown is a win dispenser 364. Exemplary casino gaming systems of the invention may also include a payment system which is comprised of a bill acceptor, a credit card reader, cashless receipt/ticket reader, and/or a coin acceptor 365. A player may utilize any accepted payment system known in the art.

FIG. 30B shows an apparatus of the invention that has been configured as a laptop computer 370. Shown on a viewscreen 371 is a virtual representation of a pyramid construct 372 of virtual dice that are a manifestation of the selectable object elements of a game matrix. The embeddable elements of the game matrix may be conceived as “embedded” in the dice construct. The object of the game is to pick dice that match at least a plurality or a majority of a reference set of winning lottery numbers. Here the body color of the dice cubes indicates that three white dice have already been selected by the player and the player is about to select a fourth cube (373) as shown by the gesture. In this embodiment, the view screen is a touch sensitive screen and the player is able to select dice by touching each one with a finger as shown.

The game may also be played on a mobile device such as a cellphone, on a casino gaming machine, or any gaming machine with an LED screen, LCD screen, or CRT, for example. The game instruction set may be downloaded from a website (i.e., as an executable program or “app”) or may be operated under the control of a browser by accessing programming at a website. Video streaming technology and broad bandwidth connectivity permits the game operator to offer the game remotely without supplying all the underlying software, a strategy that facilitates any associated financial transactions, use of proprietary code, and security. Dedicated gaming machines such as the Sony PLAYSTATION® and Microsoft Xbox may also host the game. Newer displays such as augmented reality displays disclosed in US Pat. Doc. 2015/0016777, and in related disclosures of the augmented reality genre, may also be used as a platform for the gaming systems of the inventions.

The above disclosure is sufficient to enable one of ordinary skill in the art to practice the invention, and provides the best mode of practicing the invention presently contemplated by the inventor. While above is a complete description of the preferred embodiments of the present invention, various alternatives, modifications and equivalents are possible. These embodiments, alternatives, modifications and equivalents may be combined to provide further embodiments of the present invention. Further, all foreign and/or domestic publications, patents, and patent applications cited herein, whether supra or infra, are hereby incorporated by reference in their entirety for all they teach. The inventions, examples, and embodiments described herein are not limited to particularly exemplified materials, methods, and/or structures. Various modifications, alternative constructions, changes and equivalents will readily occur to those skilled in the art and may be employed, as suitable, without departing from the true spirit and scope of the invention. Therefore, the above description and illustrations should not be construed as limiting the scope of the invention, which is defined by the appended claims.

### INCORPORATION BY REFERENCE

All of the U.S. patents, U.S. patent application publications, U.S. patent documents, foreign patents, foreign patent documents and non-patent publications referred to in this specification and related filings are incorporated herein by reference in their entirety.

### SCOPE OF CLAIMS

Having described the invention with reference to the exemplary embodiments, it is to be understood that it is not intended that any limitations or elements describing the exemplary embodiments set forth herein are to be incorporated into the meanings of the patent claims unless such limitations or elements are explicitly listed in the claims. Likewise, it is to be understood that it is not necessary to meet any or all of the identified advantages or objects of the invention disclose herein in order to fall within the scope of any claims, since the invention is defined by the claims and inherent and/or unforeseen advantages of the present invention may exist even though they may not be explicitly discussed herein.

While the above is a complete description of selected currently preferred embodiments of the present invention, it is possible to practice the invention by various alternatives, modifications, combinations and equivalents. In general, in the following claims, the terms used in the written description should not be construed to limit the claims to specific embodiments described herein for illustration, but should be construed to include all possible embodiments, both specific and generic, along with the full scope of equivalents to which such claims are entitled. Accordingly, the claims are not limited by the disclosure.

We claim:

1. A gaming machine for randomizing an outcome of a game of chance, which comprises a processor with processing circuitry, a player interface with interactive display, a memory containing program instructions, wherein said processing circuitry includes a graphics rendering engine and a kinematic engine operative to iteratively output a display of a plurality of virtual gamepieces, said gamepieces having randomized motion in three dimensions in real time such that an outcome of a game of chance played thereon is indeterminate until said randomized motion of said gamepieces is stopped.

2. The gaming machine of claim 1, wherein said gamepieces have concealed attributes or embedded content of significance in resolving said outcome of said game.

3. The gaming machine of claim 2, wherein said outcome of said game is indeterminate until a player's selection of a subset of said gamepieces is received.

4. The gaming machine of claim 2, wherein said game of chance is a conceal and reveal game, wherein said program instructions are configured to, when executed as an iteration by said processor and processing circuitry, enable said apparatus to model a plurality of virtual gamepieces of a game of chance, each gamepiece having a virtual motion in real time in a virtual space as defined by translational, rotational and collisional equations of motion applied thereto, such that said gamepieces are randomly assembled into a blinded virtual construct on said interactive display when said iteration is stopped.

5. The gaming machine of claim 4, wherein each said virtual gamepiece is modelled as a selectable object on said interactive player interface and each said gamepiece is associated with an embedded element concealedly associated therewith.

6. The gaming machine of claim 5, wherein said virtual gamepieces are segments or symbols peripherally disposed on at least one virtual slot reel having a virtual motion in a virtual cylinder, wherein said virtual motion is defined by a rotational equation of motion applied thereto.

7. The gaming machine of claim 6, wherein said program instructions are configured to represent said blinded virtual construct as a scratch card on said interactive display when said iteration is stopped, each scratchpad of said scratch card defining a selectable object, each selectable object having an embedded element concealedly associated therewith.

8. The gaming machine of claim 7, wherein said embedded elements are instant win lottery numbers, non-random supplemental game indicia, and non-winning lottery numbers such that one and only one number or other indicia is associated with each said selectable object.

9. The gaming machine of claim 4, wherein said virtual space comprises at least one delimiting boundary, wherein said boundary is a gameboard, and said blinded virtual construct is randomly assembled on said gameboard on said interactive display.

10. The gaming machine of claim 9, wherein said virtual gamepieces are dice having a virtual motion on said virtual gameboard, wherein said virtual motion is defined by translational, rotational, and collisional equations of motion applied thereto, and wherein said program instructions are configured to represent said blinded virtual construct as a construct of said dice or dice faces thereof on said virtual gameboard on said interactive player interface when said iteration is stopped, each dice or dice face of said blinded virtual construct defining a selectable object, each selectable object having an embedded element concealedly associated therewith.

11. The gaming machine of claim 10, wherein said embedded elements are instant win lottery numbers, non-random supplemental game indicia, and non-winning lottery numbers such that one and only one number or other indicia is associated with each said selectable object.

12. The gaming machine of claim 1, wherein said player interface comprises a bet receiving interface.

13. The gaming machine of claim 1, wherein said player interface is networked.

14. The gaming machine of claim 1, wherein said player interface is housed in a cell phone, a computerized device, a television, an augmented reality viewing device, a mobile device, or a casino gaming machine.

15. A system for operating a game of chance, which comprises
i) a non-volatile memory device, wherein said non-volatile memory device is configured to store digitally-encoded instructions to perform a method;
ii) a processor digitally coupled to said non-volatile memory device, wherein said processor is configured to execute said instructions;
iii) a player interface with display operatively coupled to said processor, wherein said player interface is configured to receive inputs from a player and to display a game state according to said instructions;
iv) a graphics rendering engine operatively coupled to said display and said processor;
v) wherein said method comprises
(a) displaying an animation of said gamepieces in virtual motion on said display and then transforming said animation to display a blinded virtual construct in which said gamepieces are displayed as “selectable objects” in randomized stationary order, each selectable object having an embeddable element associated therewith; and,
(b) receiving at least one selection of a subset of said selectable objects from said player interface, displaying said embeddable elements of said selection on said display, and awarding a game outcome based on a number of matches of said embeddable elements with designated winning elements of a game match-to-win ledger.

16. The gaming machine of claim 15, wherein said designated winning elements include randomly chosen indicia or numbers from a pool and at least one non-random supplemental game indicium.

17. The system of claim 16, wherein said designated winning elements are instant win lottery numbers.

18. The system of claim 16, wherein said animation comprises a simulation of a slot reel spin having a plurality of virtual slot reels.

19. The system of claim 16, wherein said virtual blinded construct is a virtual scratchcard and said gamepieces are virtual scratchpads arrayed thereon.

20. The system of claim 16, further comprising a bet receiving interface, and wherein step (a) or step (b) comprises receiving a bet on said game outcome on said bet receiving interface.

21. The system of claim 20, wherein said method further comprises making iterations of step (b), in each iteration selecting one or more additional subsets of selectable object elements, and displaying all lottery numbers and supplemental game indicia in said selections when resolving said bet or bets.

22. The gaming machine of claim 15 wherein said player interface is networked.

23. The gaming machine of claim 15, wherein said player interface is housed in a cell phone, a computerized device, a television, an augmented reality viewing device, a mobile device, or a casino gaming machine.

24. The system of claim 15, comprising a kinematic random number engine.

25. The system of claim 15, wherein said animation comprises a throw of virtual dice on a virtual gameboard.

26. The system of claim 25, wherein said animation of said virtual dice is defined by translational, rotational, and collisional equations of motion applied in iteration thereto, and wherein said program instructions are configured to represent said blinded virtual construct as a construct of said dice or dice faces thereof on said interactive player interface when said iteration is stopped, each dice or dice face of said blinded virtual construct defining a selectable object, each selectable object having an embedded element concealedly associated therewith.

27. The system of claim 26, wherein said blinded virtual construct is presented on said interactive display as a three-dimensional virtual construct of dice, said blinded virtual construct having a polygonal shape.

28. The system of claim 26, wherein a plurality of games are played in parallel on said three-dimensional virtual construct, said plurality being limited in number only by the number of aspects of said three dimensional virtual construct or by the number of face types of said dice, each said aspect or facetype defining a playline.
